(19) United States
(12) Patent Application Publication
(10) Pub. No.: US 2016/0156066 A1
(43) Pub. Date: Jun. 2, 2016

(54) POLYMER ELECTROLYTES FOR ELECTROCHEMICAL CELLS

(71) Applicants: Massachusetts Institute of Technology, Cambridge, MA (US); The Regents of the University of California, Oakland, CA (US)

(72) Inventors: Karen K. Gleason, Cambridge, MA (US); Nan Chen, Malden, MA (US); Baby Reeja Jayan, Boston, MA (US); Andong Liu, Cambridge, MA (US); Bruce S. Dunn, Los Angeles, CA (US); Priya Moni, Worcester, MA (US)

(73) Assignees: Massachusetts Institute of Technology, Cambridge, MA (US); The Regents of the University of California, Oakland, CA (US)

(21) Appl. No.: 14/918,533

(22) Filed: Oct. 20, 2015

Related U.S. Application Data
(60) Provisional application No. 62/066,271, filed on Oct. 20, 2014.

(51) Int. Cl. H01M 10/0565; H01M 10/0525; H01M 4/485; H01M 4/38; H01M 4/48; C09D 143/04; H01M 4/583

(52) U.S. Cl. CPC H01M 10/0565; C09D 143/04; H01M 10/0525; H01M 4/583; H01M 4/386; H01M 4/382; H01M 4/38; H01M 4/387; H01M 4/48; H01M 4/485; H01M 2220/30; H01M 2300/0082

(57) ABSTRACT

Thin polymer layers for use as electrolytes in electrochemical cells, and associated electrochemical cells and methods, are generally described. The thin polymer layers may be formed by initiated chemical vapor deposition (iCVD) and may be doped with an electroactive species (e.g., Li⁺). The resultant thin polymer layers may exhibit high ionic conductivity and an ability to conformally coat structures having complex geometries (e.g., electrodes having high aspect ratios).

### RELATED APPLICATIONS

This application claims priority under 35 U.S.C. §119(e) to U.S. Provisional Patent Application Ser. No. 62/066,271, filed Oct. 20, 2014, and entitled “Polymer Electrolytes for Electrochemical Cells,” which is incorporated herein by reference in its entirety for all purposes.

### GOVERNMENT FUNDING

This invention was made with government support under Contract No. N00014-13-1-0466 awarded by the Office of Naval Research. The government has certain rights in the invention.

### FIELD

The present invention generally relates to thin polymer layers and, in particular, to thin polymer electrolyte layers for use in electrochemical cells.

### BACKGROUND

Autonomous microscale and nanoscale devices have shown significant promise in areas including sensing, actuation, communications, and medical implants. In order to successfully integrate power sources into microscale and nanoscale devices, electrochemical cells (e.g., batteries) with high energy densities, high power densities, and small areal footprints are needed.

Many common electrochemical cells have planar configurations that limit energy capacity within small areal footprints. For example, lithium-ion electrochemical cells are a widely-used type of rechargeable (e.g., secondary) electrochemical cell that function through transport of lithium ions between an anode and a cathode. In typical Li-ion electrochemical cell configurations, an anode, a cathode, and an electrolyte are arranged in substantially planar layers that are stacked or wound. In order to minimize power losses associated with slow ion transport, the layers are generally thin. However, reducing the thickness of the electrodes generally results in lower amounts of energy being stored.

Three-dimensional (3D) electrochemical cell architectures may overcome the limitations of planar configurations by creating non-planar electrode structures that increase energy densities within a small areal footprint while maintaining short ionic transport distances that are preferable for high power densities. However, it has been recognized that development of thin, conformal electrolytes capable of coating electrodes with complex geometries is a challenging problem. For example, thin, uniform, conformal polymer layers are generally difficult to achieve by solution processing due to de-wetting and surface tension effects. Accordingly, improved electrolytes are needed.

### SUMMARY

The present invention generally relates to thin polymer layers and, in particular, to thin polymer electrolyte layers for use in electrochemical cells. The subject matter of the present invention involves, in some cases, interrelated products, alternative solutions to a particular problem, and/or a plurality of different uses of one or more systems and/or articles.

In one aspect, an article is provided. The article may comprise at least one electroactive structure and a polymer layer proximate the at least one electroactive structure. In some cases, the polymer layer has a thickness of about 100 nm or less. In certain embodiments, the polymer layer has an ionic conductivity of at least about 10⁻⁹ S/cm at about 25° C.

According to another aspect, an article is provided. The article may comprise at least one electroactive structure and a polymer layer proximate the at least one electroactive structure. In some cases, the polymer layer has a thickness of about 100 nm or less. In certain embodiments, the polymer layer has a surface roughness R_{RMS} of about 2 nm or less.

In another aspect, an article is provided. The article may comprise at least one electroactive structure and a polymer layer proximate the at least one electroactive structure. In some cases, the polymer layer has a thickness of about 100 nm or less. In certain embodiments, the thickness of the polymer layer is substantially uniform.

According to another aspect, an article is provided. The article may comprise at least one electroactive structure having an aspect ratio of at least about 2:1. In some embodiments, the article comprises a polymer layer proximate the at least one electroactive structure. In certain cases, the polymer layer has a thickness of about 100 nm or less. In some embodiments, the polymer layer has a step coverage in the range of about 0.8 to 1.2.

In another aspect, an article is provided. The article may comprise at least one electroactive structure and a polymer layer proximate the at least one electroactive structure. In some cases, the polymer layer has a thickness of about 100 nm or less. In certain embodiments, the polymer layer comprises a polymer, wherein the polymer has a repeat unit comprising at least one organic ring structure. In some embodiments, the at least one organic ring structure comprises at least two heteroatoms and at least one cross-linkable side group.

Some aspects are directed to an electrochemical cell. In some embodiments, the electrochemical cell comprises a first electroactive structure comprising an electroactive species. In some cases, the electrochemical cell comprises a second electroactive structure. According to some embodiments, the electrochemical cell may comprise a polymer electrolyte layer positioned between the first electroactive structure and the second electroactive structure. In certain embodiments, the polymer electrolyte layer has a thickness of about 100 nm or less, the polymer electrolyte layer has an ionic conductivity of at least about 10⁻⁹ S/cm, and the polymer electrolyte layer is doped with the electroactive species.

Some aspects are directed to a method. In some cases, the method comprises depositing a conformal polymer coating on an electroactive structure using iCVD, wherein the conformal polymer coating has a thickness of about 100 nm or less. In some embodiments, the method comprises exposing the conformal polymer coating to a solution comprising an electroactive species of the electroactive structure, wherein the conformal polymer coating is doped with the electroactive species.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to some embodiments, an exemplary schematic illustration of an article comprising an electroactive structure and a thin polymer layer;

FIG. 1B shows, according to some embodiments, an exemplary schematic illustration of an article comprising a high-aspect-ratio electroactive structure and a thin polymer layer;

FIG. 1C shows, according to some embodiments, an exemplary schematic illustration of an article comprising a plurality of high-aspect-ratio electroactive structures and a thin polymer layer;

FIG. 2A shows an exemplary cross-sectional schematic illustration of an electrochemical cell comprising interdigitated anodes and cathodes, according to some embodiments;

FIG. 2B shows an exemplary schematic illustration of an electrochemical cell comprising a plurality of high-aspect-ratio electroactive structures comprising a first electroactive material, where each high-aspect-ratio electroactive structure is conformally coated with a polymer electrolyte layer, and a second electroactive material, according to some embodiments;

FIG. 3A shows the chemical structure for 1,3,5-trivinyl-1,3,5-trimethylcyclotrisiloxane (V3D3);

FIG. 3B shows the chemical structure for 1,3,5,7-tetravinyl-1,3,5,7-tetramethylcyclotetrasiloxane (V4D4);

FIG. 3C shows the chemical structure for 1,3,5-trivinyl-1,3,5-trimethylcyclotrisilazane (V3N3);

FIG. 3D shows the chemical structure for 1,3,5,7-tetravinyl-1,3,5,7-tetramethylcyclotetrasilazane (V4N4);

FIG. 3E shows the chemical structure for oligo(ethylene glycol) allyl methyl ether (OEGAME);

FIG. 4 shows, according to some embodiments, an exemplary schematic illustration of a scheme for fabrication of a polymer electrolyte via iCVD and Li⁺ doping;

FIG. 5 shows FTIR spectra for a V4D4 monomer, an unlithiated PV4D4 polymer, and a lithiated PV4D4 polymer, according to some embodiments;

FIG. 6A shows, according to some embodiments, a TEM image of an uncoated silver nanowire;

FIG. 6B shows, according to some embodiments, a TEM image of a 10 nm PV4D4-coated silver nanowire;

FIG. 6C shows, according to some embodiments, an AFM image of an iCVD-deposited, 35 nm PV4D4 film on a silicon wafer;

FIG. 6D shows, according to some embodiments, an AFM image of the iCVD-deposited, 35 nm PV4D4 film of FIG. 6C after lithiation;

FIG. 7 shows, according to some embodiments, AFM line scans measured across the center of images of as-deposited and lithiated PV4D4 films;

FIG. 8 shows a plot of refractive index as a function of wavelength (nm) for as-deposited and lithiated PV4D4 films, according to some embodiments;

FIG. 9 shows, according to some embodiments, a TEM image of a PV4D4-coated silver nanowire after lithiation;

FIG. 10 shows film thickness histograms for as-deposited and lithiated PV4D4 films, according to some embodiments;

FIG. 11 shows a current-voltage plot for an unlithiated PV4D4 film, according to some embodiments;

FIG. 12A shows, according to some embodiments, an exemplary schematic illustration of an experimental configuration used for electrochemical impedance spectroscopy;

FIG. 12B shows, according to some embodiments, impedance of an unlithiated 25 nm PV4D4 film;

FIG. 12C shows, according to some embodiments, impedance of a lithiated 25 nm PV4D4 film;

FIG. 13 shows a plot of phase angle as a function of frequency for an unlithiated 25 nm PV4D4 film, according to some embodiments;

FIG. 14 shows, according to some embodiments, impedance of a lithiated 35 nm PV4D4 film;

FIG. 15A shows, according to some embodiments, a plot of the voltammetric response of a Pt electrode in 1 mM dmFc;

FIG. 15B shows, according to some embodiments, a plot of the voltammetric response of a Pt electrode in 1 mM CoCp₂PF₆;

FIG. 15C shows, according to some embodiments, a plot of the voltammetric response of an ITO electrode in 1 mM dmFC;

FIG. 15D shows, according to some embodiments, a plot of the voltammetric response of an ITO electrode in 1 mM CoCp₂PF₆;

FIG. 16A shows a plot of the voltammetric response of lithiated and unlithiated 20 nm PV4D4 films and ITO electrodes in 1 mM dmFc, according to some embodiments;

FIG. 16B shows a plot of the voltammetric response of lithiated and unlithiated 20 nm PV4D4 films and ITO electrodes in 1 mM CoCp₂PF₆ and 0.1 M TBATFB in PC, according to some embodiments;

FIG. 17 shows thickness of a PV4D4 film, as measured by VASE, according to some embodiments;

FIG. 18A shows, according to some embodiments, a plot of deposition rate as a function of Pₘ/Pₛₐₜ for PV3N3 and PV4N4 films;

FIG. 18B shows, according to some embodiments, a plot of deposition rate as a function of reciprocal substrate temperature for PV3N3 and PV4N4 films;

FIG. 19 shows FTIR spectra for PV3D3, PV4D4, PV3N3, and PV4N4, according to some embodiments;

FIG. 20 shows UV-Vis spectra for 100 nm PV3N3, PV4N4, PV3D3, and PV4D4 films, according to some embodiments;

FIG. 21 shows, according to some embodiments, thickness of a PV3N3 film on a 10 cm-diameter Si wafer, as measured by VASE;

FIG. 22 shows water contact angle data for PV3D3, PV4D4, PV3N3, and PV4N4 films, according to some embodiments;

FIG. 23A shows, according to some embodiments, an AFM image of a 100 nm thick film of PV3N3 on a silicon wafer;

FIG. 23B shows, according to some embodiments, an AFM image of a 100 nm thick film of PV4N4 on a silicon wafer;

FIG. 23C shows, according to some embodiments, an AFM image of a 100 nm thick film of PV3D3 on a silicon wafer;

FIG. 23D shows, according to some embodiments, an AFM image of a 100 nm thick film of PV4D4 on a silicon wafer;

FIG. 24A shows, according to some embodiments, an SEM image of a trench wafer coated with a 150 nm PV3N3 film;

FIG. 24B shows, according to some embodiments, an SEM image of a trench wafer coated with a 100 nm PV4N4 film;

FIG. 25 shows an exemplary schematic illustration of a lithiation process, according to some embodiments;

FIG. 26 shows, according to some embodiments, a plot of EIS-derived ionic conductivity (S/cm) as a function of thickness (nm) for PV3N3, PV4N4, PV3D3, and PV4D4;

FIG. 27A shows an AFM image of an iCVD-deposited, 30 nm thick PV3D3 film on a silicon wafer before lithiation, according to some embodiments;

FIG. 27B shows an AFM image of an iCVD-deposited, 30 nm thick PV3D3 film on a silicon wafer after lithiation, according to some embodiments;

FIG. 27C shows an AFM image of an iCVD-deposited, 25 nm thick PV4D4 film before lithiation, according to some embodiments;

FIG. 27D shows an AFM image of an iCVD-deposited, 25 nm thick PV4D4 film after lithiation, according to some embodiments;

FIG. 28A shows, according to some embodiments, an AFM image of a silicon surface coated with PV4D4 before lithiation;

FIG. 28B shows, according to some embodiments, an AFM image of a silicon surface coated with PV4D4 after lithiation but before an ethanol rinse;

FIG. 28C shows, according to some embodiments, an AFM image of a silicon surface coated with PV4D4 after lithiation and after an ethanol rinse;

FIG. 29 shows a plot of refractive index of PV3D3 and PV4D4 films on a silicon wafer before and after lithiation as a function of wavelength;

FIG. 30A shows, according to some embodiments, a plot of number of Li atoms per cm³ as a function of thickness for lithiated PV3D3 and PV4D4 films;

FIG. 30B shows, according to some embodiments, a plot of number of Li atoms per cm³ as a function of reciprocal thickness for lithiated PV3D3 and PV4D4 films;

FIG. 31 shows a plot of thickness of the top lithiated layer as a function of film thickness for PV3D3 and PV4D4 films, according to some embodiments;

FIG. 32 shows, according to some embodiments, a schematic illustration of a process for two-step lithiation of a PV4D4 film;

FIG. 33 shows, according to some embodiments, conductivity of 15 nm, 25 nm, 35 nm, and 25/25 nm films;

FIG. 34 shows, according to some embodiments, ionic conductivity values (S/cm) obtained when lithiating 20 nm thick PV4D4 films using lithium salts containing varying sizes of counterions;

FIG. 35A shows an AFM image of a polymer film dried for 3 days, according to some embodiments;

FIG. 35B shows an AFM image of a polymer film dried for 3 hours, according to some embodiments;

FIG. 36 shows Raman spectra for Si, V3D3, V4D4, lithiated V3D3, and lithiated V4D4, according to some embodiments;

FIG. 37 shows FTIR spectra for PV4D4-DEGDVE (1:10), PV4D4-DEGDVE (1:1), and PV4D4, according to some embodiments;

FIG. 38 shows FTIR spectra for pOEGAME, p(OEGAME-co-TVTSO), p(OEGAME-co-VPDMS), and p(OEGAME-co-DEGDVE), according to some embodiments;

FIG. 39A shows, according to some embodiments, an AFM image of an OEGAME film before lithiation;

FIG. 39B shows, according to some embodiments, an AFM image of an OEGAME film after soaking in DME and LiClO₄ for one day;

FIG. 40 shows FTIR spectra for PV4D4-BA, PV4D4-DEGDVE (1:1), and PV4D4, according to some embodiments;

FIG. 41 shows, according to some embodiments, SEM and TEM images of silicon nanowires before and after being coated with a 50 nm PV4D4 layer;

FIG. 42 shows electron dispersive spectroscopy (EDS) spectra of PV4D4-coated carbon microbeads, according to some embodiments;

FIG. 43 shows, according to some embodiments, electron microprobe analysis spectra of PV4D4-coated and uncoated single posts;

FIG. 44 shows a lithium manganese nickel oxide spinel particle coated with a PV4D4 layer;

FIG. 45A shows, according to some embodiments, results from half-cell battery tests conducted with a mesocarbon microbead (MCMB) post array coated with a lithiated, 30 nm PV4D4 film, including a plot of E_{we} vs. SCE as a function of time at C/50, C/20, and C/5 cycling rates;

FIG. 45B shows, according to some embodiments, results from half-cell battery tests conducted with a mesocarbon microbead (MCMB) post array coated with a lithiated, 30 nm PV4D4 film, including a plot of current as a function of E_{we} vs. SCE; and

FIG. 45C shows, according to some embodiments, results from half-cell battery tests conducted with a mesocarbon microbead (MCMB) post array coated with a lithiated, 30 nm PV4D4 film, including a plot of discharge capacity and coulombic efficiency as a function of cycle number for C/5.

### DETAILED DESCRIPTION

Embodiments described herein generally relate to thin polymer layers. Certain embodiments are related to the recognition that a thin polymer layer may be suitable for use as an electrolyte in an electrochemical cell. In some cases, the thin polymer layers described herein have certain characteristics that are advantageous for electrolytes, such as relatively high ionic conductivity (e.g., at least about 10⁻⁹ S/cm). Further, the thin polymer layers may be capable of conformally coating structures that have complex geometries (e.g., structures that have high aspect ratios).

It has been recognized that there may be certain advantages associated with electrochemical cells having substantially non-planar architectures (e.g., interdigitated electrodes, periodic arrays of high-aspect-ratio electrodes, aperiodic electrode configurations). For example, in some cases, such electrochemical cells may have a relatively small size (e.g., relatively small areal footprint, relatively small volume) and may also exhibit enhanced performance characteristics (e.g., relatively high power density, relatively high energy density). However, one of the challenges associated with electrochemical cells having non-planar architectures has been a lack of suitable electrolytes.

It has unexpectedly been found that thin polymer layers suitable for use as electrolytes in electrochemical cells may be synthesized using initiated chemical vapor deposition (iCVD). It has been recognized within the context of this invention that as the thickness of a polymer electrolyte layer decreases, the ionic conductivity of the polymer electrolyte layer may advantageously increase. In some cases, iCVD may be used to synthesize thin polymer layers (e.g., polymer layers having a thickness of about 100 nm or less) that accordingly have relatively high ionic conductivities. Further, iCVD may be used to synthesize thin polymer layers that conformally coat structures having complex geometries, such as structures having high aspect ratios. The iCVD-synthesized thin polymer layers may be substantially continuous and, in some cases, pinhole-free. It has also been discovered that doping a thin polymer layer with an electroactive species of an electrochemical cell may enhance the performance of the thin polymer layer as an electrolyte in the electrochemical cell. For example, doping a thin polymer layer with an electroactive species may increase the ionic conductivity of the thin polymer layer. Those of ordinary skill in the art would not have expected a thin polymer layer to be capable of providing both sufficiently high ionic conductivity and a conformal, substantially continuous coating of structures having complex geometries.

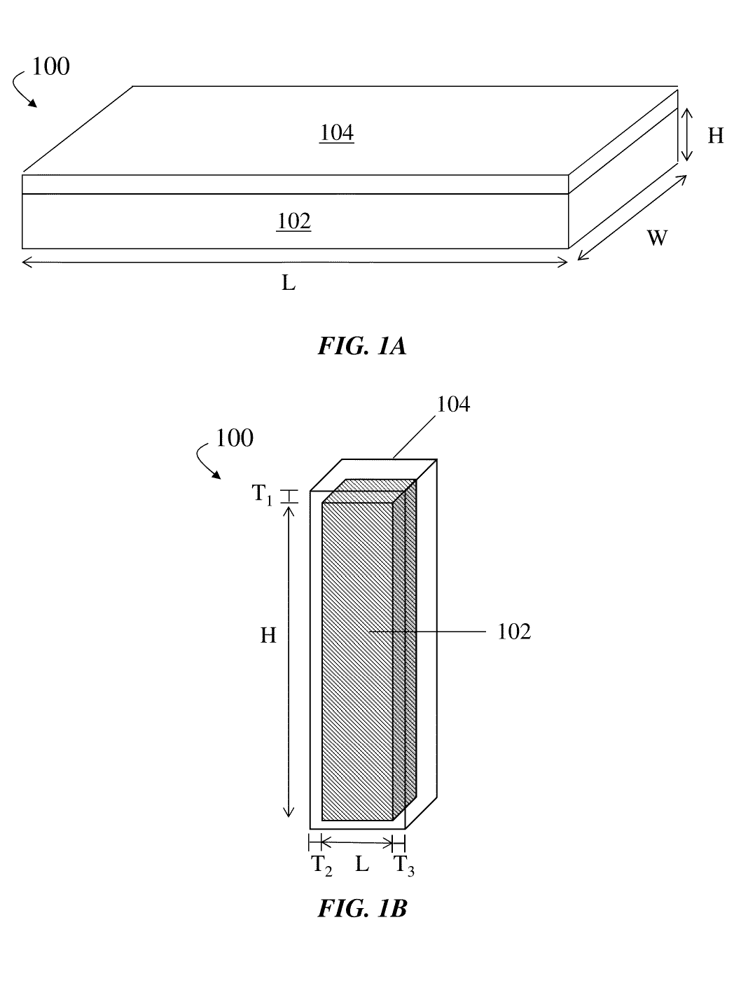

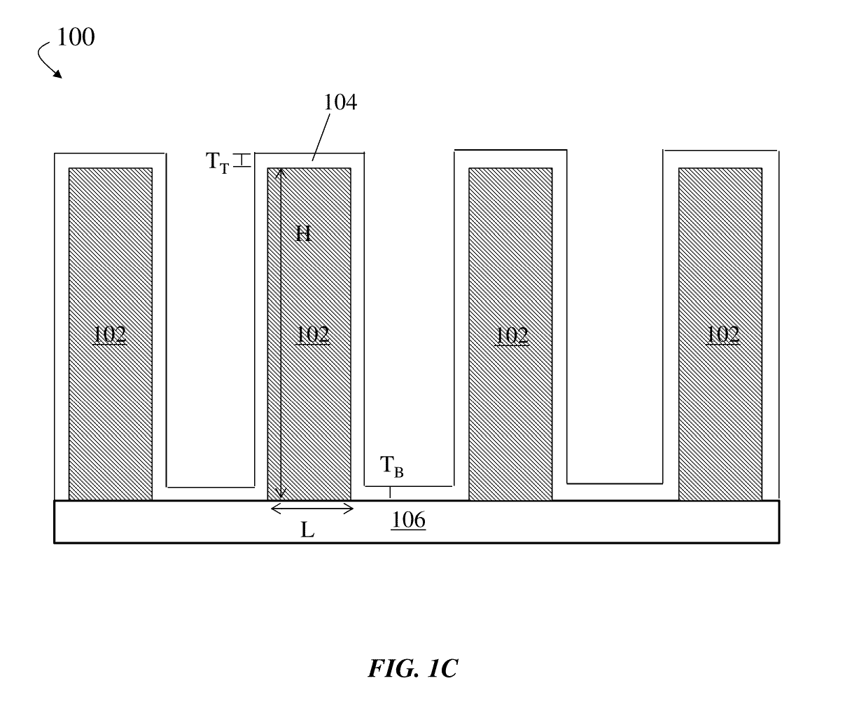

In some embodiments, an article comprises at least one electroactive structure and a polymer layer proximate the at least one electroactive structure. FIG. 1A shows an exemplary schematic illustration of article 100, which comprises electroactive structure 102 and polymer layer 104 proximate electroactive structure 102. It should be understood that when a first portion (e.g., layer, film, structure, region) is “proximate” a second portion, it can be directly on the second portion, or an intervening portion may be present between the first and second portions. In FIG. 1A, polymer layer 104 is positioned in direct contact with electroactive structure 102.

From FIG. 1A, it can be seen that polymer layer 104 is proximate one side of electroactive structure 102. In some embodiments, a polymer layer is proximate one, two, three, four, five, six, seven, eight, or more sides of an electroactive structure.

In FIG. 1A, electroactive structure 102 has a substantially planar geometry. A structure having a substantially planar geometry may refer to a structure having a cross section with a maximum cross-sectional dimension (e.g., length, diameter) and a height measured along an axis orthogonal to the cross section, where the maximum cross-sectional dimension is substantially larger than the height. In some cases, the maximum cross-sectional dimension of the electroactive structure is at least about 1.5 times greater, at least about 2 times greater, at least about 5 times greater, at least about 10 times greater, at least about 20 times greater, at least about 50 times greater, at least about 100 times greater, at least about 500 times greater, or at least about 1000 times greater than the height of the electroactive structure. In FIG. 1A, for example, electroactive structure 102 has a rectangular cross section with a maximum cross-sectional dimension of length L (e.g., length L is greater than width W). Electroactive structure 102 also has a height H, and it can be seen from FIG. 1A that the height of electroactive structure 102 is substantially smaller than the length of electroactive structure 102. An electroactive structure having a substantially planar geometry may also have a relatively low aspect ratio (e.g., ratio of height to maximum cross-sectional dimension). In some embodiments, the electroactive structure has an aspect ratio of about 1:1 or less, about 1:2 or less, about 1:4 or less, about 1:10 or less, about 1:20 or less, about 1:50 or less, about 1:100 or less, about 1:500 or less, or about 1:1000 or less. In certain cases, the electroactive structure has an aspect ratio in the range of about 1:1000 to about 1:100, about 1:1000 to about 1:10, about 1:1000 to about 1:1, about 1:100 to about 1:10, about 1:100 to about 1:1, about 1:10 to about 1:1, about 1:4 to about 1:1, or about 1:2 to about 1:1.

Some embodiments relate to articles comprising at least one electroactive structure having a relatively high aspect ratio and a polymer layer proximate the at least one electroactive structure. FIG. 1B shows an exemplary schematic illustration of article 100 comprising electroactive structure 102 having a high aspect ratio and polymer layer 104 proximate electroactive structure 102. Like the electroactive structure illustrated in FIG. 1A, electroactive structure 102 in FIG. 1B has a rectangular cross section with a maximum cross-sectional dimension of length L. Electroactive structure 102 also has a height H. In contrast to the electroactive structure illustrated in FIG. 1A, it can be seen from FIG. 1B that the height H of electroactive structure 102 is substantially larger than the length L of electroactive structure 102. Accordingly, electroactive structure 102 has a relatively high aspect ratio (e.g,. ratio of height to maximum cross-sectional dimension). In some embodiments, a high-aspect-ratio electroactive structure has an aspect ratio of at least about 2:1, at least about 3:1, at least about 4:1, at least about 5:1, at least about 10:1, at least about 20:1, at least about 50:1, at least about 100:1, at least about 200:1, at least about 500:1, at least about 1000:1, at least about 2000:1, at least about 3000:1, at least about 4000:1, at least about 5000:1, or at least about 10,000:1. Correspondingly, in some embodiments, a high-aspect-ratio electroactive structure has an aspect ratio of about 10,000:1 or less, about 5000:1 or less, about 4000:1 or less, about 3000:1 or less, about 2000:1 or less, about 1000:1 or less, about 500:1 or less, about 200:1 or less, about 100:1 or less, about 50:1 or less, about 20:1 or less, about 10:1 or less, about 5:1 or less, about 4:1 or less, about 3:1 or less, or about 2:1 or less. Combinations of the above-noted ranges are also possible (e.g., about 4:1 to about 1000:1). For instance, in some embodiments, a high-aspect-ratio electroactive structure has an aspect ratio in the range of about 2:1 to about 100:1, about 2:1 to about 500:1, about 2:1 to about 1000:1, about 2:1 to about 5000:1, about 2:1 to about 10,000:1, about 4:1 to about 100:1, about 4:1 to about 500:1, about 4:1 to about 1000:1, about 4:1 to about 4000:1, about 4:1 to about 10,000:1, about 10:1 to about 100:1, about 10:1 to about 500:1, about 10:1 to about 1000:1, about 10:1 to about 5000:1, about 10:1 to about 10,000:1, about 100:1 to about 1000:1, about 100:1 to about 5000:1, about 100:1 to about 10,000:1, about 500:1 to about 1000:1, about 500:1 to about 5000:1, about 500:1 to about 10,000:1, about 1000:1 to about 5000:1, about 1000:1 to about 10,000:1, or about 5000:1 to about 10,000:1.

In FIG. 1B, polymer layer 104 is proximate five sides of electroactive structure 102. As shown in FIG. 1B, polymer layer 104 provides a conformal coating of high-aspect-ratio electroactive structure 102 (e.g., polymer layer 104 physically matches the exterior contour of electroactive structure 102 and preserves the morphology of electroactive structure 102). One measure of the conformality of polymer layer 104 is the ratio of the thickness of polymer layer 104 proximate a first side of electroactive structure 102 to the thickness of polymer layer 104 proximate a second side of electroactive structure 102. For example, in FIG. 1B, a first thickness T₁ of the portion of polymer layer 104 proximate a first side of electroactive structure 102, a second thickness T₂ of the portion of polymer layer 104 proximate a second side of electroactive structure 102, and a third thickness T₃ of the portion of polymer layer 104 proximate a third side of electroactive structure 102 are labelled. In some cases, the ratio of the thickness of a polymer layer proximate a first side of an electroactive structure to the thickness of a polymer layer proximate a second side of an electroactive structure is at least about 0.8, at least about 0.85, at least about 0.9, at least about 0.95, at least about 0.99, at least about 1.0, at least about 1.01, at least about 1.05, or at least about 1.1. Correspondingly, in some embodiments, the ratio of the thickness of a polymer layer proximate a first side of an electroactive structure to the thickness of a polymer layer proximate a second side of an electroactive structure is about 1.1 or less, about 1.05 or less, about 1.01 or less, about 1.0 or less, about 0.99 or less, about 0.95 or less, about 0.9 or less, about 0.85 or less, or about 0.8 or less. Combinations of the above-noted ranges are also possible (e.g., about 0.95 to about 1.05). For example, in some embodiments, the ratio is in the range of about 0.8 to about 1.1, about 0.8 to about 1.05, about 0.8 to about 1.0, about 0.9 to about 1.1, about 0.9 to about 1.0, about 0.95 to about 1.05, or about 0.99 to about 1.01.

Certain embodiments relate to articles comprising a plurality of high-aspect-ratio electroactive structures. FIG. 1C shows an exemplary schematic illustration of article 100 comprising four electroactive structures 102, polymer layer 104 proximate the four electroactive structures, and substrate 106. As shown in FIG. 1C, polymer layer 104 provides a substantially conformal coating of the four electroactive structures 102. In certain cases, an appropriate measure of conformality is step coverage. Step coverage may refer to the ratio of thickness of a polymer layer proximate a top surface of an electroactive structure to the thickness of a polymer layer proximate a bottom surface adjacent the electroactive structure. For example, the thickness T_{T} of polymer layer 104 proximate a top surface of an electroactive structure 102 and the thickness T_{B} of polymer layer 104 proximate a bottom surface adjacent the electroactive structure are shown in FIG. 1C. In some embodiments, the step coverage is at least about 0.8, at least about 0.85, at least about 0.9, at least about 0.95, at least about 0.99, at least about 1.0, at least about 1.01, at least about 1.05, or at least about 1.1. Correspondingly, in some embodiments, the step coverage is about 1.1 or less, about 1.05 or less, about 1.01 or less, about 1.0 or less, about 0.99 or less, about 0.95 or less, about 0.9 or less, about 0.85 or less, or about 0.8 or less. Combinations of the above-noted ranges are also possible (e.g., about 0.95 to about 1.05). For example, in some embodiments, the step coverage is in the range of about 0.8 to about 1.1, about 0.8 to about 1.05, about 0.8 to about 1.0, about 0.9 to about 1.1, about 0.9 to about 1.0, about 0.95 to about 1.05, or about 0.99 to about 1.01.

Certain embodiments relate to a polymer layer that is doped with one or more dopants (e.g., to alter the ionic conductivity of the polymer layer). In some embodiments, the dopant is an electroactive species associated with an electroactive structure proximate the polymer layer. For example, the electroactive structure may be an electrode for use in an electrochemical cell. An electrochemical cell generally functions through transport of an electroactive species between a negative electrode (commonly considered an anode) and a positive electrode (commonly considered a cathode) through an electrolyte. It has been discovered in the context of this invention that doping a polymer layer with an electroactive species may advantageously increase the ionic conductivity of the polymer layer. In some cases, the polymer layer may be doped with an electroactive species of an electrochemical cell prior to use of the polymer layer as an electrolyte in the electrochemical cell (e.g., prior to operation of the electrochemical cell). In some embodiments, the electroactive species is a cation. Examples of suitable cations include, but are not limited to, Li⁺, Na⁺, K⁺, Ag⁺, Mg²⁺, Ca²⁺, Ba²⁺, and Zn²⁺. In some embodiments, the electroactive species is an anion. A non-limiting example of a suitable anion is O²⁻. In some embodiments, the chemical structure of a polymer layer may be substantially unchanged after doping (e.g., there may not be substantial structural re-arrangement). It may be advantageous, in some cases, to preserve the chemical structure of the polymer in order to retain certain structures that may be beneficial for ion transport (e.g., siloxane and/or silazane ring structures). In some embodiments, the polymer layer remains mechanically intact after doping.

In some embodiments, the number density of electroactive species atoms (e.g., ions) in the polymer layer may be relatively high. For example, in some cases, the number density of electroactive species atoms in the polymer layer is at least about 1.0×10¹⁸ atoms/cm³, at least about 1.0×10¹⁹ atoms/cm³, at least about 1.0×10²⁰ atoms/cm³, at least about 2.0×10²⁰ atoms/cm³, at least about 3.0×10²⁰ atoms/cm³, at least about 4.0×10²⁰ atoms/cm³, at least about 5.0×10²⁰ atoms/cm³, at least about 6.0×10²⁰ atoms/cm³, or at least about 1.0×10²¹ atoms/cm³. Correspondingly, in some cases, the number density of electroactive species atoms in the polymer layer is about 1.0×10²¹ atoms/cm³ or less, about 6.0×10²⁰ atoms/cm³ or less, about 5.0×10²⁰ atoms/cm³ or less, about 4.0×10²⁰ atoms/cm³ or less, about 3.0×10²⁰ atoms/cm³ or less, about 2.0×10²⁰ atoms/cm³ or less, about 1.0×10²⁰ atoms/cm³ or less, about 1.0×10¹⁹ atoms/cm³ or less, or about 1.0×10¹⁸ atoms/cm³ or less. Combinations of the above-noted ranges are also possible (e.g., about 1.0×10¹⁸ atoms/cm³ to about 1.0×10²¹ atoms/cm³). In some embodiments, the number density of electroactive species atoms in the polymer layer is in the range of about 1.0×10¹⁸ atoms/cm³ to about 1.0×10¹⁹ atoms/cm³, about 1.0×10¹⁸ atoms/cm³ to about 1.0×10²⁰ atoms/cm³, about 1.0×10¹⁸ atoms/cm³ to about 5.0×10²⁰ atoms/cm³, about 1.0×10¹⁸ atoms/cm³ to about 1.0×10²¹ atoms/cm³, about 1.0×10¹⁹ atoms/cm³ to about 1.0×10²⁰ atoms/cm³, about 1.0×10¹⁹ atoms/cm³ to about 5.0×10²⁰ atoms/cm³, about 1.0×10¹⁹ atoms/cm³ to about 1.0×10²¹ atoms/cm³, or about 1.0×10²⁰ atoms/cm³ to about 1.0×10²¹ atoms/cm³. One method of quantifying the number of electroactive species atoms present in a polymer layer is inductively coupled plasma mass spectrometry (ICP-MS). In some cases, ICP-MS may be capable of detecting trace quantities of atoms.

In an illustrative embodiment, the electroactive structure may be an electrode for use in a lithium-ion cell, and the electroactive species may be lithium ions (Li^{t}). Accordingly, in some cases, a polymer layer is doped with lithium ions (e.g., the polymer layer is lithiated). In some cases, the number density of lithium ions in the polymer layer may be relatively high (e.g., greater than 1.0×10²⁰ Li atoms/cm³). In some embodiments, the number density of Li atoms in the polymer layer may be at least about 1.0×10²⁰ Li atoms/cm³, at least about 2.0×10²⁰ Li atoms/cm³, at least about 4.0×10²⁰ Li atoms/cm³, at least about 5.0×10²⁰ Li atoms/cm³, at least about 6.0×10²⁰ Li atoms/cm³, at least about 8.0×10²⁰ Li atoms/cm³, or at least about 1.0×10²¹ Li atoms/cm³. Correspondingly, in some cases, the number density of Li atoms in the polymer layer may be less than about 1.0×10²¹ Li atoms/cm³, less than about 8.0×10²⁰ Li atoms/cm³, less than about 6.0×10²⁰ Li atoms/cm³, less than about 5.0×10²⁰ Li atoms/cm³, less than about 4.0×10²⁰ Li atoms/cm³, less than about 2.0×10²⁰ Li atoms/cm³, or less than about 1.0×10²⁰ Li atoms/cm³. Combinations of the above-noted ranges are also possible (e.g., about 1.0×10²⁰ Li atoms/cm³ to about 1.0×10²¹ Li atoms/cm³). In some embodiments, the number density of Li atoms in the polymer layer is in the range of about 1.0×10²⁰ Li atoms/cm³ to about 2.0×10²⁰ Li atoms/cm³, about 1.0×10²⁰ Li atoms/cm³ to about 5.0×10²⁰ Li atoms/cm³, or about 1.0×10²⁰ Li atoms/cm³ to about 1.0×10²¹ Li atoms/cm³.

In some embodiments, the polymer layers described herein have characteristics that have been recognized to be advantageous for electrolytes in electrochemical cells. In certain cases, the polymer layer is relatively thin (e.g., has a thickness of about 100 nm or less). Thickness generally refers to the perpendicular distance from an interface between the polymer layer and an electroactive structure and an opposing surface of the polymer layer. It has been recognized that it may be advantageous for a polymer layer for use as an electrolyte in an electrochemical cell to be thin. For example, a decrease in thickness of a polymer layer may be associated with a concomitant increase in ionic conductivity. Without wishing to be bound by a particular theory, one reason a thinner polymer layer may exhibit increased ionic conductivity may be because the electroactive species (e.g., Li⁺) have a shorter distance to travel, reducing the amount of ohmic loss accordingly. Another reason why a thinner polymer layer may exhibit increased ionic conductivity may be because thicker polymers are more difficult to dope. In addition, in certain embodiments, the polymer layer may comprise a polymer comprising one or more rings, and a thicker polymer layer may have increased disorder in ring stacking. A thinner polymer layer may also be associated with other advantages. For example, a thinner polymer layer may be substantially smoother (e.g., have a lower surface roughness) than a thicker polymer layer, and therefore may have a lower probability of pinhole occurrence. In some cases, a thinner polymer layer may have a significantly lower ionic diffusion time than a thicker polymer layer. For example, ionic diffusion time τ may be related to ionic diffusion length Iᵢₒₙ according to Equation 1:

$$τ = \frac{{L}_{ion}^{2}}{{D}_{ion}} \qquad ( 1 )$$

where Dᵢₒₙ is the ionic diffusion coefficient. In some cases, a thinner polymer layer may exhibit a reduced ionic diffusion length and, therefore, a significantly shorter ionic diffusion time. In some embodiments, the polymer layer has a thickness of about 100 nm or less, about 75 nm or less, about 50 nm or less, about 35 nm or less, about 20 nm or less, about 15 nm or less, about 10 nm or less, or about 5 nm or less. Correspondingly, in some embodiments, the polymer layer has a thickness of about 5 nm or more, about 10 nm or more, about 15 nm or more, about 20 nm or more, about 35 nm or more, about 50 nm or more, about 75 nm or more, or about 100 nm or more. Combinations of the above-noted ranges are also possible (e.g., between about 5 nm and about 100 nm). Further non-limiting examples of suitable ranges include about 5 nm to about 35 nm, about 5 nm to about 50 nm, about 5 nm to about 75 nm, about 5 nm to about 100 nm, about 10 nm to about 35 nm, about 10 nm to about 50 nm, about 10 nm to about 75 nm, about 10 nm to about 100 nm, about 20 nm to about 50 nm, about 20 nm to about 75 nm, about 20 nm to about 100 nm, or about 50 nm to about 100 nm. The thickness of the polymer layer may be measured according to any method known in the art. For example, one suitable method of measuring thickness is variable angle spectroscopic ellipsometry (VASE). Measurements may be made at three incident angles (65°, 70°, and 75°), and the data may be fit to a Cauchy-Urbach isotropic model.

In some embodiments, the polymer layer has a relatively high ionic conductivity. Ionic conductivity is given its ordinary meaning in the art (e.g., ability of ions to migrate and thereby conduct electric current) and may be measured according to any method known in the art, such as electrochemical impedance spectroscopy (EIS). For example, impedance measurements may be made using a hanging mercury drop electrode, and ionic resistance may be determined by fitting the impedance measurements to an equivalent electrical circuit model. Ionic conductivity may then be calculated using Equation 2:

$$σ = \frac{Film thickness}{Ionic resistance \times Electrode contact area} \qquad ( 2 )$$

where film thickness may be obtained from VASE measurements and electrode contact area may be determined from the mercury drop size.

It has been recognized that it may be advantageous for a polymer electrolyte layer to have a relatively high ionic conductivity at least because a relatively high ionic conductivity may lead to low internal resistance, high energy density, high discharge capacity, and/or high rate capability in an electrochemical cell. Additionally, a relatively high ionic conductivity may avoid deleterious development of concentration polarization at an electrode of the electrochemical cell. In some embodiments, the polymer layer has an ionic conductivity of at least about 10⁻¹⁰ S/cm, at least about 10⁻⁹ S/cm, at least about 10⁻⁸ S/cm, at least about 10⁻⁷ S/cm, at least about 10⁻⁶ S/cm, at least about 10⁻⁵ S/cm, or at least about 10⁻⁴ S/cm. Correspondingly, in some cases, the polymer layer has an ionic conductivity of less than about 10⁻⁴ S/cm, less than about 10⁻⁵ S/cm, less than about 10⁻⁶ S/cm, less than about 10⁻⁷ S/cm, less than about 10⁻⁸ S/cm, less than about 10⁻⁹ S/cm, or less than about 10⁻¹⁰ S/cm. Combinations of the above-noted ranges are also possible (e.g., about 10⁻⁸ S/cm to about 10⁻⁶ S/cm). For example, the polymer layer may have an ionic conductivity in the range of about 10⁻¹⁰ S/cm to about 10⁻⁴ S/cm, about 10⁻⁹ S/cm to about 10⁻⁴ S/cm, 10⁻⁸ S/cm to about 10⁻⁴ S/cm, 10⁻⁷ S/cm to about 10⁻⁴ S/cm, 10⁻⁶ S/cm to about 10⁻⁴ S/cm, about 10⁻¹⁰ S/cm to about 10⁻⁶ S/cm, about 10⁻⁹ S/cm to about 10⁻⁶ S/cm, or about 10⁻⁸ S/cm to about 10⁻⁶ S/cm. In some embodiments, the polymer layer has a relatively high ionic conductivity at a temperature of about 200° C. or less, about 150° C. or less, about 100° C. or less, about 50° C. or less, about 25° C. or less, or about 15° C. or less.

In some embodiments, the polymer layer has a relatively high ionic conductivity at about room temperature (e.g., about 25° C.). It has been recognized that it may be important for certain applications (e.g., sensing, medical implants) for the polymer layer to have relatively high ionic conductivity at room temperature. In some embodiments, the polymer layer has an ionic conductivity of at least about 10⁻¹⁰ S/cm, at least about 10⁻⁹ S/cm, at least about 10⁻⁸ S/cm, at least about 10⁻⁷ S/cm, at least about 10⁻⁶ S/cm, at least about 10⁻⁵ S/cm, or at least about 10⁻⁴ S/cm at about room temperature (e.g., about 25° C.). Correspondingly, in some cases, the polymer layer has an ionic conductivity of less than about 10⁻⁴ S/cm, less than about 10⁻⁵ S/cm, less than about 10⁻⁶ S/cm, less than about 10⁻⁷ S/cm, less than about 10⁻⁸ S/cm, less than about 10⁻⁹ S/cm, or less than about 10⁻¹⁰ S/cm at about room temperature (e.g., about 25° C.). Combinations of the above-noted ranges are also possible (e.g., about 10⁻⁸ S/cm to about 10⁻⁶ S/cm). For example, the polymer layer may have an ionic conductivity in the range of about 10⁻ 10S/cm to about 10⁻⁴ S/cm, about 10⁻⁹ S/cm to about 10⁻⁴ S/cm, about 10⁻⁸ S/cm to about 10⁻⁴ S/cm, about 10⁻⁷ S/cm to about 10⁻⁴ S/cm, about 10⁻⁶ S/cm to about 10⁻⁴ S/cm, about 10⁻¹⁰ S/cm to about 10⁻⁶ S/cm, about 10⁻⁹ S/cm to about 10⁻⁶ S/cm, or about 10⁻⁸ S/cm to about 10⁻⁶ S/cm at about room temperature (e.g., about 25° C.).

In some embodiments, the polymer layer has relatively low electronic conductivity (e.g., the polymer layer is substantially electronically insulating). It may be desirable for the polymer layer to have low electronic conductivity, for example, in order to prevent an electrical short circuit between an anode and a cathode of an electrochemical cell. Electronic conductivity is given its ordinary meaning in the art (e.g., ability of electrons to migrate and thereby conduct electric current) and may be measured according to any method known in the art, such as electrochemical impedance spectroscopy. For example, impedance measurements may be made using a hanging mercury drop electrode, and electronic resistance (e.g., DC resistance) may be determined by fitting the impedance measurements to an equivalent electrical circuit model. Electronic conductivity may then be calculated from the electrical resistance values using Equation 3:

$$σ = \frac{Film thickness}{Electronic resistan ce \cdot Electrode conta ct area} \qquad ( 3 )$$

where film thickness may be obtained from VASE measurements and electrode contact area may be determined from the mercury drop size.

In some embodiments, the polymer layer has an electronic conductivity of about 10⁻¹⁰ S/cm or less, about 10⁻¹¹ S/cm or less, about 10⁻¹² S/cm or less, about 10⁻¹³ S/cm or less, or about 10⁻¹⁴ S/cm or less. In some embodiments, the polymer layer has an electronic conductivity in the range of about 10⁻¹⁴ S/cm to about 10⁻¹⁰ S/cm, about 10⁻¹⁴ S/cm to about 10⁻¹¹ S/cm, about 10⁻¹⁴ S/cm to about 10⁻¹² S/cm, or about 10⁻¹⁴ S/cm to about 10⁻¹³ S/cm.

According to some embodiments, the polymer layer is relatively smooth (e.g., has low surface roughness). It may be important for a polymer electrolyte layer to be relatively smooth, as large variations in thickness may increase the likelihood of pinhole defects, which may result in electrical shorting. The surface roughness of the polymer layer may be quantified using any appropriate method. For example, a surface roughness profile may be obtained through atomic force microscopy (AFM). A mean line may be established, and deviation from the mean line may be measured. One measure of surface roughness is root mean square roughness R_{RMS}, which can be calculated according to Equation 4:

$$\sqrt{\frac{1}{N} {\sum }_{i = 1}^{N} {R}_{i}^{2}} \qquad ( 4 )$$

where Rᵢ is the height at the i^{th} point in a surface roughness profile and N is the number of points that were measured. In some cases, the polymer layer has a root mean square surface roughness R_{RMS} of about 2 nm or less, about 1.5 nm or less, about 1 nm or less, about 0.8 nm or less, about 0.6 nm or less, about 0.5 nm or less, about 0.4 nm or less, about 0.3 nm or less, about 0.2 nm or less, or about 0.1 nm or less. In some cases, the polymer layer has a root mean square surface roughness R_{RMS} of about 0.1 nm or more, about 0.2 nm or more, about 0.3 nm or more, about 0.4 nm or more, about 0.5 nm or more, about 0.6 nm or more, about 0.8 nm or more, about 1 nm or more, about 1.5 nm or more, or about 2 nm or more. Combinations of the above-noted ranges (e.g., about 0.2 nm to about 1 nm) are also possible. In some cases, the polymer layer has a root mean square surface roughness R_{RMS} in the range of about 0.1 nm to about 0.3 nm, about 0.1 nm to about 0.4 nm, about 0.1 nm to about 0.5 nm, about 0.1 nm to about 0.6 nm, about 0.1 nm to about 0.7 nm, about 0.1 nm to about 0.8 nm, about 0.1 nm to about 0.9 nm, about 0.1 nm to about 1 nm, about 0.1 nm to about 1.5 nm, about 0.1 nm to about 2 nm, about 0.2 nm to about 0.4 nm, about 0.2 nm to about 0.5 nm, about 0.2 nm to about 0.6 nm, about 0.2 nm to about 1 nm, about 0.2 nm to about 1.5 m, about 0.2 nm to about 2 nm, about 0.5 nm to about 0.6 nm, about 0.5 nm to about 0.7 nm, about 0.5 nm to about 0.8 nm, about 0.5 nm to about 0.9 nm, about 0.5 nm to about 1 nm, about 0.5 nm to about 1.5 nm, or about 0.5 nm to about 2 nm.

According to some embodiments, a polymer having a relatively low root mean square surface roughness has a relatively high ionic conductivity. In certain cases, for example, a polymer having a relatively low root mean square surface roughness may have been doped with an electroactive species (e.g., lithiated).

In some embodiments, the polymer layer is substantially continuous. In certain cases, the polymer layer is substantially free of discontinuities (e.g., the polymer layer is pinhole-free). It has been recognized that each discontinuity (e.g., defect, pinhole) represents a current path that can lead to electrical shorting between electrodes, and it therefore may be advantageous for a polymer layer to be substantially free of discontinuities. In some embodiments, the polymer layer is substantially free of discontinuities above a certain size. For example, in certain cases, the polymer layer is substantially free of discontinuities having a maximum cross-sectional dimension greater than about 5 nm, greater than about 4 nm, greater than about 3 nm, greater than about 2 nm, greater than about 1 nm, greater than about 0.5 nm, or greater than about 0.1 nm. In some embodiments, the polymer layer is substantially free of discontinuities having a maximum cross-sectional dimension in the range of about 0.1 nm to about 1 nm, about 0.1 nm to about 5 nm, about 0.5 nm to about 1 nm, about 0.5 nm to about 5 nm, or about 1 nm to about 5 nm.

The size of the discontinuities (e.g., pinholes) in the polymer layer may be measured according to any technique known in the art. For example, in one suitable method, a pair of redox couples with different solvation shell diameters, such as decamethylferrocene (dmFc) and cobaltocenium hexafluorophosphate (CoCp₂PF₆), may be employed to observe changes in cyclic voltammograms as a function of redox molecule size. Oxidation peak current densities may be obtained at scan rates of 700 mV/s.

In some embodiments, the number density of discontinuities in the polymer layer may be relatively low. For example, in certain cases, the number density of discontinuities in the polymer layer is about 10 discontinuities/μm² or less, about 8 discontinuities/μm² or less, about 6 discontinuities/μm² or less, about 4 discontinuities/μm² or less, about 2 discontinuities/μm² or less, or about 1 discontinuity/μm² or less. In some embodiments, the polymer layer has a number density of discontinuities in the range of about 1 discontinuity/μm² to about 4 discontinuities/μm², about 1 discontinuity/μm² to about 6 discontinuities/μm², about 1 discontinuity/μm² to about 8 discontinuities/μm², or about 1 discontinuity/μm² to about 10 discontinuities/μm².

The number density of discontinuities in the polymer layer may be determined according to any technique known in the art. For example, electrochemical techniques may be used. Using cyclic voltammetry, a redox molecule (e.g., ferrocene, ferrocenium, cobaltocene, cobaltocenium, decamethyl ferrocene, cobaltocenium hexafluorophosphate) may be used to probe the surface of the polymer layer. The number density N may then be calculated using Equation 5:

$$N = \frac{j}{4 n FDC * {r}_{0}} \qquad ( 5 )$$

where j is the peak current density, n is the number of electrons transferred per redox molecule, r₀ is the average radius of the discontinuities (e.g., as determined using the methods described above), F is the Faraday constant, D is the diffusion coefficient for a redox system with bare working electrodes, and C* is the concentration of the probe molecule (e.g., redox molecule).

In some embodiments, the polymer layer provides substantially full coverage of an electroactive structure. For example, the polymer layer may cover at least about 80%, at least about 90%, at least about 95%, at least about 99%, or about 100% of the surface area of an electroactive structure. In some embodiments, the polymer layer may cover between 80% and 90%, between 80% and 95%, between 80% and 100%, between 90% and 100%, or between 95% and 100% of the surface area of an electroactive structure.

In some embodiments, the polymer layer has a substantially uniform thickness (e.g., the thickness of the polymer layer has a standard deviation within about 20% or less, about 10% or less, about 5% or less, or about 1% or less of an average thickness of the polymer layer). As noted above, one method for measuring the thickness of a polymer layer is VASE. In certain embodiments, the thickness of the polymer layer has a standard deviation within about 20% or less, about 10% or less, about 5% or less, or about 1% or less of an average thickness of the polymer layer. In some embodiments, the polymer layer has a thickness having a standard deviation in the range of about 1% to about 5% of the average thickness, about 1% to about 10% of the average thickness, about 1% to about 20% of the average thickness, or about 5% to about 20% of the average thickness.

In some embodiments, the polymer layer substantially conformally coats the electroactive structure. As used herein, a “conformal” coating refers to a coating formed on and attached or adhered to a material (e.g., an underlying material), wherein the coating physically matches the exterior contour of the surface area of the underlying material and the coating does not substantially change the morphology of the underlying material. That is, the coated material has a morphology that is essentially the same as the morphology of an essentially identical material lacking the polymer coating, under essentially identical conditions. It should be understood that the conformal coating may uniformly increase one or more dimensions (e.g., thickness) of the material, however, the overall morphology of the material remains essentially unchanged. For example, a conformal coating on a cylindrical electrode may form a cylindrically-shaped coating around the electrode. Such properties may be advantageous, for example, when preservation of certain properties (e.g., high aspect ratio of a nanostructure) is desired and known coating techniques may produce undesired irregularities and morphological changes that may adversely affect the desired properties. In some cases, conformal coatings may be formed on materials having a high aspect ratio (e.g., nanostructures). Additionally, the conformal coating may form a stable structure and may not delaminate from the surface of the nanostructures. As used herein, the terms “attached” or “adhered” refer to attachment or adhesion via covalent bonds, non-covalent bonds (e.g., ionic bonds, van der Waals forces, etc.), and the like.

The polymer layer may comprise any suitable polymer. As is well recognized in the art, a polymer generally refers to a molecule comprising a plurality of repeat units. As used herein, a “repeat unit” is given its ordinary meaning in the art, e.g., an atom or group of atoms (including pendant atoms or groups, if any), the repetition of which comprises a part of the essential structure of the polymer. Those of ordinary skill in the art will be able to identify and describe the repeat units that a polymer comprises. A polymer is generally formed through polymerization of a plurality of monomers (also referred to as monomeric precursors). In some cases, the polymer is a homopolymer (e.g., formed through polymerization of a single type of monomer). A homopolymer generally has one type of repeat unit. In some embodiments, the polymer is a copolymer (e.g., formed through polymerization of two or more types of monomers). A copolymer generally has two or more types of repeat units. The two or more types of repeat units may be distributed within the polymer in any order, including random orders and periodic orders, such as alternating, block, or other repeating orders. The polymer may be formed from any suitable monomer or combination of monomers.

In some embodiments, a repeat unit of the polymer comprises at least one heteroatom (e.g., an atom that is not carbon or hydrogen). In some embodiments, a repeat unit of the polymer comprises at least two heteroatoms, where the heteroatoms may be the same or different. In certain cases, a repeat unit of the polymer may comprise at least about three, at least about four, at least about five, at least about six, at least about seven, at least about eight, at least about nine, or at least about ten heteroatoms, where the heteroatoms may be the same or different. In certain embodiments, a repeat unit of the polymer comprises at least one heteroatom that is relatively electronegative. For example, in some instances, a repeat unit of the polymer comprises at least one heteroatom having a Pauling electronegativity of at least about 1.5, at least about 2, at least about 2.5, or at least about 3. In particular embodiments, at least one heteroatom is oxygen or nitrogen. In certain cases, a repeat unit of the polymer comprises at least one, at least two, at least three, at least four, at least five, or at least six oxygen atoms. In some embodiments, a repeat unit comprises at least one, at least two, at least three, at least four, at least five, or at least six nitrogen atoms. In some embodiments, at least one heteroatom is silicon. A repeat unit of the polymer may, in some cases, comprise at least one relatively polar bond (e.g., a bond between two atoms where the difference in electronegativity between the two atoms is in the range of about 0.4 to about 2.0). It may be advantageous, for example, for a repeat unit of the polymer to comprise a relatively polar bond, as it may result in an atom having more negative charge and potentially providing an attractive binding site for electroactive species (e.g., Li⁺).

In certain cases, a repeat unit of the polymer comprises a siloxane (e.g., an organosiloxane) and/or a silazane (e.g., an organosilazane). It has been recognized, in some cases, that siloxane and/or silazane segments may advantageously increase the ionic conductivity of a polymer. Without wishing to be bound by a particular theory, siloxane and/or silazane segments may comprise relatively polar bonds in which the oxygen atom or nitrogen atom has a relatively negative charge. The oxygen atom of a siloxane segment or the nitrogen atom of a silazane segment may thus have enhanced ability to chelate cations, such as certain electroactive species (e.g., Li⁺). Further, the flexible nature and free volume of siloxane and/or silazane segments may facilitate ionic transport. Additionally, siloxane and/or silazane segments may impart other advantages, such as mechanical and/or electrochemical stability.

In some cases, a repeat unit of the polymer comprises one or more organic ring structures. An organic ring structure generally refers to a ring structure comprising at least one carbon atom. In some cases, the ring structure has a ring diameter that is large enough for an electroactive species (e.g., Li⁺) to pass through. In some cases, the polymer comprises a ring structure having a ring diameter of at least about 150 pm, at least about 180 pm, at least about 200 pm, at least about 220 pm, at least about 250 pm, at least about 300 pm, at least about 350 pm, at least about 400 pm, at least about 450 pm, at least about 500 pm, at least about 550 pm, or at least about 600 pm. In some embodiments, the polymer comprises a ring structure having a ring diameter in the range of about 150 pm to about 200 pm, about 150 pm to about 250 pm, about 150 pm to about 300 pm, about 150 pm to about 400 pm, about 150 pm to about 500 pm, about 150 pm to about 600 pm, about 200 pm to about 250 pm, about 200 pm to about 300 pm, about 200 pm to about 400 pm, about 200 pm to about 500 pm, about 200 pm to about 600 pm, about 300 pm to about 400 pm, about 300 pm to about 500 pm, or about 300 pm to about 600 pm. The ring structure may, in some embodiments, be at least a three-membered ring, at least a four-membered ring, at least a five-membered ring, at least a six-membered ring, at least a seven-membered ring, or at least an eight-membered ring. In certain cases, a plurality of ring structures may stack in a polymer to form ion transport channels (e.g., Li⁺ transport channels).

In some embodiments, a repeat unit of the polymer comprises one or more organic ring structures, where at least one organic ring structure comprises at least one heteroatom. In some embodiments, at least one organic ring structure comprises at least two heteroatoms. At least one organic ring structure may, in some cases, comprise a cyclosiloxane (e.g., a cyclotrisiloxane, a cyclotetrasiloxane) and/or a cyclosilazane (e.g., a cyclotrisilazane, a cyclotetrasilazane).

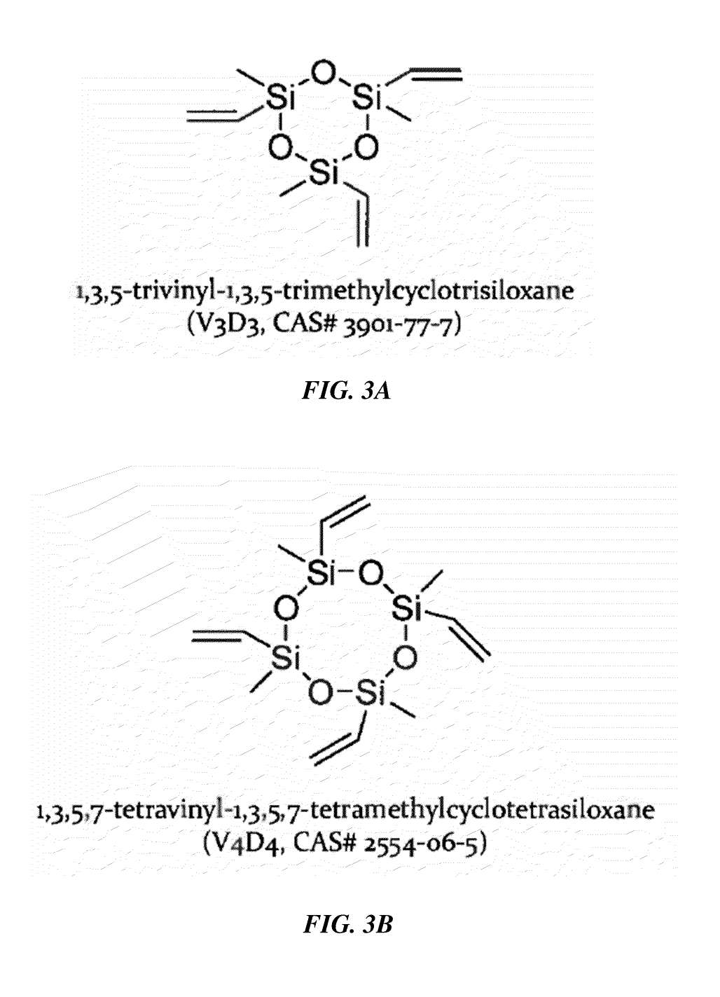

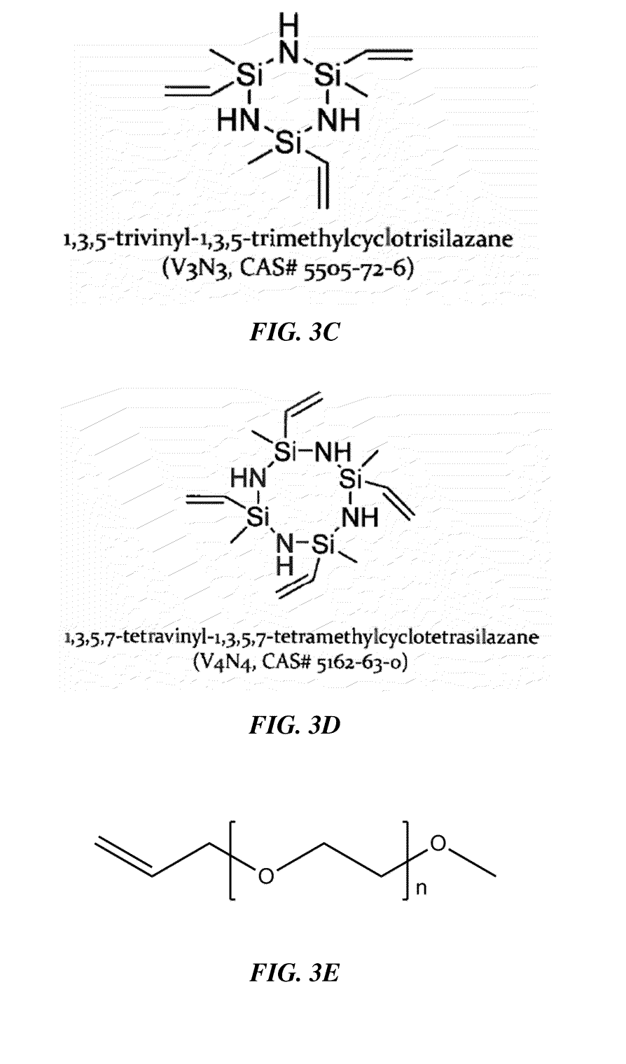

The polymer may be formed from any suitable monomer, oligomer, or combination of monomers and/or oligomers. These monomers and/or oligomers may also be referred to as monomeric precursors or oligomeric precursors. Non-limiting examples of suitable monomers and oligomers include 1,3,5-trivinyl-1,3,5-trimethylcyclotrisiloxane (C₉H₁₈O₃Si₃, also referred to as V3D3, FIG. 3A), 1,3,5,7-tetravinyl-1,3,5,7-tetramethylcyclotetrasiloxane (C₄H₂₄O₄Si₄, also referred to as V4D4, FIG. 3B), 1,3,5-trivinyl-1,3,5-trimethylcyclotrisilazane (C₉H₂₁N₃Si₃, also referred to as V3N3, FIG. 3C), 1,3,5,7-tetravinyl-1,3,5,7-tetramethylcyclotetrasilazane (C₁₂H₂₈N₄Si₄, also referred to as V4N4, FIG. 3D), oligo(ethylene glycol) allyl methyl ether (OEGAME, FIG. 3E), ethylene oxide, ethylene glycol divinyl ether, diethylene glycol divinyl ether (DEGDVE), trivinyl-1,1,3,5,5-pentamethyltrisiloxane (TVTSO), vinylpolydimethylsiloxane (VPDMS), methyl methacrylate, and butyl acrylate.

In some embodiments, a monomeric precursor of the polymer comprises at least one cross-linkable side group. As used herein, a cross-linkable side group refers to a group that can form at least one covalent bond during polymerization of the monomeric precursor. A non-limiting example of a suitable cross-linkable side group is a vinyl group. It has been recognized that it may be advantageous for a monomeric precursor of the polymer to comprise at least one cross-linkable side group to promote polymerization and enhance stability.

In some embodiments, at least a portion of the polymer of the polymer layer is crosslinked. In some embodiments, at least about 30%, at least about 40%, at least about 50%, at least about 60%, at least about 70%, at least about 80%, at least about 90%, or about 100% by weight of the polymer of the polymer layer is crosslinked. Correspondingly, in some embodiments, less than about 100%, less than about 90%, less than about 80%, less than about 70%, less than about 60%, less than about 50%, less than about 40%, or less than about 30% by weight of the polymer of the polymer layer is crosslinked. Combinations of the above-noted ranges are also possible (e.g., about 30% to about 90% by weight of the polymer of the polymer layer may be crosslinked). It has been recognized that, in some cases, crosslinked networks may advantageously enhance stability.

In some embodiments, the polymer is a homopolymer. In certain cases, the homopolymer is poly(1,3,5-trivinyl-1,3,5-trimethylcyclotrisiloxane) (PV3D3), poly(1,3,5,7-tetravinyl-1,3,5,7-tetramethylcyclotetrasiloxane) (PV4D4), poly(1,3,5-trivinyl-1,3,5-trimethylcyclotrisilazane) (PV3N3), poly(1,3,5,7-tetravinyl-1,3,5,7-tetramethylcyclotetrasilazane) (PV4N4), poly(oligo(ethylene glycol) allyl methyl ether) (pOEGAME), poly(ethylene) glycol divinyl ether (PEGDVE), polyethylene oxide (PEO) or poly(methyl methacrylate) (PMMA). In some embodiments, the polymer is a copolymer. The copolymer may be formed from any combination of the monomers or oligomers described herein. Suitable copolymers include, but are not limited to, PV4D4-co-diethylene glycol divinyl ether (PV4D4-DEGDVE), p(OEGAME-co-DEGDVE), poly(OEGAME-co-1,3,5-trivinyl-1,1,3,5,5-pentamethyltrisiloxane) (p(OEGAME-co-TVTSO)), poly(OEGAME-co-vinylpolydimethylsiloxane) (p(OEGAME-co-VPDMS)), and PV4D4-co-butyl acrylate (PV4D4-BA).

Certain embodiments relate to articles comprising an electroactive structure. As used herein, an electroactive structure refers to a structure that is capable of participating in an electrochemical process (e.g., a lithium intercalation process) in an electrochemical cell. For example, in some cases, the electroactive structure may be an electrode (e.g., a positive electrode, a negative electrode) in an electrochemical cell. In some cases, the electroactive structure comprises an electroactive material (e.g., a material that is capable of participating in an electrochemical process in an electrochemical cell). In certain embodiments, the electroactive structure further comprises a non-electroactive material (e.g., a material that is not capable of participating in an electrochemical process in an electrochemical cell). For example, the electroactive structure may comprise the following non-electroactive components: a substrate and/or one or more binders. The substrate may comprise an electrically conductive material or an electrically insulating material.

In an illustrative embodiment, the electroactive structure is a positive electrode (e.g., a cathode) for use in a lithium-ion electrochemical cell. In some embodiments, the cathode comprises an electroactive material. In certain embodiments, the electroactive material comprises a lithium intercalation compound (e.g., a compound capable of inserting and extracting lithium ions). In some embodiments, the electroactive material comprises a layered oxide (e.g., an oxide having a lamellar structure). Non-limiting examples of layered oxides include lithium cobalt oxide (LiCoO₂), lithium nickel oxide (LiNiO₂), lithium manganese oxide (LiMnO₂), lithium nickel manganese cobalt oxide (LiNiₓMn_{y}Co_{z}O₂, where the sum of x, y, and z is 1), and lithium nickel cobalt aluminum oxide (LiNiₓCo_{y}Al_{z}O₂, where the sum of x, y, and z is 1). In some embodiments, the electroactive material comprises a transition metal polyanion oxide (e.g., a compound comprising a transition metal, an oxygen, and/or an anion having a charge with an absolute value greater than 1). Non-limiting examples of suitable transition metal polyanion oxides include lithium iron phosphate (LiFePO₄) and lithium manganese iron phosphate (LiMnₓFe₁₋ₓPO₄). In some embodiments, the electroactive material comprises a spinel (e.g., a compound having the structure AB₂O₄, where A can be Li, Mg, Fe, Mn, Zn, Cu, Ni, Ti, or Si, and B can be Al, Fe, Cr, Mn, or V). Non-limiting examples of suitable spinels include lithium manganese oxide (LiMn₂O₄) and lithium manganese nickel oxide (LiNiₓM₂₋ₓO₄).

In an illustrative embodiment, the electroactive structure is a negative electrode (e.g., an anode) for use in a lithium-ion electrochemical cell. In some embodiments, the anode comprises an electroactive material. In some embodiments, the electroactive material comprises carbon. Examples of suitable carbon-containing materials include, but are not limited to, graphite, petroleum coke, and mesocarbon microbeads (MCMB). Graphite generally refers to a material comprising a plurality of layers of graphene (e.g., layers comprising carbon atoms arranged in a hexagonal lattice). Adjacent graphene layers are typically attracted to each other via van der Waals forces, although covalent bonds may be present between one or more sheets in some cases. In certain embodiments, the electroactive material comprises MCMB in combination with one or more binders. Non-limiting examples of suitable binders include polyacrylonitrile (PAN) and carboxymethyl cellulose (CMC). In some embodiments, the electroactive material comprises silicon, lithium, antimony, tin, tin dioxide (SnO₂), titanium dioxide (TiO₂), lithium titanate (Li₂TiO₃), or an intermetallic compound (e.g., Co—Sb). In some embodiments, the electroactive material comprises an alloy comprising silicon, lithium, antimony, and/or tin.

While particular materials relating to electrodes of a lithium-ion electrochemical cell have been described, the electroactive structure may comprise any suitable electroactive material for use in any type of electrochemical cell. Non-limiting examples of types of electrochemical cells include a nickel-cadmium electrochemical cell, a nickel-zinc electrochemical cell, a nickel-metal hydride electrochemical cell, a zinc-air cell, a silver-zinc cell, and a lithium-sulfur cell. Examples of suitable electroactive materials for the electroactive structure include, but are not limited to, lithium metal, sulfur, nickel, cadmium, zinc, silver, platinum, and manganese dioxide.

The electroactive structure may have any suitable cross-sectional shape. In some embodiments, the cross section of the structure may be substantially circular, substantially elliptical, substantially square, substantially rectangular, substantially triangular, substantially polygonal, or any other suitable shape. In some embodiments, the cross section of the electroactive structure may have an irregular shape.

The electroactive structure may have any suitable shape. In some embodiments, the structure may be substantially cylindrical. In some embodiments, the structure is a rectangular prism, a triangular prism, or any polygonal prism. In certain embodiments, the structure has an irregular shape.

In certain cases, the electroactive structure has a relatively small size. In some embodiments, the electroactive structure is a nanostructure (e.g., a nanorod, a nanotube, a nanofiber, a nanowhisker). In some embodiments, the electroactive structure has a maximum cross-sectional dimension of about 100 microns or less, about 80 microns or less, about 50 microns or less, about 20 microns or less, about 10 microns or less, about 5 microns or less, about 1 micron or less, about 500 nm or less, about 100 nm or less, about 50 nm or less, about 20 nm or less, about 10 nm or less, about 5 nm or less, or about 1 nm or less. In some embodiments, the electroactive structure has a maximum cross-sectional dimension of at least about 1 nm, at least about 5 nm, at least about 10 nm, at least about 20 nm, at least about 50 nm, at least about 100 nm, at least about 500 nm, at least about 1 micron, at least about 5 microns, at least about 10 microns, at least about 20 microns, at least about 50 microns, at least about 80 microns, or at least about 100 microns. Combinations of the above-noted ranges are also possible (e.g., about 1 nm to about 100 microns). In some embodiments, the electroactive structure has a maximum cross-sectional dimension in the range of about 1 nm to about 20 nm, about 1 nm to about 50 nm, about 1 nm to about 100 nm, about 1 nm to about 500 nm, about 1 nm to about 1 micron, about 1 nm to about 50 microns, or about 1 nm to about 100 microns.

In some embodiments, the electroactive structure has a height of about 100 microns or less, about 80 microns or less, about 50 microns or less, about 20 microns or less, about 10 microns or less, about 5 microns or less, about 1 micron or less, about 500 nm or less, about 100 nm or less, about 50 nm or less, about 20 nm or less, about 10 nm or less, about 5 nm or less, or about 1 nm or less. In some embodiments, the electroactive structure has a height of at least about 1 nm, at least about 5 nm, at least about 10 nm, at least about 20 nm, at least about 50 nm, at least about 100 nm, at least about 500 nm, at least about 1 micron, at least about 5 microns, at least about 10 microns, at least about 20 microns, at least about 50 microns, at least about 80 microns, or at least about 100 microns. Combinations of the above-noted ranges are also possible (e.g., about 1 nm to about 100 microns). In some embodiments, the electroactive structure has a height in the range of about 1 nm to about 20 nm, about 1 nm to about 50 nm, about 1 nm to about 100 nm, about 1 nm to about 500 nm, about 1 nm to about 1 micron, about 1 nm to about 50 microns, about 1 nm to about 100 microns, about 10 nm to about 50 nm, about 10 nm to about 100 nm, about 10 nm to about 500 nm, about 10 nm to about 1 micron, about 10 nm to about 50 microns, about 10 nm to about 100 microns, about 100 nm to about 500 nm, about 100 nm to about 1 micron, about 100 nm to about 50 microns, about 100 nm to about 100 microns, about 1 micron to about 10 microns, about 1 micron to about 20 microns, about 1 micron to about 50 microns, or about 1 micron to about 100 microns.

Certain embodiments relate to articles comprising a plurality of electroactive structures. In some embodiments, the plurality of electroactive structures comprises at least about 2, at least about 3, at least about 4, at least about 5, at least about 10, at least about 20, at least about 50, at least about 100, at least about 200, at least about 500, at least about 1000, at least about 2000, at least about 5000, or at least about 10,000 electroactive structures. In some embodiments, the plurality of electroactive structures comprises between about 2 to about 10 electroactive structures, about 2 to about 50 electroactive structures, about 2 to about 100 electroactive structures, about 2 to about 500 electroactive structures, about 2 to about 1000 electroactive structures, about 2 to about 5000 electroactive structures, about 2 to about 10,000 electroactive structures, about 10 to about 100 electroactive structures, about 10 to about 500 electroactive structures, about 10 to about 1000 electroactive structures, about 10 to about 5000 electroactive structures, about 10 to about 10,000 electroactive structures, about 100 to about 1000 electroactive structures, about 100 to about 5000 electroactive structures, about 100 to about 10,000 electroactive structures, about 1000 to about 5000 electroactive structures, or about 1000 to about 10,000 electroactive structures. In some cases, the plurality of electroactive structures may be substantially ordered (e.g., in a periodic array). In some embodiments, the plurality of electroactive structures may be substantially disordered (e.g., in an aperiodic array, a random configuration).

The electroactive structure may be fabricated according to any method known in the art. In certain embodiments, the electroactive structure may be grown (e.g., a nanostructure such as a nanowire may be grown using catalyst particles). In some cases, the electroactive structure may be formed by etching (e.g., troughs may be etched in a wafer). In certain embodiments, the electroactive structure may comprise an electroactive material that has been grown or that has been etched. In some cases, the electroactive structure may comprise a substrate (e.g., comprising a non-electroactive material) that has been grown or that has been etched. For example, a wafer comprising a non-electroactive material may be etched to form a high-aspect-ratio substrate. An electroactive material may then be conformally deposited (e.g., via chemical vapor deposition, sputtering, or any suitable deposition method) on the substrate. In some embodiments, the electroactive-material-comprising layer may be relatively thin. For example, in certain cases, the electroactive-material-comprising layer may have a thickness of about 100 nm or less, about 50 nm or less, about 35 nm or less, about 20 nm or less, about 15 nm or less, about 10 nm or less, or about 5 nm or less. In some embodiments, the electroactive-material-containing layer may have a thickness in the range of about 5 nm to about 35 nm, about 5 nm to about 50 nm, about 5 nm to about 100 nm, about 10 nm to about 35 nm, about 10 nm to about 50 nm, about 10 nm to about 100 nm, about 20 nm to about 50 nm, about 20 nm to about 100 nm, or about 35 nm to about 100 nm.

Some aspects relate to an electrochemical cell comprising a first electroactive structure, a second electroactive structure, and a polymer electrolyte layer positioned between the first electroactive structure and the second electroactive structure. In certain embodiments, the first electroactive structure comprises an electroactive species, and the polymer electrolyte layer is doped with the electroactive species. The electrochemical cell may have any type of suitable chemistry. In some embodiments, the electrochemical cell is a lithium-ion electrochemical cell, a nickel-cadmium electrochemical cell, a nickel-zinc electrochemical cell, a nickel-metal hydride electrochemical cell, a zinc-air cell, a silver-zinc cell, or a lithium-sulfur cell.

In an illustrative embodiment, the electrochemical cell is a lithium-ion electrochemical cell. The first electroactive structure of the electrochemical cell may be an anode. The first electroactive structure may, for example, comprise carbon (e.g., graphite, petroleum coke, mesocarbon microbeads), silicon, lithium, antimony, tin, tin dioxide (SnO₂), titanium dioxide (TiO₂), lithium titanate (Li₂TiO₃), or an intermetallic compounds (e.g., Co—Sb). In some embodiments, the first electroactive structure comprises an alloy of silicon, lithium, antimony, and/or tin. The second electroactive structure of the electrochemical cell may be a cathode. The second electroactive structure may, for example, comprise a lithium intercalation compound (e.g., lithium cobalt oxide, lithium iron phosphate, lithium nickel oxide, lithium manganese oxide, lithium nickel cobalt manganese oxide).

In some embodiments, the first electroactive structure and/or the second electroactive structure of the electrochemical cell have a non-planar geometry. In some embodiments, the first electroactive structure and/or the second electroactive structure have a high aspect ratio. The aspect ratio of the first and/or second electroactive structure may, in some embodiments, be at least about 2:1, at least about 3:1, at least about 4:1, at least about 5:1, at least about 10:1, at least about 20:1, at least about 50:1, at least about 100:1, at least about 200:1, at least about 500:1, at least about 1000:1, at least about 2000:1, at least about 3000:1, at least about 4000:1, at least about 5000:1, or at least about 10,000:1. Correspondingly, in some embodiments, the aspect ratio of the first and/or second electroactive structure may be about 10,000:1 or less, about 5000:1 or less, about 4000:1 or less, about 3000:1 or less, about 2000:1 or less, about 1000:1 or less, about 500:1 or less, about 200:1 or less, about 100:1 or less, about 50:1 or less, about 20:1 or less, about 10:1 or less, about 5:1 or less, about 4:1 or less, about 3:1 or less, or about 2:1 or less. Combinations of the above-noted ranges are also possible (e.g., about 4:1 to about 1000:1). In some embodiments, the aspect ratio of the first and/or second electroactive structure is in the range of about 2:1 to about 10:1, about 2:1 to about 100:1, about 2:1 to about 500:1, about 2:1 to about 1000:1, about 2:1 to about 5000:1, about 2:1 to about 10,000:1, about 5:1 to about 10:1, about 5:1 to about 100:1, about 5:1 to about 500:1, about 5:1 to about 1000:1, about 5:1 to about 5000:1, about 5:1 to about 10,000:1, about 10:1 to about 100:1, about 10:1 to about 500:1, about 10:1 to about 1000:1, about 10:1 to about 5000:1, about 10:1 to about 10,000:1, about 50:1 to about 100:1, about 50:1 to about 500:1, about 50:1 to about 1000:1, about 50:1 to about 5000:1, about 50:1 to about 10,000:1, about 100:1 to about 500:1, about 100:1 to about 1000:1, about 100:1 to about 5000:1, about 100:1 to about 10,000:1, about 500:1 to about 1000:1, about 500:1 to about 5000:1, about 500:1 to about 10,000:1, about 1,000:1 to about 5,000:1, about 1000:1 to about 10,000:1, or about 5000:1 to about 10,000:1.

The first and second electroactive structures may have any suitable shape. In some embodiments, the cross section of the first and/or second electroactive structure may be substantially circular, substantially elliptical, substantially square, substantially rectangular, substantially triangular, substantially polygonal, or any other suitable shape. In some embodiments, the cross section of the first and/or second electroactive structure may have an irregular shape. In some embodiments, the first and/or second electroactive structure may be substantially cylindrical. In some embodiments, the first and/or second electroactive structure is a rectangular prism, a triangular prism, or any polygonal prism. In certain embodiments, the first and/or second electroactive structure has an irregular shape.

In some embodiments, the electrochemical cell comprises a plurality of first electroactive structures and/or a plurality of second electroactive structures. A polymer electrolyte layer may be positioned between the first electroactive structures and the second electroactive structures, such that none of the first electroactive structures are in direct contact with any of the second electroactive structures.

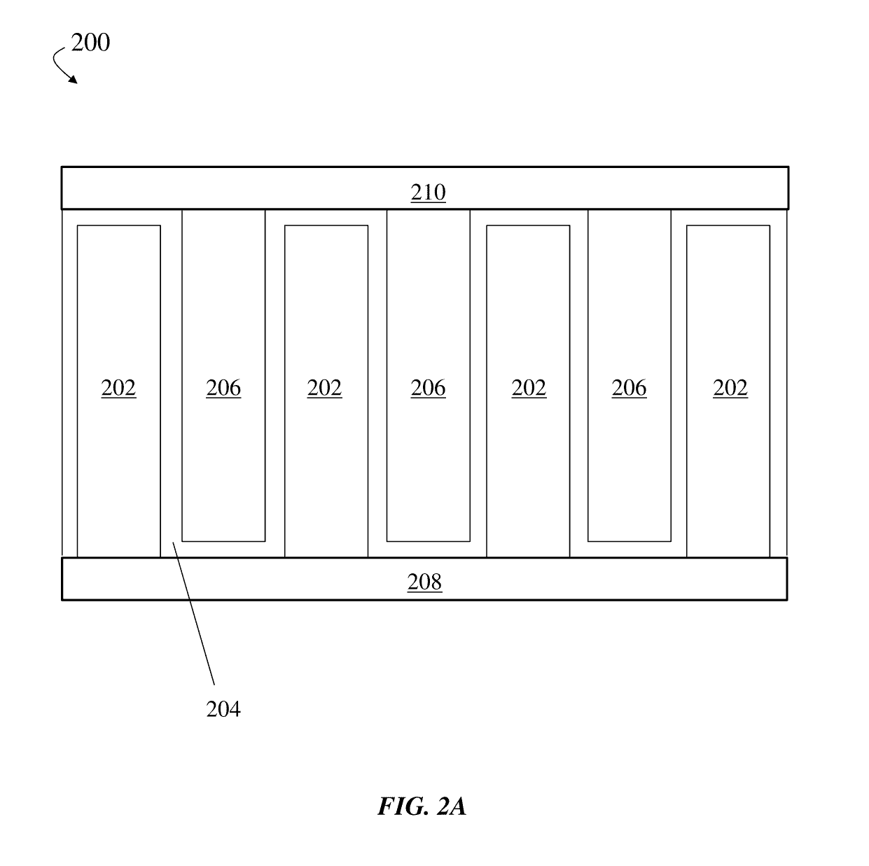

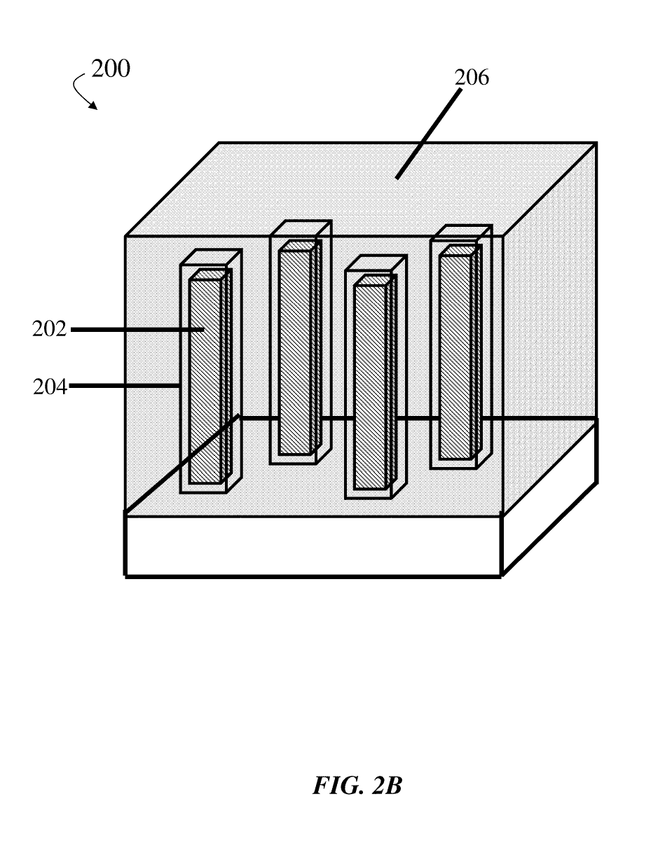

The first electroactive structures and second electroactive structures of the electrochemical cell may be arranged in any suitable configuration. In some embodiments, the first electroactive structures and/or second electroactive structures may be arranged in an ordered configuration (e.g., a periodic array). For example, the electrochemical cell may comprise a configuration in which the plurality of first electroactive structures is interdigitated with the plurality of second electroactive structures. In certain cases, such a configuration may advantageously reduce distance between electrodes and increase energy density. FIG. 2A shows an exemplary cross-sectional schematic illustration of electrochemical cell 200 comprising a plurality of first electroactive structures 202 comprising a first electroactive material interdigitated with a plurality of second electroactive structures 206 comprising a second electroactive material. As shown in FIG. 2A, each of first electroactive structures 202 and second electroactive structures 206 has a high aspect ratio. Polymer electrolyte layer 204 separates first electroactive structures 202 and second electroactive structures 206. In electrochemical cell 200, each of first electroactive structures 202 and second electroactive structures 206 is in direct contact with polymer electrolyte layer 204. Polymer electrolyte layer 204 separates first electroactive structures 202 and second electroactive structures 206 such that none of first electroactive structures 202 are in direct contact with any of second electroactive structures 206. In FIG. 2A, first electroactive structures 202 are in direct contact with first current collector 208, and second electroactive structures 206 are in direct contact with second current collector 210.

FIG. 2B shows an exemplary schematic illustration of electrochemical cell 200 comprising a plurality of first electroactive structures 202 comprising a first electroactive material. As shown in FIG. 2B, each of first electroactive structures 202 has a high aspect ratio. Further, as shown in FIG. 2B, each of first electroactive structures 202 is conformally coated with polymer electrolyte layer 204. Substantially all of the remaining volume of electrochemical cell 200 may be filled with a second electroactive material, thereby forming second electroactive structure 206. In some embodiments (not shown), a layer of the second electroactive material may be conformally deposited on polymer electrolyte layer 204, and any suitable material (e.g., a non-electroactive material) may optionally fill any remaining volume in the electrochemical cell. As shown in FIG. 2B, polymer electrolyte layer 204 separates first electroactive structures 202 and second electroactive structure 206 such that none of first electroactive structures 202 are in direct contact with second electroactive structure 206.

In some embodiments, the first electroactive structures and/or second electroactive structures are arranged in a substantially disordered configuration (e.g., an aperiodic array, a random configuration). In certain embodiments, an electroactive cell may comprise a first electroactive structure having an irregular shape. For example, the first electroactive structure may have a porous nanoarchitecture (e.g., the first electroactive structure may comprise a foam or a porous gel). In certain embodiments, the first electroactive structure may comprise a first electroactive material having an irregular shape (e.g., a porous nanoarchitecture). In some cases, the first electroactive structure may comprise a non-electroactive substrate having an irregular shape (e.g., a porous nanoarchitecture) and a first-electroactive-material-comprising layer conformally deposited on the non-electroactive substrate. In some cases, a polymer electrolyte layer may be conformally deposited on the first electroactive structure. According to some embodiments, at least a portion of the remaining volume of the electrochemical cell (e.g., substantially all of the remaining volume) may be filled with a second electroactive material, thereby forming a second electroactive structure. According to some embodiments, a second-electroactive-material-comprising layer may be conformally deposited on the polymer electrolyte layer. Any suitable material (e.g., a non-electroactive material) may optionally fill any remaining volume in the electrochemical cell.

In some embodiments, the electrochemical cell has a relatively small size (e.g., a relatively small areal footprint, a relatively small volume). In certain embodiments, the electrochemical cell has an areal footprint of about 100 μm² or less, about 50 μm² or less, about 20 μm² or less, about 10 μm² or less, about 5 μm² or less, about 1 μm² or less, about 500 nm² or less, about 200 nm² or less, about 100 nm² or less, or about 50 nm² or less. In some cases, the electrochemical cell has an areal footprint in the range of about 50 nm² to about 1 μm², about 50 nm² to about 10 μm², about 50 nm² to about 100 μm², about 100 nm² to about 1 μm², about 100 nm² to about 10 μm², about 100 nm² to about 100 μm², about 1 μm² to about 10 μm², about 1 μm² to about 50 μm², or about 1 μm² to about 100 μm². In some embodiments, the electrochemical cell has a volume of about 1 cm³ or less, about 1 mm³ or less, about 1000 μm³ or less, about 1 μm³ or less, or about 1000 nm³ or less. In certain cases, the electrochemical cell has a volume in the range of about 1000 nm³ to about 1 μm³, about 1000 nm³ to about 1000 μm³, about 1000 nm³ to about 1 mm³, or about 1000 nm³ to about 1 cm³.

The electrochemical cell may have any suitable shape. For example, the electrochemical cell may be a cylinder, a rectangular prism, a triangular prism, any polygonal prism, or any other suitable shape. In certain embodiments, the electrochemical cell has an irregular shape. In some cases, the electrochemical cell may have any suitable cross-sectional shape. For example, the cross section of the electrochemical cell may be substantially circular, substantially elliptical, substantially square, substantially rectangular, substantially triangular, substantially polygonal, or any other suitable shape. In some embodiments, the cross section of the electroactive structure may have an irregular shape.

In some embodiments, the electrochemical cell exhibits enhanced performance characteristics. For example, in some cases, the electrochemical cell has a relatively high specific energy. In certain embodiments, the electrochemical cell has a specific energy of at least about 0.3 MJ/kg, at least about 0.5 MJ/kg, at least about 0.8 MJ/kg, at least about 1 MJ/kg. In some embodiments, the electrochemical cell has a specific energy in the range of about 0.3 MJ/kg to about 1 MJ/kg or about 0.5 MJ/kg to about 1 MJ/kg. In some cases, the electrochemical cell has a relatively high energy density. In certain cases, the electrochemical cell has an energy density of at least about 1 MJ/L, at least about 1.5 MJ/L, at least about 2 MJ/L, at least about 2.5 MJ/L, or at least about 3 MJ/L. In some embodiments, the electrochemical cell has an energy density in the range of about 1 MJ/L to about 3 MJ/L or about 2 MJ/L to about 3 MJ/L. In some embodiments, the electrochemical cell has a relatively high power density. For example, the electrochemical cell may have a power density of at least about 300 W/kg, at least about 400 W/kg, at least about 500 W/kg, or at least about 1000 W/kg. In certain embodiments, the electrochemical cell has a power density in the range of about 300 W/kg to about 1000 W/kg or about 500 W/kg to about 1000 W/kg. In some embodiments, the electrochemical cell has relatively high areal capacity (e.g., area-normalized capacity). In some embodiments, the electrochemical cell has an areal capacity of at least about 0.05 mAh/cm², at least about 1 mAh/cm², at least about 1.5 mAh/cm², at least about 2 mAh/cm², at least about 2.5 mAh/cm², at least about 5 mAh/cm², or at least about 10 mAh/cm². In some embodiments, the electrochemical cell has an areal capacity in the range of about 1 mAh/cm² to about 10 mAh/cm², about 2 mAh/cm² to about 10 mAh/cm², or about 5 mAh/cm² to about 10 mAh/cm2.

In certain embodiments, the electrochemical cell may further comprise additional components. For example, the electrochemical cell may comprise at least one current collector. The current collector may, for example, comprise copper, aluminum, nickel, silver, gold, graphene, or any suitable electrically conductive material.

Some aspects relate to methods of forming thin, conformal polymer coatings on electroactive structures. Some methods comprise the step of depositing a polymer layer on an electroactive structure using iCVD. For example, a surface to be coated (e.g., a surface of an electroactive structure) may be positioned in a reaction chamber comprising one or more heated filaments (e.g., a resistively-heated conducting filament). The surface may be maintained at a temperature that is substantially lower than that of the heated filaments. Gaseous phase monomers and a thermally labile initiator species may flow into the reaction chamber, and thermal energy from the heated filaments may generate initiator radicals. The initiator radicals may then react with monomer adsorbed on the cool surface, polymerizing cross-linkable groups (e.g., vinyl bonds) and thereby forming a polymer layer. The gaseous phase and the filament may be at a temperature that is less than about 800° C. The surface may be maintained at a temperature that is less than about 175° C.

In some cases, the initiator species may be a thermal initiator, such as perfluorooctane sulfonyl fluoride, triethylamine, tert-butyl peroxide, tert-butyl peroxybenzoate, tert-amyl peroxide, and the like. In some cases, the initiator species may be a photoinitiator. For example, the method may involve introduction (e.g., continuous introduction) of a photoinitiator, such as 2,2′-azobis(2-methylpropane), into a vacuum chamber under UV irradiation or other electromagnetic radiation. In such cases, the vacuum chamber may include, for example, a UV-transparent window instead of filaments. In other embodiments, a Type II photoinitiator, such as benzophenone, that can produce free-radical sites on the substrate surface may be employed.

Also, methods described herein may advantageously be carried out at relatively low temperatures (e.g., less than 500° C.). In some cases, exposure of the surface to an initiator species and/or a monomeric species may be performed at a temperature of about 500° C. or less, about 450° C. or less, about 400° C. or less, about 350° C. or less, about 300° C. or less, about 250° C. or less, about 200° C. or less, about 150° C. or less, about 100° C. or less, about 75° C. or less, about 50° C. or less, or about 25° C. or less. In some embodiments, the surface is exposed to a initiator species and/or a monomeric species at a temperature in the range of about 25° C. to about 500° C., about 25° C. to about 400° C., about 25° C. to about 300° C., about 25° C. to about 200° C., about 25° C. to about 100° C., or about 25° C. to about 50° C. In a particular embodiment, the surface is exposed to a initiator species and/or a monomeric species at a temperature of about 25° C. (e.g., room temperature).

In some embodiments, the methods further comprise the step of exposing the polymer layer to a solution comprising an electroactive species of an electroactive structure, thereby doping the polymer layer with the electroactive species.

In an illustrative embodiment, the electroactive species is Li⁺. In some such embodiments, the solution comprises a lithium salt. Examples of suitable lithium salts include, but are not limited to, lithium perchlorate (LiClO₄), lithium tetrafluoroborate (LiBF₄), lithium bis(trifluoromethane sulfonyl) imide (LiTFSI), lithium chloride (LiCl), lithium hexafluorphosphate (LiPF₆), and lithium bis(oxalate)borate (LiBOB).

In some cases, the solution further comprises a solvent. Any solvent capable of solvating the lithium salt may be used. Non-limiting examples of suitable solvents include propylene carbonate, ethylene carbonate, dimethyl carbonate, dimethoxyethane, and acetonitrile. In certain embodiments, use of certain solvents (e.g., dimethyl carbonate) may result in reduced salt crystal formation (e.g., lithium salt formation). In some embodiments, accordingly, use of certain solvents may result in lower surface roughness. In some embodiments, the solvent is an ionic liquid (e.g., a salt in liquid state). Non-limiting examples of suitable ionic liquids include 1-butyl-3-methylimidazolium tetrafluoroborate.

In some embodiments, the polymer layer is exposed to the solution comprising an electroactive species for at least about 1 hour, at least about 3 hours, at least about 6 hours, at least about 12 hours, at least about 1 day, at least about 2 days, at least about 3 days, at least about 4 days, or at least about 5 days. In some embodiments, the polymer is exposed to the solution comprising an electroactive species for an amount of time in the range of about 1 hour to about 3 hours, about 1 hour to about 6 hours, about 1 hour to about 12 hours, about 1 hour to about 1 day, or about 1 hour to about 5 days.

In some embodiments, the polymer layer is exposed to the solution comprising an electroactive species at a temperature of at least about 25° C., at least about 50° C., at least about 75° C., at least about 100° C., or at least about 200° C. In some embodiments, the temperature may be in the range of about 25° C. to about 100° C., about 25° C. to about 200° C., about 50° C. to about 100° C., about 50° C. to about 200° C., about 75° C. to about 100° C., about 75° C. to about 200° C., or about 100° C. to about 200° C. In some cases, the temperatures is lower than the glass transition temperature of the polymer of the polymer layer.

According to some embodiments, the polymer layer may be rinsed with a solvent (e.g., ethanol) after being exposed to the solution comprising an electroactive species. In certain cases, for example, the polymer layer may be soaked in the solvent for at least about 5 minutes, at least about 10 minutes, at least about 15 minutes, at least about 20 minutes, at least about 30 minutes, or at least about 60 minutes. In some embodiments, the polymer layer may be soaked in the solvent for about 60 minutes or less, about 30 minutes or less, about 20 minutes or less, about 15 minutes or less, or about 10 minutes or less. Combinations of the above-noted ranges are also possible (e.g., about 10 minutes to about 20 minutes). Any solvent capable of solvating the lithium salt may be used. A non-limiting example of a suitable solvent is ethanol. According to certain embodiments, rinsing with the solvent (e.g., ethanol) may reduce the surface roughness of the polymer layer.

Chemical vapor deposition reactors are also provided. The reactor typically includes a chamber, wherein the chamber comprises a substrate, an electrode, a filament, and an inlet. In some cases, the chamber includes a plurality of filaments. The filaments may comprise a metal or other suitable material known in the art. In some cases, the filaments may have a diameter of about 0.01 cm to about 0.1 cm. The filaments may be periodically spaced from the substrate and/or from one another. For example, the filaments may be spaced from about 1 mm apart to about 30 mm apart, or from about 0.1 cm to about 20 cm, from the substrate.

The reactor may further include a source of a monomer species in fluid communication with the chamber, a source of an initiator species in fluid communication with the chamber, a vacuum source operably connected to the chamber, and a heat source and/or a cooling source, the heat source and/or the cooling source operably connected to the substrate. The reactor may also include controls for controlling the flow of the monomer species and initiator species. In some cases, the chamber may include a window, a door, or a lid, and/or the chamber may be substantially cylindrical in shape. The chamber may be fabricated from various materials, including glass or stainless steel. Those of ordinary skill in the art would be capable of selecting the appropriate materials for fabricating a reactor as described herein.

The following examples are intended to illustrate certain embodiments of the present invention, but do not exemplify the full scope of the invention.

It should be understood that when a portion (e.g., layer, structure, region) is “on,” “proximate,” “adjacent,” “above,” “over,” “overlying,” or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on,” “immediately adjacent,” “in contact with,” or “directly supported by” another portion means that no intervening portion is present.

### EXAMPLE 1

This Example describes the fabrication and characterization of polymer layers synthesized by iCVD for use as electrolytes in electrochemical cells.

An important consideration for integrating power into autonomous microscale and nanoscale devices for sensing, actuation, communications, and medical implants is the footprint area of the power source. Three-dimensional (3D) battery architectures can overcome the limitations of planar designs by creating non-planar electrode structures that increase energy densities within a small areal footprint while maintaining the short ionic transport distances necessary for high power densities. Development of a stable, thin-film, ion-conducting electrolyte that conformally covers such electrodes, an important feature for many 3D battery architectures, has been a challenging problem. This example describes the development of a new class of thin-film, conformal, solid polymer electrolytes prepared by doping lithium ions (Li⁺) into cyclic siloxane networks containing siloxane (—Si—O—Si—) ring moieties. As described in this Example, poly-(tetravinyltetramethylcyclotetrasiloxane) (PV4D4) films were synthesized by initiated chemical vapor deposition (iCVD). The siloxane ring moieties provided excellent stability and facilitated Li⁺ transport, resulting in room temperature ionic conductivities exceeding 10⁻⁸S/cm, comparable to polymeric electrolytes such as poly(ethylene oxide) (PEO). The conformal nature of the polymerization process resulted in complete coverage of complex geometries by a uniform, pinhole free film. iCVD cyclic siloxane polymer electrolytes thus appear to be attractive for the emerging field of 3D batteries.

A common theme among 3D battery designs is the use of electrodes with non-planar geometries that effectively enable power sources to possess high energy density and high power density within a small footprint area. In some cases, it is desirable for electrolyte films in 3D batteries to cover these complex electrode geometries while retaining the underlying morphology of the electrodes, i.e., conformal coverage. However, such uniform and thin polymer layers are often difficult to achieve by solution processing due to de-wetting and surface tension effects. This Example describes the development of a new class of cyclic siloxane, conformal, solid polymer electrolyte films synthesized by iCVD.

The iCVD process directly converts gas phase monomers into solid films through polymerization (e.g., polymerization of vinyl bonds). One of the primary benefits of iCVD is the ability to retain non-vinyl organic moieties present in the monomer. For example, in the case of monomers like tetravinyltetramethylcyclotetrasiloxane, the siloxane ring structure of the monomer is retained while reaction of the four vinyl groups results in a highly cross-linked network. The monomer and a thermally labile initiator flow into a reaction chamber, wherein thermal energy from heated filaments generates initiator radicals, which react with adsorbed monomer on a cooled substrate, forming a polymer layer. The resulting polymer layers are capable of uniformly covering such structures as arrays of high-aspect-ratio nanowires that serve as 3D electrodes. In this Example, it was demonstrated that the iCVD process can be used to deposit 10-40 nm thick polymer layers conformally on high-aspect-ratio nanowires. The uniform thickness and composition of these polymer electrolyte films are attractive for 3D battery architectures. In addition to conformality, it was shown that the iCVD polymer layers were extremely smooth and virtually free of pinholes, exhibited low electronic conductivity, and possessed excellent high voltage stability, all of which are properties that are desirable for thin conformal electrolytes. Additionally, processing protocols were established that enabled the iCVD polymer electrolyte to exhibit reasonable levels of ion conductivity at room temperature.

One of the most commonly explored polymeric electrolytes is poly(ethylene oxide) (PEO, [—(O—CH₂—CH₂—]ₙ). PEO and its cyclic variants are known to chelate Li⁺. However, PEO has certain properties that may not be advantageous for certain applications. For example, PEO is crystalline at room temperature, but the segmental motion of the —C—O—C— linkages that facilitate Li⁺ transport only occurs in its amorphous phase above 60° C. As a result, PEO generally exhibits improved ionic conductivity at elevated temperatures, but not room temperature.

It has been recognized that siloxane networks may have certain advantageous properties. For example, conjugating siloxane segments to PEO can increase ionic conductivity and impart improved mechanical and electrochemical stability. The —Si—O—Si— bonds in the siloxane moieties are more ionic than —C—O—C— bonds, leading to a more negative charge on the oxygen atom that can chelate Li⁺. Additionally, the flexible nature and associated free volume of the siloxane linkages can further facilitate ionic transport. In this Example, several multivinyl siloxane monomers that can be polymerized to form flexible, cross-linked network structures, with the potential for the ring structures in the monomer to stack to form built-in channels for Li⁺ transport, were studied. Among polymers derived from such cyclic siloxane materials, PV4D4 exhibited good mechanical and thermal stability, which is highly desirable for polymer electrolytes. However, currently used bulk synthesis techniques are not suitable for growing conformal thin films. In this Example, it was demonstrated for the first time that Li⁺ doping of iCVD-grown conformal polysiloxane PV4D4 thin films can make them ionic conductors even at room temperature.

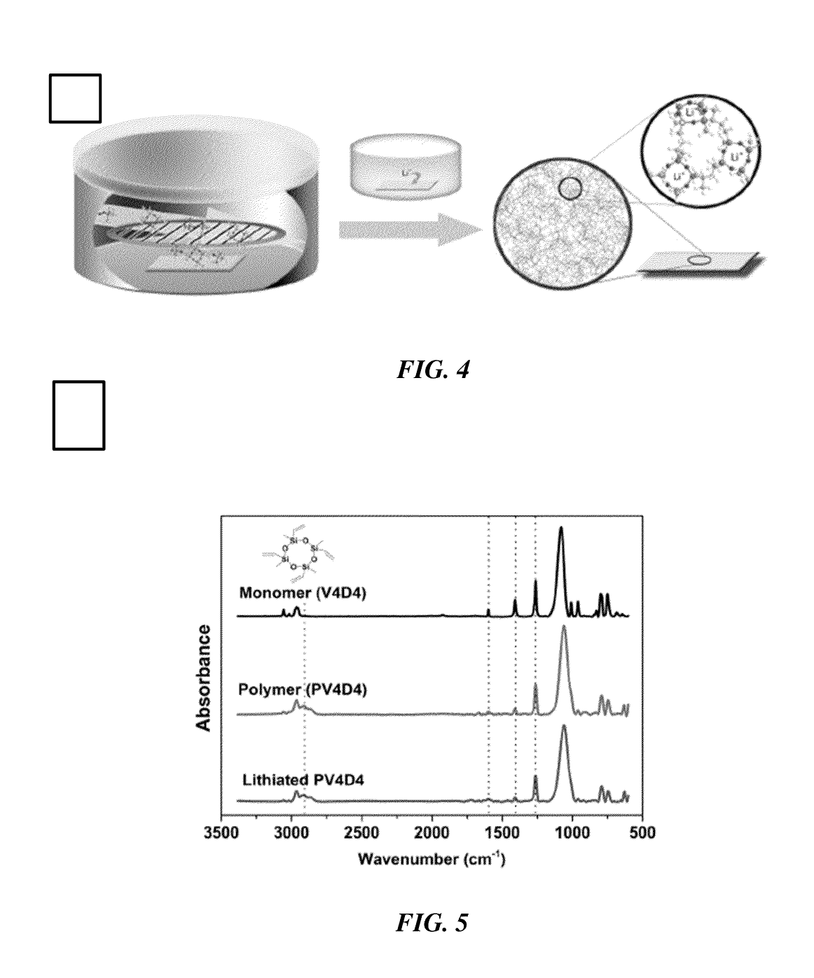

The fabrication process of the PV4D4 electrolyte films is illustrated in FIG. 4. 10-40 nm thick polymer layers were deposited by iCVD on silicon wafers (for chemical and morphological characterization) and indium tin oxide (ITO) coated glass (for ionic conductivity and pinhole measurements). Films were subsequently lithiated by soaking in 1 M LiClO₄ solution at room temperature. The inset of FIG. 4 depicts the siloxane ring structure of the V4D4 monomer.

In order to verify the chemical structure of the synthesized film, Fourier transform infrared spectroscopy (FTIR) spectra of the monomer (V4D4), polymer (PV4D4) and the lithiated polymer, respectively, were obtained. FIG. 5 shows the FTIR spectra for V4D4, unlithiated PV4D4, and lithiated PV4D4, with vertical dash lines indicating changes between monomer and polymer spectra. From FIG. 5, it can be seen that strong peaks at 1060 cm⁻¹, which were due to Si—O bond absorption, appeared in all three FTIR spectra. This result indicated that the —Si—O—Si— ring structure, which facilitates Li⁺ transport, was retained after polymerization. Comparisons between the polymer spectra (unlithiated and lithiated PV4D4) and the monomer spectrum (V4D4) also indicated that IR absorptions associated with the vinyl moiety (C═C stretch) were significantly reduced after polymerization, while those associated with the Si-methyl moiety remained unchanged. For example, it can be seen in FIG. 5 that the peak at 1261 cm⁻¹ (Si-methyl) was unchanged, and the peaks at 1408 cm⁻¹ (CH₂ deformation) and 1600 cm⁻¹ (C=C stretch) were reduced in the polymer spectra compared to the monomer spectrum. Further evidence for polymerization was found near 2900 cm⁻¹, where broader peaks in the polymer spectra that were not observed in the monomer spectrum indicated absorptions from the newly formed polyethylene-like backbone in the polymer. No obvious difference existed between IR spectra of the original PV4D4 film and the lithiated PV4D4 film. This may have been because the major IR absorption of LiClO₄ (Cl—O v₃ asymmetric stretching) appeared around 1100 cm⁻¹ and overlapped with the strong Si—O absorption. This further indicated that the PV4D4 films remained chemically and mechanically intact after the solution-based lithiation step without noticeable structural re-arrangement. It was previously demonstrated that similar polysiloxane films were excellent electronic insulators that maintained high values of bulk electrical resistivity (greater than 4×10¹⁵ Ω-cm) under constant electrical bias for over 8 years. The formation of insoluble crosslinked networks from polymerization at multiple propagation (vinyl) sites on the V4D4 monomer may have been one reason for such stability, which is beneficial for polymer electrolytes.

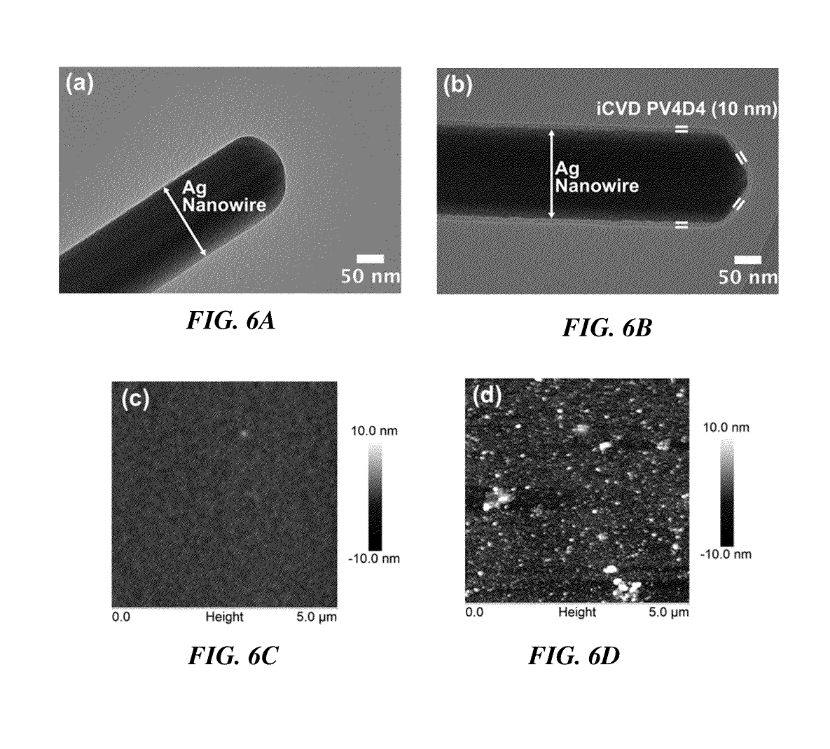

The nanoscale morphology of iCVD synthesized PV4D4 films was characterized by transmission electron microscopy (TEM) and atomic force microscopy (AFM). FIG. 6A shows a TEM image of a bare silver nanowire (160 nm in diameter), and FIG. 6B shows a TEM image of a silver nanowire coated with a 10 nm layer of PV4D4. As shown in FIG. 6B, the PV4D4 film coat uniformly covered the nanowire, demonstrating excellent conformality of the film over this high aspect ratio nanostructure and maintaining its high surface area.

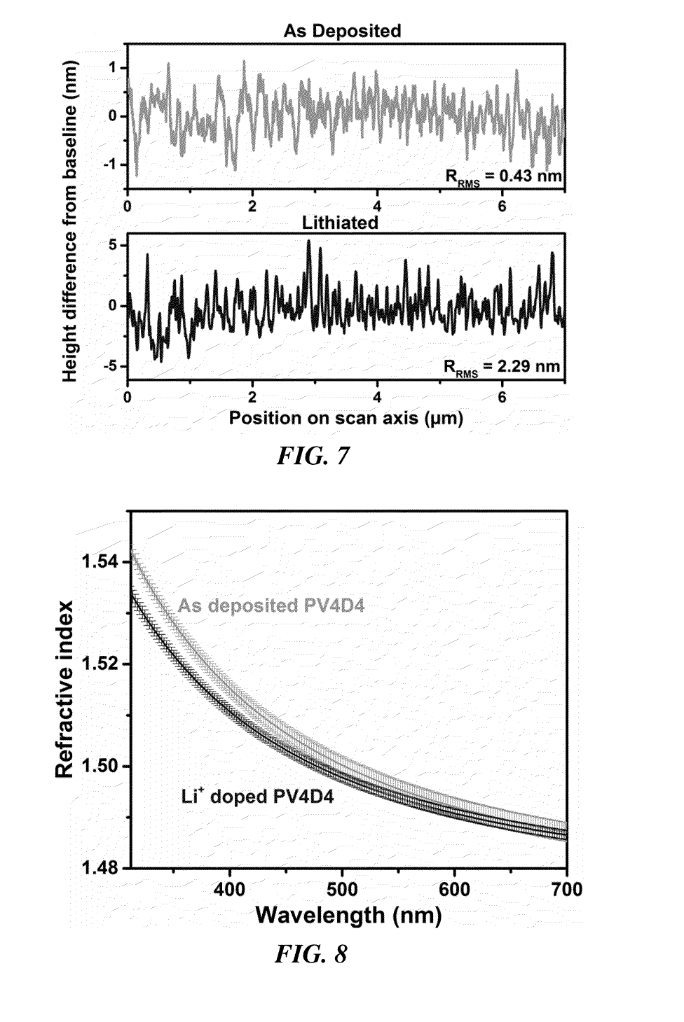

It is also important for polymer electrolyte films to be smooth, as large variations in thickness may statistically increase the chance of pinhole defects. However, although complete, pinhole-free coverage of complex electrode geometries is important for avoiding electrical shorting, such coverage has been difficult to achieve by previously attempted methods. The surface roughness of the unlithiated and lithiated PV4D4 films was characterized by AFM, and it was found that the films were substantially smooth. FIG. 6C shows an AFM image of an iCVD-deposited, 35 nm PV4D4 film deposited on a silicon wafer before lithiation, and FIG. 6D shows an AFM image of the same PV4D4 film after lithiation. As shown in FIG. 6C, the PV4D4 film was extremely smooth prior to lithiation; the unlithiated PV4D4 film had a root mean square surface roughness R_{RMS} of about 0.463 nm. From FIG. 6D, it can be seen that small clusters were visible after Li⁺ doping; the lithiated PV4D4 film had a root mean square surface roughness R_{RMS} of about 2.20 nm. FIG. 7 shows plots of height difference from baseline (nm) as a function of position on the scan axis (μm) for the as-deposited and lithiated PV4D4 films. As shown in FIG. 7, it was found that the as-deposited PV4D4 film had a root mean square roughness R_{RMS} of 0.43 nm, and the lithiated PV4D4 film had a root mean square roughness R_{RMS} of 2.29 nm.

The mechanical adhesion and chemical stability of the lithiated PV4D4 films were further verified by variable angle spectroscopic ellipsometry (VASE) measurements (Table 1). The VASE measurements demonstrated that thickness, roughness, and refractive index of the PV4D4 film did not change significantly after lithiation.

TABLE 1

| | PV4D4 before soaking in | | | |
|---|---|---|---|---|
| | Li salt solution | | PV4D4 after soaking in | |
| | | Mean | Li salt solution | |
| | | Squared | | Mean Squared |
| Position | Thickness (nm) | Error (MSE) | Thickness (nm) | Error (MSE) |
| 1 | 35.9 | 5.2 | 36.8 | 5.5 |
| 2 | 36.0 | 5.0 | 37.1 | 5.0 |
| 3 | 36.0 | 4.9 | 36.9 | 5.1 |
| 4 | 35.5 | 4.1 | 36.8 | 4.6 |
| 5 | 35.9 | 4.8 | 36.7 | 5.3 |

| | |
|---|---|
| Average thickness | Average thickness |
| before Li soaking = 35.86 nm | after Li soaking = 36.86 nm |

Table 1 compares PV4D4 film thickness on a silicon wafer before and after lithiation, as measured by VASE at 5 positions on the film sample. Both film thickness and mean squared error (MSE), which provides a measure of film roughness, showed marginal changes after soaking in a Li⁺ salt solution for 3 days. The average thickness before Li soaking was 35.86 nm, while the average thickness after Li soaking was 36.86 nm. MSE values are typically around 4-5 for extremely smooth surfaces, such as polished silicon. The average MSE value before Li soaking was 4.8, and the average MSE value after Li soaking was 5.1. From FIG. 8, which shows a plot of refractive index as a function of wavelength (nm) for a PV4D4 film on a silicon wafer before and after soaking in a Li⁺ salt solution for 3 days, it can also be seen that the refractive index of the PV4D4 film only showed marginal changes after lithiation. In FIG. 8, each data point represents an average of refractive index measurements at 5 positions on the film sample, and error bars indicate deviation from the average value.

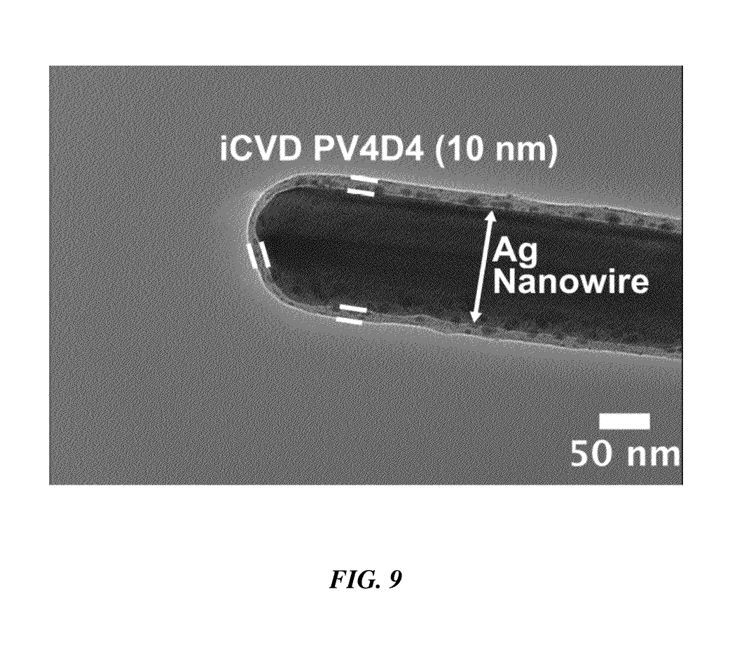

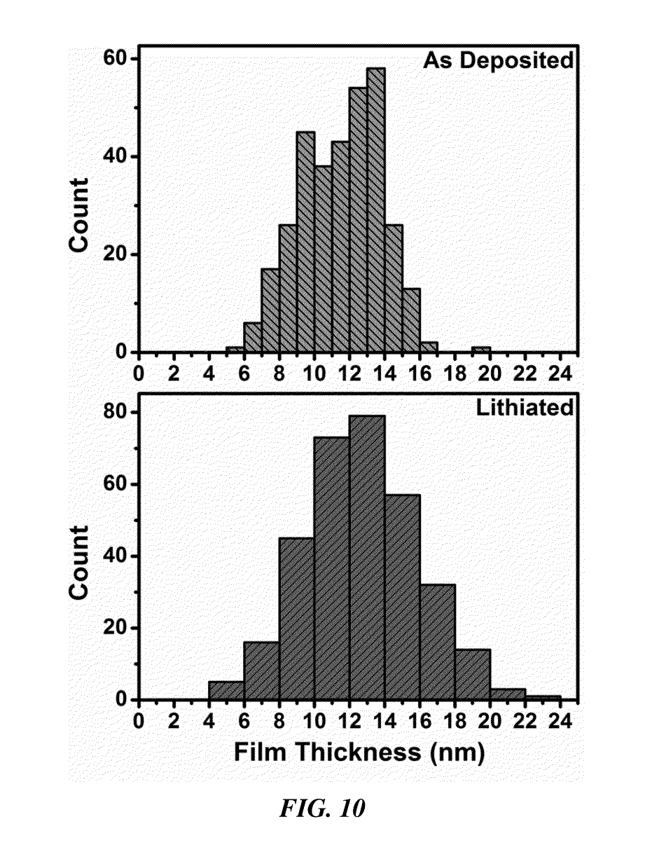

TEM imaging also demonstrated that solution-based lithiation of PV4D4 films did not result in obvious swelling of the films, unlike PEO films, and resulted in minimal change in film thickness. For example, FIG. 9, which shows a TEM image of a PV4D4-coated silver nanowire after lithiation, demonstrates that the conformality of the PV4D4 film was retained after lithiation. TEM imaging analysis was also used to evaluate the effect of lithiation on film thickness. To conduct the analysis, 11 PV4D4-coated silver nanowires were chosen at random from different locations of the grid, and 30 measurements were taken on each wire for both the as-deposited (e.g., unlithiated) and lithiated samples. The results are shown in FIG. 10, which shows a comparison of PV4D4 film thickness distribution before and after lithiation. It was found that the mean thickness of the as-deposited film was 11.5 nm, and the standard deviation was 2.6 nm. After lithiation, there was a marginal increase in mean thickness to 12.6 nm and in standard deviation to 3.2 nm.

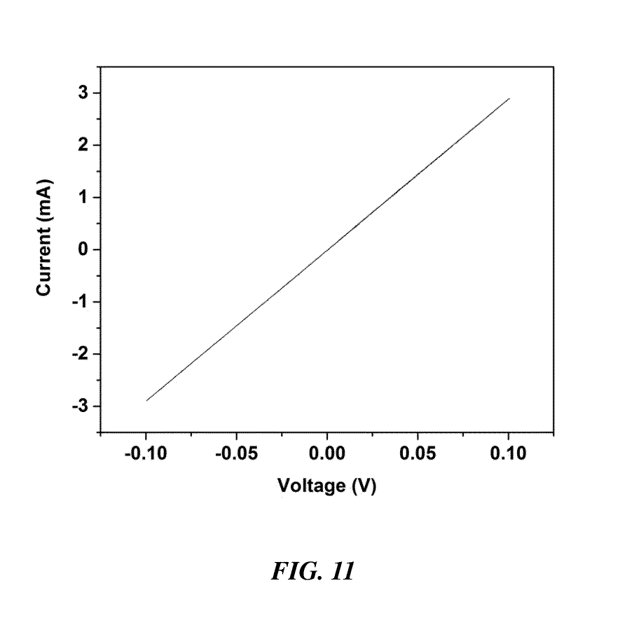

The electrical conductivities of unlithiated 25 and 35 nm PV4D4 films were obtained by measuring the current over a small potential range applied relative to the open-circuit voltage of the system. FIG. 11 shows a DC current-voltage curve of an unlithiated 25 nm PV4D4 film. The voltage range was taken with respect to the open-circuit voltage of the system at a scan rate of 2 mV/s. It can be seen from FIG. 11 that the current-voltage plot shows an ohmic (e.g., linear) response that was stable over time and fully reversible. The unlithiated 35 nm PV4D4 film exhibited a similar impedance response. Based on these measurements, the electronic conductivity of the 25 nm unlithiated PV4D4 film was found to be 4.1±2.4×10⁻¹¹ S/cm, and the electronic conductivity of the 35 nm unlithiated PV4D4 film was found to be 5.7±3.4×10⁻¹¹ S/cm. These measurements indicated that the unlithiated polymer layers were good dielectrics and could withstand electric fields in excess of 10⁴ V/cm.

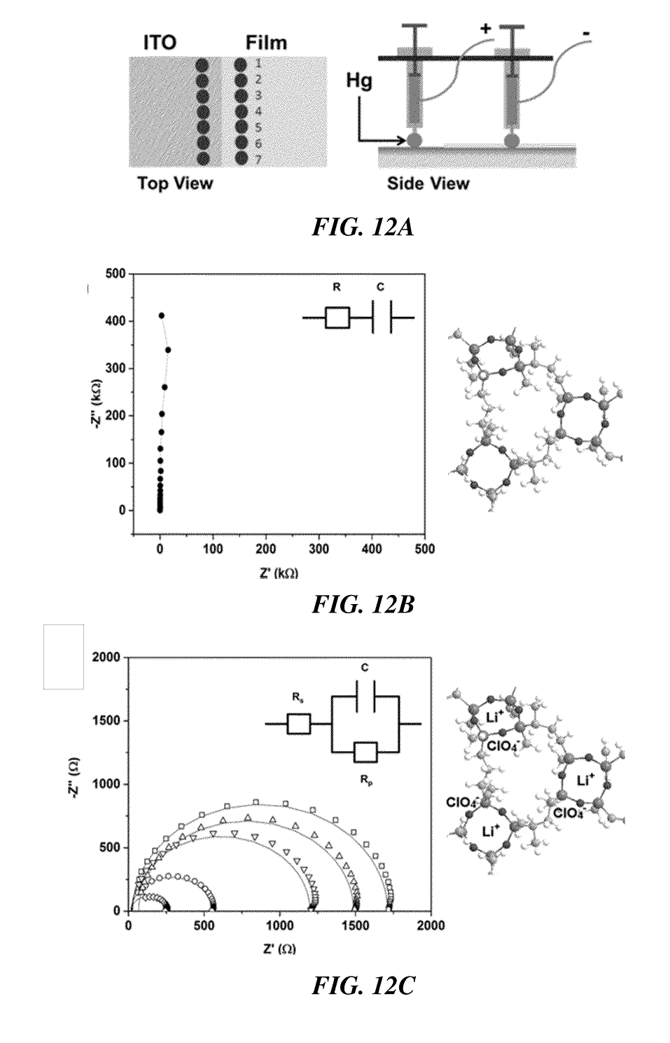

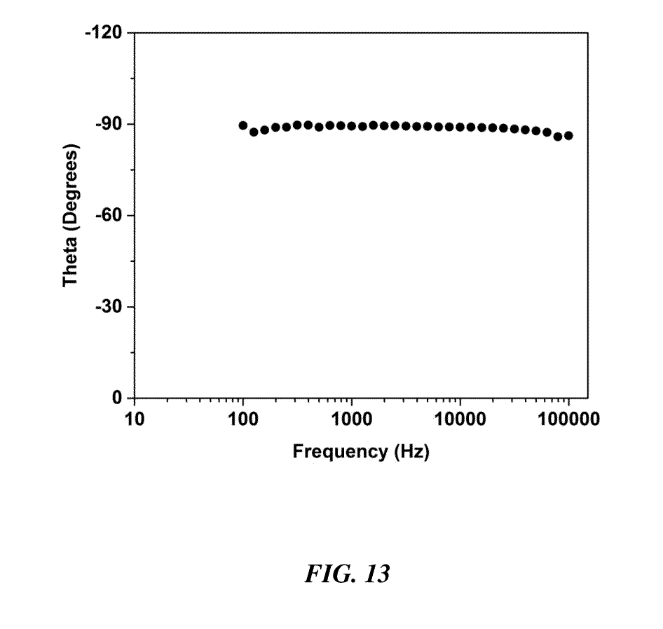

The ionic conductivities of unlithiated and lithiated PV4D4 films at room temperature were compared using electrochemical impedance spectroscopy (EIS). Multiple measurements were taken at various positions along the films using a hanging mercury drop electrode arrangement, as shown in FIG. 12A. Nyquist plots (e.g., plots in which the real component of impedance is plotted on the x-axis and the imaginary component of impedance is plotted on the y-axis) for an unlithiated, 25 nm PV4D4 film, a lithiated, 25 nm PV4D4 film, and a lithiated, 35 nm PV4D4 film are shown in FIGS. 12B, 12C, and 13 respectively. The data were taken in the frequency range from 100 kHz to 100 Hz using a 10 mV (RMS) potential. The solid curves in the plots were obtained from data fitting and were used to determine Rₚ, the resistance of pore electrolyte per length. For FIGS. 12B and 12C, the circuits used for equivalent circuit fitting are shown in each plot, and cartoon insets in FIGS. 12B and 12C show proposed PV4D4 structures before and after lithiation, respectively. A Bode plot (e.g., a plot of phase angle as a function of frequency) is shown for the unlithiated, 25 nm PV4D4 film in FIG. 13.

The impedance of the unlithiated, 25 nm PV4D4 film exhibited a dielectric response, as indicated by the vertical line in the Nyquist plot (FIG. 12B) and the near -90° phase angles in the Bode plot throughout the entire frequency range of the measurement (FIG. 13). The impedance values of the unlithiated, 25 nm PV4D4 film were consistent across multiple positions on the film. An unlithiated, 35 nm PV4D4 film exhibited impedance characteristics similar to those of the unlithiated, 25 nm PV4D4 film.

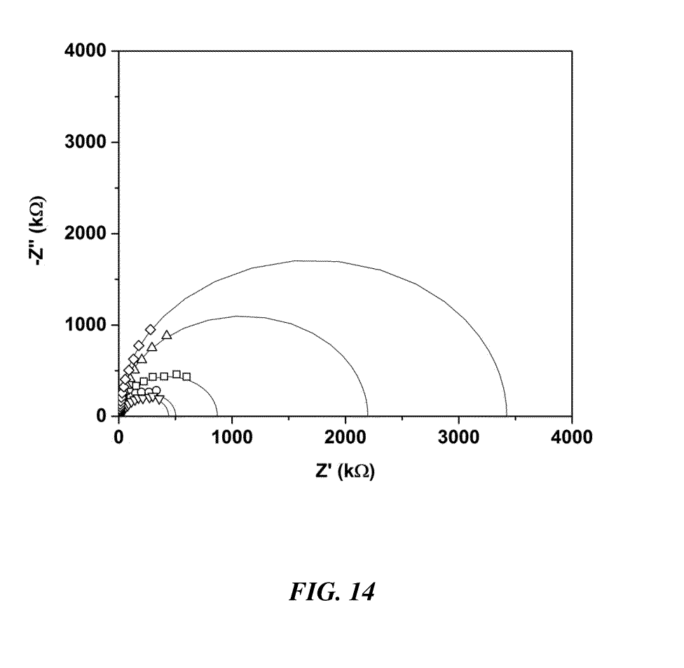

Upon lithiation, the impedance response of the PV4D4 film became typical of an ionic conductor. As shown in FIG. 12C, the Nyquist plot for the lithiated, 25 nm PV4D4 film depicted the characteristic semi-circles indicative of ionic transport in the film. FIG. 14 shows the Nyquist plot for a lithiated, 35 nm PV4D4 film. The impedance data for the lithiated, 35 nm PV4D4 film were consistent with the RC circuit used to model charge transport (FIG. 14). The higher impedance observed for thicker lithiated polymers suggests an inhomogeneous distribution of charge in the film.

Ionic conductivities of the films were calculated using Equation 2, where film thickness was measured using VASE, electrode contact area was defined by Hg drop size, and ionic resistance was determined from equivalent circuit fitting. Electronic conductivity was calculated using Equation 3, which replaced ionic resistance in Equation 2 with DC resistance. The limits of the reported conductivities were calculated using the range of possible contact areas for the Hg electrodes. For the lithiated, 25 nm PV4D4 film, ionic conductivity σ was 7.5±4.5×10⁻⁸ S/cm at room temperature. The O atoms on siloxane rings in PV4D4 films can provide favorable binding sites for Li⁺, while ClO₄⁻ counterions can remain in the inter-ring space to minimize electrostatic repulsion (FIG. 12C). The flexible —Si—O—Si— bonds can further facilitate ion transport, resulting in ionic conduction even at room temperature. The value of conductivity at room temperature is important relative to that at higher temperature for several applications like sensing and medical implants that operate under ambient conditions. For the thicker 35 nm PV4D4 film, ionic conductivity σ was 1.3±1.2×10⁻¹⁰ S/cm. One hypothesis for the observed decrease in σ as film thickness increased is that disorder in ring stacking increased with film thickness, leading to lower ionic conductivity. An alternative hypothesis is that full lithiation of a thicker film may be more difficult to achieve. In a 3D battery, low electrolyte conductivity can lead to the development of concentration polarization at the electrode and lower discharge capacity and rate capability. The variability in the impedance values in FIG. 12C suggests that there was an inhomogeneous distribution of charge carriers throughout the PV4D4 film.

A small fraction of the impedance measurements made on lithiated PV4D4 displayed hard electrical shorts; this response was not observed in the unlithiated films. It was hypothesized that salt crystals present on the surface of the lithiated film (see FIG. 6D) could have been a cause of this occasional shorting.

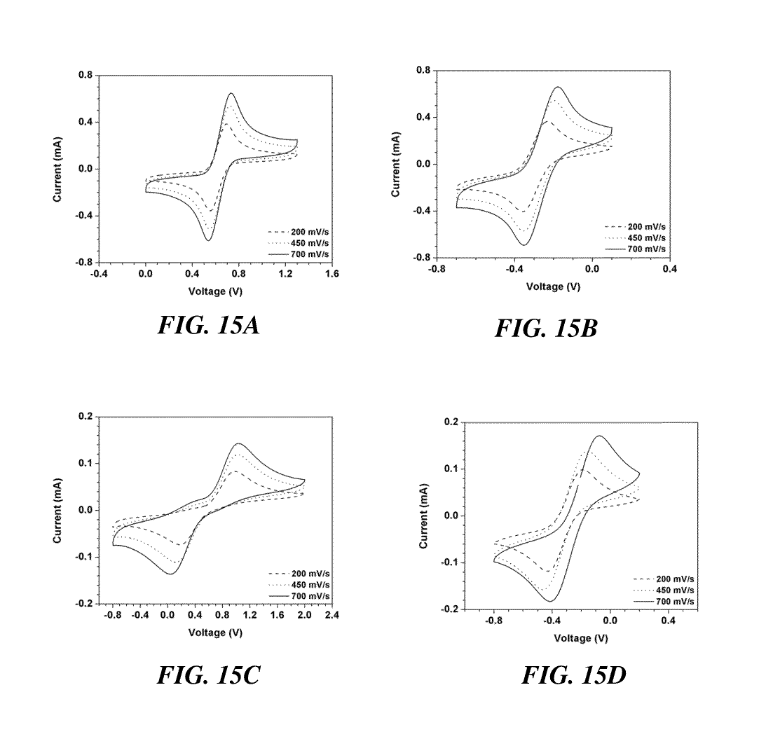

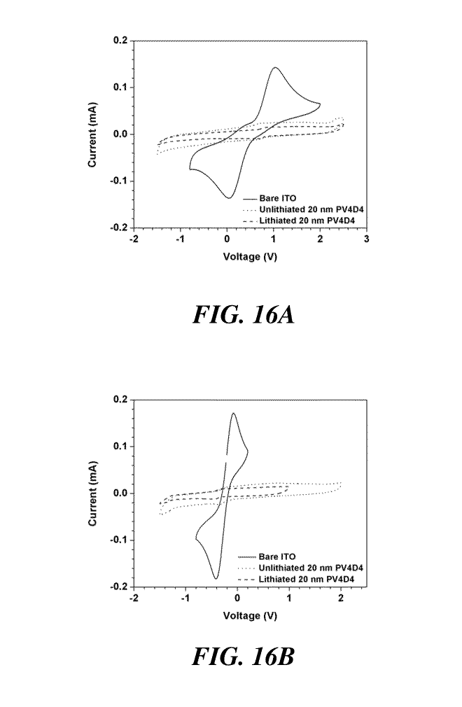

The presence of pinholes in a thin film solid electrolyte is an important issue for batteries because of the need to prevent short circuits between the anode and cathode. The most widely investigated thin film solid-state batteries typically have electrolyte thicknesses on the order of 1 μm and are sufficiently thick that pinholes are not problematic. However, in the present Example, where the polymer layers are on the order of 25 nm, the presence of pinholes is a greater concern. The approach that was used to characterize pinholes in the PV4D4 films was based on electrochemical techniques that make use of different cyclic voltammetry signatures that depend on pinhole conditions in nanoporous, self-assembled monolayers. This method quantified the number of pinholes of a given size over a specific area and thus provided a useful metric for evaluating an electrolyte, as these defects represented potential current paths that could lead to electrical shorting between electrodes. The characterization method and the results obtained with the redox couples decamethyl ferrocene (dmFc) and cobaltocenium hexafluorophosphate (CoCp₂PF₆) as probe molecules are presented in FIGS. 15-16 and described below.

To obtain approximate pinhole density in the PV4D4 films, it was assumed that the pinholes acted as independent disk-shaped electrodes. The number density of pinholes N was then calculated using Equation 5, where j is the peak current density, r₀ is the average pinhole radius, F is the Faraday constant, and D and C* are the diffusion coefficient (for a redox system with bare working electrodes) and concentration of the probe molecule, respectively.

An important parameter in calculating the pinhole density is r₀, which is determined independently. To this end, a pair of redox couples with different solvation shell diameters was employed to observe changes in cyclic voltammograms as a function of redox molecule size. In order to calculate and catalogue these diameters, diffusion coefficients of the redox couples, D, were first determined from voltammograms using the Randles-Sevcik equation (Equation 6):

$${i}_{p} = 0.4463 {nFAC ( \frac{nFvD}{RT} )}^{\frac{1}{2}} \qquad ( 6 )$$

where iₚ is the peak current, n is the number of electrons transferred per redox molecule, F is the Faraday constant, A is the electrode area, C is the concentration of the redox couple, v is the scan rate, and R is the gas constant. The diffusion coefficients were extracted as the slope of peak currents versus the square root of the scan rate.

The Stokes-Einstein equation (Equation 7) was then used to determine the diameter of the diffusing species, d, where k_{B} is the Boltzmann constant, and η is the viscosity of the solvent used in the redox system.

$$D = \frac{{k}_{B} T}{3 π η d} \qquad ( 7 )$$

Diffusion coefficients determined from the oxidation peak currents were used in the calculations of the solvation shell diameter for consistency.

Heterogeneous rate constants, k⁰, are another useful parameter for pinhole characterization because they are a measure of the difficulty for electrons to transfer from the redox molecule to the electrode. Therefore, redox couples with large k⁰ values may be able to exchange electrons at defect sites that may not necessarily be accessible given the size considerations of the pinhole and probe molecule. Rate constants for the redox couples were determined through the Nicholson relationship (Equations 8 and 9), where ψ is related to the voltage separation of the oxidation and reductions peaks observed from cyclic voltammetry of the redox couples, k⁰ is the rate constant, D_{O} and D_{R} are the oxidation and reduction diffusion coefficients respectively, and the other variables are consistent with previous equations.

$$\begin{matrix}ψ = \frac{{γ}^{a} {k}^{0}}{\sqrt{n π {FvD}_{O} / RT}} & ( 8 ) \\ γ = {( \frac{{D}_{O}}{{D}_{R}} )}^{\frac{1}{2}} & ( 9 )\end{matrix}$$

Electrochemical measurements were performed on 1 cm² samples of PV4D4 films deposited on ITO-coated glass substrates in a three-electrode cell with platinum counter and reference electrodes. In the determination of diffusion coefficients, Pt or Au microelectrodes are often used due to several advantages over macroelectrodes, including intrinsically larger heterogeneous rate constants and the minimization of uncompensated resistance and capacitive distortion. However, macroelectrodes offer better statistical data of the coating coverage and a larger signal-to-noise ratio for electrolyte-coated electrodes that demonstrate decreased currents. Because of this, a 2 cm² bare Pt electrode and a 1 cm² ITO working electrode were employed to validate the use of macroelectrodes in these measurements and to ensure that the calculated diffusion coefficients of dmFc and CoCp₂PF₆ were reflective of those reported in literature. In some cases, the diffusion coefficients for the redox systems in PC were not available and values for the redox systems in acetonitrile (ACN) were used for comparison instead.

FIGS. 15A-D show plots of the voltammetric response of a 2 cm² Pt electrode in 1 mM dmFc (FIG. 15A), a 2 cm² Pt electrode in 1 mM CoCp₂PF₆ (FIG. 15B), a 1 cm² ITO electrode in 1 mM dmFc (FIG. 15C), and a 1 cm² ITO electrode in 1 mM CoCp₂PF₆ (FIG. 15D). In addition to 1 mM dmFc or 1 mM CoCp₂PF₆, the solutions also comprised 0.1 M tetrabutylammonium tetrafluoroborate (TBATFB) in propylene carbonate (PC). The voltammograms were obtained at scan rates of 200, 450, and 700 mV/s. Diffusion coefficients were calculated from the slope of peak currents versus the square root of the scan rate. Diffusion coefficients for the dmFc and CoCp₂PF₆ redox systems with Pt working electrodes were calculated to be 1.85×10⁻⁶ and 2.21×10⁻⁶ cm²/s, respectively (FIG. 15). These values were consistent with those reported in literature, validating the use of macroelectrodes. Diffusion coefficients for the dmFc and CoCp₂PF₆ redox systems with bare ITO working electrodes were calculated to be 3.80×10⁻⁷ and 4.93×10⁻⁷ cm²/s, respectively, lower than those of the Pt electrodes by approximately one order of magnitude. This effect may be ascribed to differences in the charge transfer coefficients between Pt and ITO. Using the diffusion coefficients with bare ITO working electrodes, the solvation shell diameters of dmFc and CoCp₂PF₆ were determined to be 4.51 and 3.48 nm, respectively, and the heterogeneous rate constants were calculated to be 2.21×10⁻⁴ and 2.66×10⁻⁴ cm/s, respectively. The increased peak separation of the voltammograms for the ITO electrodes was expressed in the lower heterogeneous rate constant for the redox systems for ITO.

Cyclic voltammetry using the dmFc and CoCp₂PF₆ redox systems was carried out on unlithiated and lithiated 20 nm PV4D4 films. FIGS. 16A-B show plots of the voltammetric response of a bare ITO electrode, an ITO electrode with an unlithiated 20 nm PV4D4 film, and an ITO electrode with a lithiated 20 nm PV4D4 film in 1 mM dmFc (FIG. 16A) and 1 mM CoCp₂PF₆ and 0.1 M TBATFB in PC (FIG. 16B). The voltammetric responses of the PV4D4 films were stable across multiple sweeps for each scan rate; FIGS. 16A-B show the third cycles at a scan rate of 700 mV/s. At a scan rate of 700 mV/s, the Faradaic currents from the redox couples could be accurately decoupled from any capacitive contribution while also avoiding the significant ohmic drop or RC time constant distortion that could affect cyclic voltammograms at faster scan rates. The peak currents used in the pinhole density calculations were the oxidation current plateaus at the redox potential (about 0.75 V for dmFc and about −0.25 V for CoCp₂PF₆). The slope of the voltammograms was due to the electrolyte resistance of the electrochemical cell.

While the CoCp₂PF₆ redox system was expected to result in greater peak currents due to the smaller size of the redox molecule (e.g., smaller solvation shell diameter) and greater accessibility of the ITO substrate through pinholes, it was observed that peak currents for the dmFc redox system were appreciably larger in the p.m range than peak currents for the CoCp₂PF₆ system (FIG. 16). Because the heterogeneous rate constants of the dmFc and CoCp₂PF₆ redox systems were comparable to one another, an alternative explanation was needed to explain this discrepancy. It has been argued that if pinholes are assumed to be in the same size regime as the probe molecules, selectivity may arise due to chemical characteristics rather than physical size of the probe molecules. As such, the pinholes were reasonably estimated as 4 nm in diameter, or a radius, r₀, of 2 nm.

Using Equation 5, the number density of pinholes was calculated, and the results are shown in Table 2. The number density of pinholes was found to be somewhat less than those reported for self-assembled monolayers based on organomercaptans. Moreover, the number density of pinholes decreased upon lithiation. This effect may have been due to the closing of some pinholes as a result of the expansion of the PV4D4 film from the incorporation of LiClO₄, as demonstrated by a slight increase in film thickness after lithiation (Table 1, FIGS. 8, 10). Alternatively, the LiClO₄ clusters observed by AFM may have blocked access of some pinholes by the redox couples (FIG. 6D).

TABLE 2

| | | Peak Current | Number Density of |
|---|---|---|---|
| | | Density | Pinholes |
| PV4D4 Film | Redox Couple | (μA/cm²) | (pinholes/μm²) |
| Unlithiated 20 nm | dmFc | 23.50 | 8.01 |
| Unlithiated 20 nm | CoCp₂PF₆ | 14.00 | 3.68 |
| Lithiated 20 nm | dmFc | 14.50 | 4.94 |
| Lithiated 20 nm | CoCp₂PF₆ | 9.35 | 2.46 |

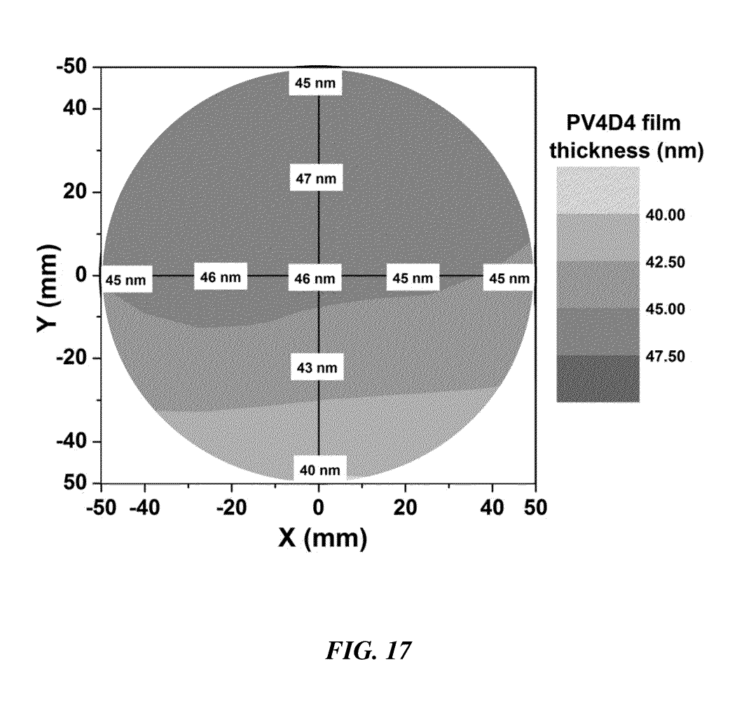

Finally, it was demonstrated in FIG. 17 that the iCVD process used to engineer these conformal, pinhole-free PV4D4 ionic conducting films was scalable. Variable angle spectroscopic ellipsometry (VASE) measurements at various positions on a PV4D4 film grown on a 100 mm diameter silicon wafer showed remarkable uniformity; the standard deviation of the measurements at various locations was within 4.6% of the average film thickness. These are encouraging results for commercialization of these electrolyte films, as the solvent-free CVD polymerization process is readily scalable and easily integrated with other techniques, such as roll-to-roll processing.

In this Example, a key materials limitation that has prevented the realization of high energy density, compact power systems with 3D architectures, namely the lack of a stable, thin film electrolyte to conformally coat non-planar electrode arrays, has been addressed. Incorporating such non-planar electrodes within the 3D architecture may depend on the structural integrity and conformality of the electrolyte. It was demonstrated that thin PV4D4 films synthesized by iCVD are excellent candidates for conformal electrolytes that demonstrate room temperature ionic conductivity exceeding 10⁻⁸ S/cm, in addition to being smooth, pinhole-free and possessing excellent mechanical stability. This Example is the first demonstration that solid thin film cyclic siloxane films with a built-in ring structure can conduct Li⁺ and that these films can be conformal on geometries of proposed 3D battery electrodes. Being the workhorse technology for growing inorganic thin films in the microelectronics industry, CVD is a proven and cost-effective technology, which when coupled with the flexibility of organic chemistry can engineer novel polymer electrolyte films for the emerging field of 3D batteries.

### Methods:

Synthesis. In the iCVD process, vapors of a thermal initiator were introduced into a chamber along with the monomer vapors. Heated films thermally cracked the initiator to form radicals that reacted with the monomer adsorbed on a surface, resulting in simultaneous polymerization and thin film formation on the surface. Key details of the synthesis of PV4D4 via iCVD are described. Thin (10-40 nm) conformal PV4D4 films were synthesized by iCVD from the monomer tetravinyltetramethylcyclotetrasiloxane (V4D4, Gelest Inc.) and the initiator tertbutylperoxide (TBPO, Sigma-Aldrich). The V4D4 monomer, heated to 75° C., and TBPO initiator, at room temperature, were delivered into the reactor at 0.15 and 0.85 standard cubic centimeters per minute (sccm), respectively. PV4D4 films were deposited on 100 mm diameter Si wafers (Wafer World, Inc.), ITO coated glass (1×2 cm, about 50Ω, Precision Glass and Optics), and TEM grids coated with silver nanowires. The reactor pressure, substrate temperature, and filament temperature were maintained at 200 mTorr, 35° C., and 300° C., respectively. The thickness of PV4D4 films was monitored in situ with a laser interferometer system. These deposition conditions are tabulated in Table 3.

TABLE 3

| | | | V4D4 | TBPO | | |
|---|---|---|---|---|---|---|
| Depo- | | | flow | flow | | Average film |
| sition | T_{substrate} | T_{filament} | rate | rate | | deposition |
| # | (° C.) | (° C.) | (sccm) | (sccm) | Pₘ/Pₛₐₜ | rate (nm/min) |
| 1 | 45 | 300 | 0.15 | 1.0 | 0.50 | 0.90 |
| 2 | 35 | 300 | 0.15 | 1.0 | 0.50 | 1.2 |
| 3 | 30 | 300 | 0.15 | 1.0 | 0.50 | 1.4 |
| 4 | 25 | 300 | 0.15 | 1.0 | 0.50 | 1.7 |
| 5 | 35 | 300 | 0.15 | 1.0 | 0.95 | 1.8 |
| 6 | 35 | 300 | 0.15 | 1.0 | 0.30 | 0.72 |

In Table 3, Pₘ/Pₛₐₜ defines the monomer saturation ratio, which presents the effective surface concentration of the monomer on the substrate surface at the start of film growth.
Lithiation. To introduce Li⁺ into PV4D4 films, PV4D4-coated silicon substrates were soaked for 3 days in a 1 M solution of lithium perchlorate (LiClO₄) in propylene carbonate (PC). This soaking step was carried out in a nitrogen-filled glovebox, with O₂ and H₂O levels less than 0.1 ppm. The soaked films were subsequently rinsed in fresh PC and dried under flowing nitrogen.
Chemical and morphological characterization. The FTIR spectra in FIG. 5 were obtained using a Thermo Nicolet Nexus 870 spectrometer operated in transmission mode. The thicknesses of the PV4D4 films, grown on Si wafers, were measured using a variable angle spectroscopic ellipsometer (VASE, JA Woollam M-2000). Measurements were made at 3 incident angles (65°, 70° and 75°), and the data was fit to a Cauchy-Urbach isotropic model using the WVASE32 software. For the 100 mm diameter wafer study, these measurements were repeated at different positions on the wafer. The spot-size of the VASE beam was 1 mm×4 mm. The AFM images in FIGS. 6C and 6D were obtained with a Veeco Dimension 3100 scanning probe microscope operated in tapping mode. The TEM images in FIGS. 6A and 6B were obtained by a JEOL 2010 Advanced High Performance TEM. The TEM samples were prepared by placing a drop of 0.05% silver nanowires in isopropanol (Sigma-Aldrich) on a Lacey carbon copper TEM grid (Ted Pella) and drying overnight under an incandescent bulb. The grids were coated with PV4D4 via iCVD.
Electrical and impedance measurements. Decamethylferrocene (dmFc), cobaltocenium hexafluorophosphate (CoCp₂PF₆), tetrabutylammonium tetrafluoroborate (TBATFB), propylene carbonate (PC), and mercury were obtained from Sigma Aldrich. All reagents were used as received except for the TBATFB, which was dried under vacuum at 120° C. for 6 hours. Electrical and impedance measurements and pinhole characterizations were carried out at room temperature in an argon-filled glovebox. Unlithiated and lithiated 25 and 35 nm PV4D4 films deposited on ITO coated glass substrates were annealed in the glovebox at 110° C. for 1 hour to remove any moisture present in the films. Electrical contacts to the PV4D4 film and ITO substrate were made using hanging mercury drop electrodes with contact areas of 0.0707 to 0.0177 cm² (corresponding to drops of 3 mm and 1.5 mm in diameter, respectively). DC conductivity measurements on unlithiated samples were made by sweeping the potential ±100 mV relative to the open-circuit voltage at a scan rate of 2 mV/s (Bio-Logic VMP3). The DC resistance was calculated from the resulting current-voltage plot. Because DC methods can include contact resistances, the resistance between the Hg electrode and ITO substrate was measured and found to be negligible compared to the calculated DC resistance of the PV4D4 films. Electrochemical impedance measurements were carried out using a Solartron 1252 Frequency Response Analyzer at a frequency range of 100 kHz to 100 Hz and a 10 mV (RMS) potential. Measurements were taken at different positions for each sample and equivalent circuit fittings were applied to the impedance data (Scribner).

Pinhole characterization. Electrochemical measurements were performed on 1 cm² samples of PV4D4 films deposited on ITO coated glass substrates in a three-electrode cell with platinum counter and reference electrodes. Solutions were prepared by combining 1 mM dmFc or CoCp₂PF₆ and 0.1 M TBATFB in PC. Cyclic voltammetry was carried out with scan rates from 200 to 700 mV/s in steps of 50 mV/s (Bio-Logic VMP3). Prior to each set of pinhole tests, the samples were rinsed in PC before being placed in fresh solution, and an initial linear sweep voltammetry scan determined the potential window of the redox couple relative to the Pt quasi-reference electrode. Cyclic voltammetry using 0.1M TBATFB in PC under these same conditions was also performed to account for any capacitive contribution to the redox peak currents.

### EXAMPLE 2

This Example describes the synthesis and characterization of four cyclic organosiloxane and organosilazane polymers. In particular, poly(1,3,5,7-tetravinyl-1,3,5,7-tetramethylcyclotetrasiloxane) (PV4D4), poly(1,3,5-trivinyl-1,3,5-trimethylcyclotrisiloxane) (PV3D3), poly(1,3,5-trivinyl-1,3,5-trimethylcyclotrisilazane) (PV3N3), and poly(1,3,5,7-tetravinyl-1,3,5,7-tetramethylcyclotetrasilazane) (PV4N4) were synthesized via iCVD processes.

All four polymers were fully characterized, and their chemical, morphological, and optical properties were analyzed.

Materials. The initiator, tert-butyl peroxide (TBPO, 98%) was purchased from Sigma Aldrich. 1,3,5-trivinyl-1,3,5-trimethylcyclotrisiloxane (V3D3, greater than 95%), 1,3,5,7-tetravinyl-1,3,5,7-tetramethylcyclotetrasiloxane (V4D4, greater than 95%), 1,3,5-trivinyl-1,3,5-trimethylcyclotrisilazane (V3N3, 95%), and 1,3,5,7-tetravinyl-1,3,5,7-tetramethylcyclotetrasilazane (V4N4, 95%) were purchased from Gelest, Inc. All reactants were used as received.

Polymerization. Vapors of monomer and initiator were introduced into the iCVD chamber with flow rates of 0.05 to 0.2 (PV3D3: 0.2; PV4D4: 0.1; PV3N3: 0.1; PV4N4: 0.05) and 1.0 sccm, respectively. Polymer thin films were deposited on 10 cm-diameter silicon wafers (Wafer World, Inc) and indium tin oxide (ITO) coated glass (1×2 cm, about 50 S⁻2, Precision Glass and Optics). The film growth was monitored via laser interferometery (633-nm HeNe laser, JDS Uniphase). The chamber pressure was controlled at 200 mTorr by throttle valve and measured using a Baratron capacitance manometer (MKS Instruments). An array of filaments (ChromAlloy O, Goodfellow Inc.) was heated to about 270° C. by a DC power supply. The initiator was thermally cracked by the hot filaments and formed free radicals, which reacted with the monomer on the surface. The temperature of the sample stage was maintained between 27 and 40° C. by a chiller (NESLAB). Reactor, filament, and substrate temperatures were monitored using thermocouples (K-type, Omega Engineering). The monomers were heated to a temperature of 75° C., and the initiator was retained at room temperature. The ratio between the monomer partial pressure (Pₘ) and the saturation pressure at the substrate temperature (Pₛₐₜ) was controlled between 0.3 to 0.8 as an optimal iCVD window.

This Example represents the first time that PV3N3 and PV4N4 were synthesized by iCVD. Table 4 summarizes the deposition rates of PV3N3 and PV4N4 at different substrate temperatures (T₅) and Pₘ/Pₛₐₜ.

TABLE 4
Deposition Conditions of iCVD Polysilazane Films

| | | | | | Rate of |
|---|---|---|---|---|---|
| Sample | Sample | | | | Deposition |
| Number | Name | Tₛ (K) | T_{f} (K) | Pₘ/Pₛₐₜ | (nm/min) |
| A1 | PV3N3 | 306 | 543 | 0.70 | 2.50 ± 0.35 |
| A2 | PV3N3 | 306 | 543 | 0.50 | 1.60 ± 0.20 |
| A3 | PV3N3 | 306 | 543 | 0.35 | 1.30 ± 0.12 |
| A4 | PV3N3 | 300 | 543 | 0.35 | 1.80 ± 0.15 |
| A5 | PV3N3 | 311 | 543 | 0.35 | 1.00 ± 0.10 |
| B1 | PV4N4 | 306 | 543 | 0.30 | 0.030 ± 0.007 |
| B2 | PV4N4 | 306 | 543 | 0.80 | 0.090 ± 0.010 |
| B3 | PV4N4 | 306 | 543 | 0.50 | 0.070 ± 0.007 |
| B4 | PV4N4 | 300 | 543 | 0.50 | 0.080 ± 0.010 |
| B5 | PV4N4 | 313 | 543 | 0.50 | 0.040 ± 0.006 |

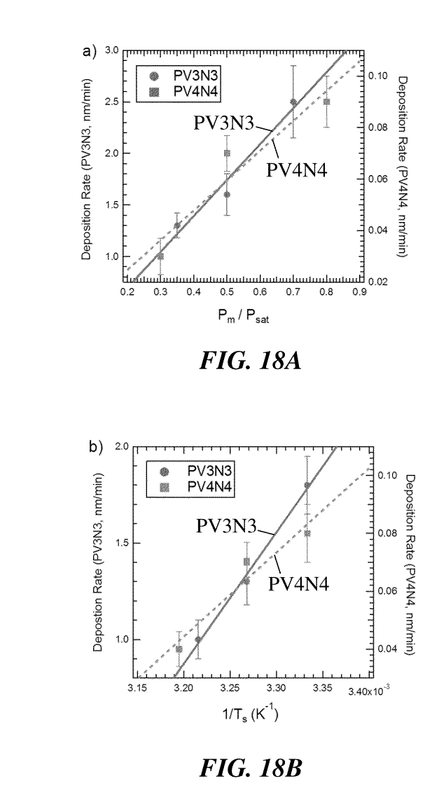

The kinetics of polymerization were studied for the PV3N3 and PV4N4 polymers. FIG. 18A shows a plot of deposition rate (nm/min) as a function of Pₘ/Pₛₐₜ for PV3N3 (samples A1-A3) and PV4N4 (samples B1-B3), with the solid line indicating a linear fitting of the data points. The deposition rate was calculated by dividing the maximum film thickness by the total deposition time. From FIG. 18A, it can be seen that increasing Pₘ/Pₛₐₜ, which is one of the main factors affecting deposition rate in iCVD processes, generally increased deposition rate. For example, increasing Pₘ/Pₛₐₜ for PV3N3 from 0.35 to 0.70 resulted in an increase in PV3N3 deposition rate from 1.0 to 2.5 nm/min. Similarly, increasing Pₘ/Pₛₐₜ for PV4N4 from 0.30 to 0.80 resulted in an increase in PV4N4 deposition rate from 0.03 to 0.09 nm/min.

FIG. 18B shows a plot of deposition rate (nm/min) as a function of reciprocal substrate temperature 1/Tₛ (K⁻¹) for PV3N3 (samples A3-A5) and PV4N4 (samples B3-B5). From FIG. 18B, it can be seen that deposition rate generally increased with increasing reciprocal substrate temperature. Using the Arrhenius equation, apparent activation energies (Eₐ) of PV3N3 and PV4N4 polymerizations were estimated as −35.2 kJ/mol and −42.1 kJ/mol, respectively. Previous iCVD studies indicated that Eₐ (with respect to Tₛ) of PV3D3 was −23.2 kJ/mol.

In iCVD, increasing substrate temperature Tₛ generally increases the propagation rate of polymerization but reduces the equilibrium concentration of absorbed species on the substrate. The negative Eₐ of PV3N3 and PV4N4 indicated that the decrease in surface concentration of reactive species dominated over the increase in propagation rate when Tₛ increased. Comparison of Eₐ between PV3N3 and PV3D3 also suggested that Tₛ had a larger effect on the polymerization of silazane than siloxane.

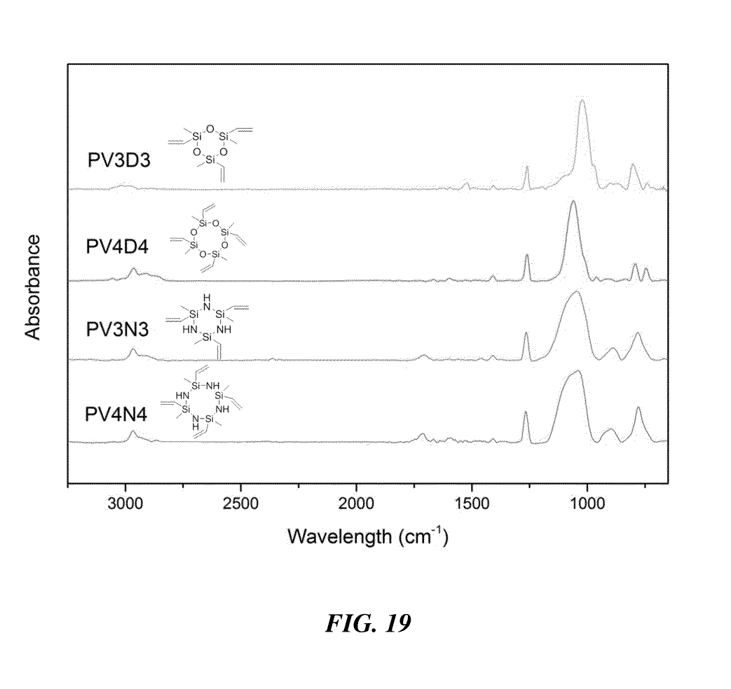

To identify the structures of the iCVD-synthesized polymers, the polymers were characterized by Fourier transform infrared (FTIR) spectra. FTIR spectra were obtained using a Thermo Nicolet Nexus 870 spectrometer equipped with a MCT (Mercury cadmium tellurium) detector and KBr beamsplitter operated in transmission mode. OMNIC software (Thermo Scientific) was used for spectra processing. FIG. 19 shows FTIR spectra for PV3D3, PV4D4, PV3N3, and PV4N4 polymers. It can be seen from FIG. 19 that a peak at around 1060 cm⁻¹, which may be attributed to Si—O or Si—N bond absorption, was present in the FTIR spectra of all four polymers. Large peaks located around 1100 cm⁻¹ correspond to Si—O—Si stretching from cyclic six- or eight-member siloxane rings. This presence of these peaks in the PV3D3 and PV4D4 spectra indicated that siloxane rings had been retained during PV3D3 and PV4D4 polymerization. Si-N-Si stretching was observed as the broad peak around 1200 cm⁻¹ and the small peak around 950 cm⁻¹ in the PV3N3 and PV4N4 FTIR spectra. These peaks indicated that silazane rings were retained after PV3N3 and PV4N4 polymerization. Evidence of free radical polymerization can generally be confirmed by the reduction of vinyl-bond absorption and the appearance of symmetric CH₂ stretching peaks around 2900 cm⁻¹, which indicate polyethylene-like backbones in polymers. These methylene groups were formed from the polymerization of the vinyl groups, and the significant reduction at 1415 and 1600 cm⁻¹ confirmed the loss of vinyl moieties through free radical polymerization. Because each monomer contained either three or four vinyl groups, the resultant structure was a highly crosslinked organic network.

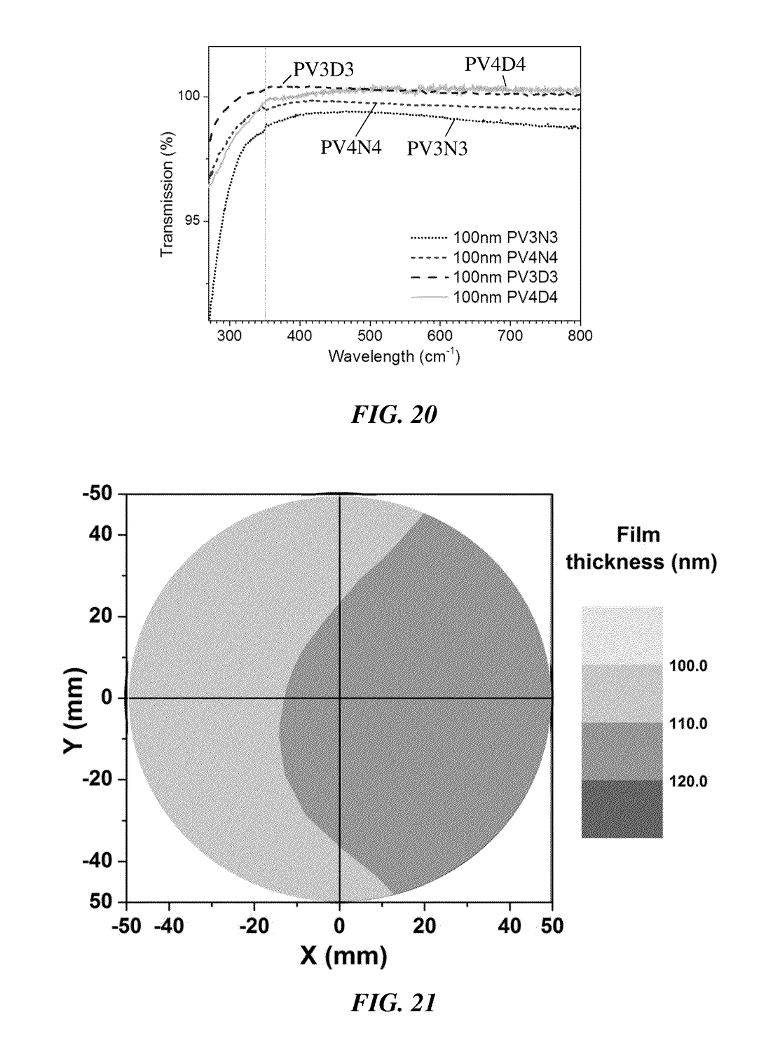

Optical transmittance measurements were made for 100 nm PV3D3, PV4D4, PV3N3, and PV4N4 films on glass substrates using a Varian Cary 6000i UV-Vis-NIR dual-beam spectrophotometer. The iCVD polysiloxane and polysilazane thin films were transparent in both visible and ultraviolet (UV) spectra regions. FIG. 20 shows UV-Vis spectra for 100 nm PV3N3, PV4N4, PV3D3, and PV4D4 films. The vertical dotted line indicates greater than 98% transmittance in the wavenumber range of 350 to 800 cm⁻¹. From FIG. 20, it can be seen that all four polymers showed greater than 98% transmittance of light in the range of 350 to 800 cm⁻¹, and greater than 95% transmittance of light in the UV range of 300 to 350 cm⁻¹. Their high transparency, in addition to their good thermal stability, solvent resistance, and ease of processing, enable polysiloxane and polysilazane thin films to be considered in optoelectronics applications, such as encapsulation, fabrication of micro lenses, and optical coatings.

The thicknesses of iCVD films were measured using a JA Woollam M-2000 variable angle spectroscopic ellipsometer (VASE) at incident angles of 65, 70, and 75°. For example, the thickness of a 100 nm PV3N3 film on a 10 cm-diameter silicon wafer was measured by VASE, and the results are shown in FIG. 21. From FIG. 21, it can be seen that the thicknesses at 9 different positions all had a standard deviation (SD) within 6% of the average thickness. A previous study on the uniformity of PV4D4 film grown on a 10 cm-diameter Si wafer also showed a SD of thicknesses at various locations within 4.6% of the average thickness. These results demonstrate the uniformity of iCVD coatings.

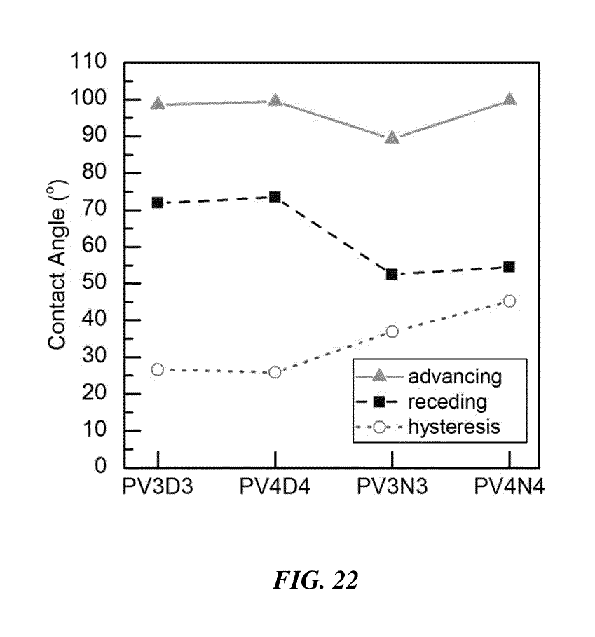

Water contact angles were measured by a goniometer equipped with an automated dispenser (Model 500, Rame-Hart). Advancing (the largest angle obtained) and receding (the smallest angle obtained) contact angles were measured using the sessile drop method, depositing a droplet of 1 μL on the surface. FIG. 22 shows advancing (solid triangle), receding (solid square), and hysteresis (hollow circle) of water contact angle (CA) for PV3D3, PV4D4, PV3N3, and PV4N4 films. All polymers exhibited advancing CA around 100° except PV3N3, which had an advancing CA around 90°. Both PV3D3 and PV4D4 films showed higher receding CA and therefore lower CA hysteresis (the difference between advancing and receding CA) than PV3N3 and PV4D4 films. Low CA hysteresis, corresponding to low sliding angle, may be desirable for surfaces with low wettability in high efficiency water-repellent coatings or electro-wetting devices. CA hysteresis can be affected by several factors, such as surface roughness, physical and chemical surface heterogeneities, cross-linking level, drop size effect, and/or molecular reorientation at the surface. While all the polymer films had similar ring structures and physical properties (e.g. smoothness), their cross-linking levels may have been different since the rate of propagation may have been different in the polymerization of siloxane and silazane. Having NH groups instead of 0 atoms, silazane monomers generally have more electronegative Si than siloxane monomers, which may result in less reactive vinyl bonds and therefore a slower propagation rate. This hypothesis is consistent with the lower CA hysteresis of polysiloxane observed, since CA hysteresis strongly decreases with the increased cross-linking level of the polymer.

In addition, the resistivity of a 20 nm PV4D4 film was measured and was found to be about 10⁸ Ω·cm.

Additionally, the ring diameter of the V4D4 monomer was estimated to be 590 picometers (μm). It was therefore determined that a number of cations could be capable of moving through the V4D4 ring; for example, Mg²⁺ has a diameter of 172 pm, Li⁺ has a diameter of 180 pm, and Na⁺ has a diameter of 232 pm.

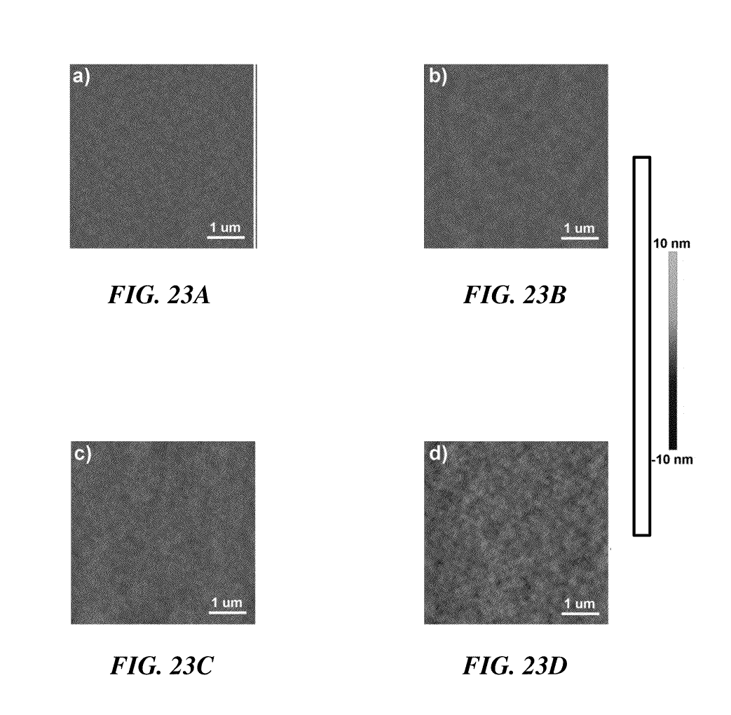

The morphology of iCVD polymer films was characterized by atomic force microscopy (AFM). AFM images were obtained using a Veeco Dimension 3100 scanning probe operated in tapping mode. As shown in FIGS. 23A-D, 100 nm thick films on silicon wafers of PV3N3 (FIG. 23A), PV4N4 (FIG. 23B), PV3D3 (FIG. 23C), and PV4D4 (FIG. 23D) all were smooth and uniform. The root-mean-squared roughness values (R_{RMS}) were measured at 0.27, 0.28, 0.39, and 0.54 nm for 100 nm PV3N3, PV4N4, PV3D3, and PV4D4 films on Si substrates, respectively. No visible pin-holes or defects were found in the AFM investigation.

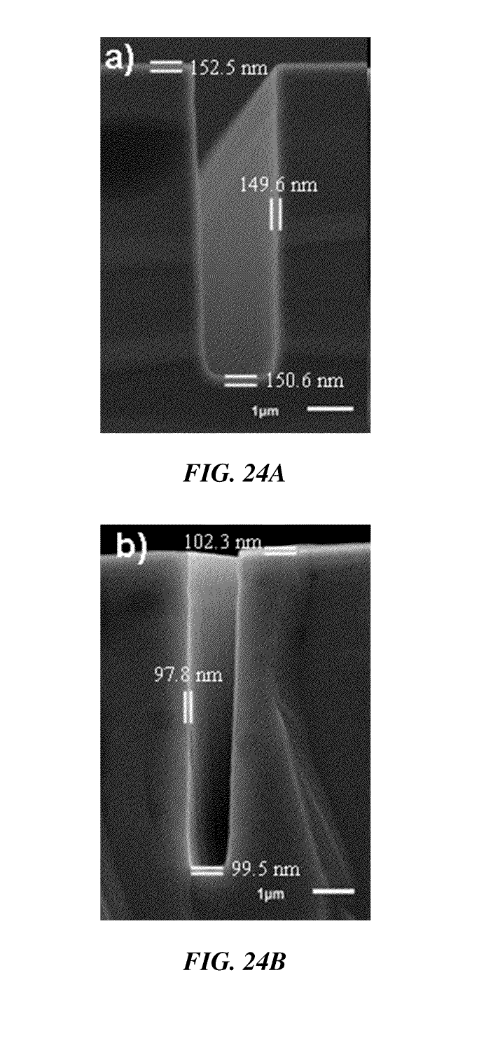

Other than roughness, conformality is an important factor describing the quality of coatings. It represents the ability to cover the entire surface topography with a uniform thickness and composition. Trench Si wafers were conformally coated with PV3N3 and PV4N4 films. Scanning electron micrograph (SEM) spectra were obtained using a JEOL 6010LA scanning electron microscope. FIG. 24A shows a cross-sectional SEM image of a 150 nm PV3N3 film coating a trench Si wafer with an aspect ratio of 4:1, and FIG. 24B shows a cross-sectional SEM image of a 100 nm PV4N4 film on a trench Si wafer with an aspect ratio of 8:1. For the 150 nm PV3N3 film, the ratio of the thickness of the polymer layer on the top surface of the trench to the thickness of the polymer layer on the bottom surface of the trench, Tₜₒₚ:T_{bottom}, was 1.01, the ratio of the thickness of the polymer layer on the top surface of the trench to the thickness of the polymer layer on a side surface of the trench, Tₜₒₚ:T_{side}, was 1.02, and the ratio of the thickness of the polymer layer on the bottom surface of the trench to the thickness of the polymer layer on a side surface of the trench, T_{bottom}:T_{side}, was 1.01. For the 100 nm PV4N4 film, the ratio of Tₜₒₚ:T_{bottom} was 1.03, the ratio of Tₜₒₚ:T_{side} was 1.05, and the ratio of T_{bottom}:T_{side} was 1.02. These results further demonstrated that iCVD polysiloxane or polysilazane thin films could be conformally coated onto substrates with complex geometry.

Overall, experimental results showed that the polysiloxane and polysilazane polymers could be conformally, smoothly (R_{RMS} less than 1 nm), and uniformly coated onto substrates with high aspect ratios, such as electrode arrays used in 3D Li⁺ batteries. The transparent nature and contact angle (CA) properties of these films also suggested that they could be used in other applications, such as optical devices and/or surfaces engineering.

### EXAMPLE 3

This Example describes how iCVD-synthesized nanoscale (10-50 nm) films of cyclic siloxane and silazane polymers were converted into ionic conductors at room temperature through a solution-based lithium ion (Li⁺) doping process referred to as lithiation. The characteristics of the lithiated films, including thickness, ionic conductivity, morphological and chemical stability, and ion content are also described.

Materials. 10-50 nm thick poly(1,3,5-trivinyl-1,3,5-trimethylcyclotrisiloxane) (PV3D3), poly(1,3,5,7-tetravinyl-1,3,5,7-tetramethylcyclotetrasiloxane) (PV4D4), poly(1,3,5-trivinyl-1,3,5-trimethylcyclotrisilazane) (PV3N3), and poly(1,3,5,7-tetravinyl-1,3,5,7-tetramethylcyclotetrasilazane) (PV4N4) films were synthesized using the iCVD method. The V3D3, V4D4, V3N3, V4N4 monomers were heated at 70° C., and their vapors were delivered into the reactor at flow rates of 0.1-0.3 sccm, while vapors of a tert-butyl peroxide initiator (at room temperature) were delivered into the reactor at a flow rate of 1.0 sccm. The reactor pressure, substrate temperature, and filament temperature were maintained at 200 mTorr, 35° C. and 280° C., respectively. These films were deposited on silicon wafers (Wafer World, Inc) and indium tin oxide (ITO) coated glass (1×2 cm, about 50 S⁻2, Precision Glass and Optics). The salts used for lithiation, anhydrous lithium perchlorate (LiClO₄), anhydrous lithium chloride (LiCl), and anhydrous lithium tetrafluoroborate (LiBF₄), and the anhydrous solvents propylene carbonate (PC) and ethanol, were purchased from Sigma Aldrich and used without further purification.

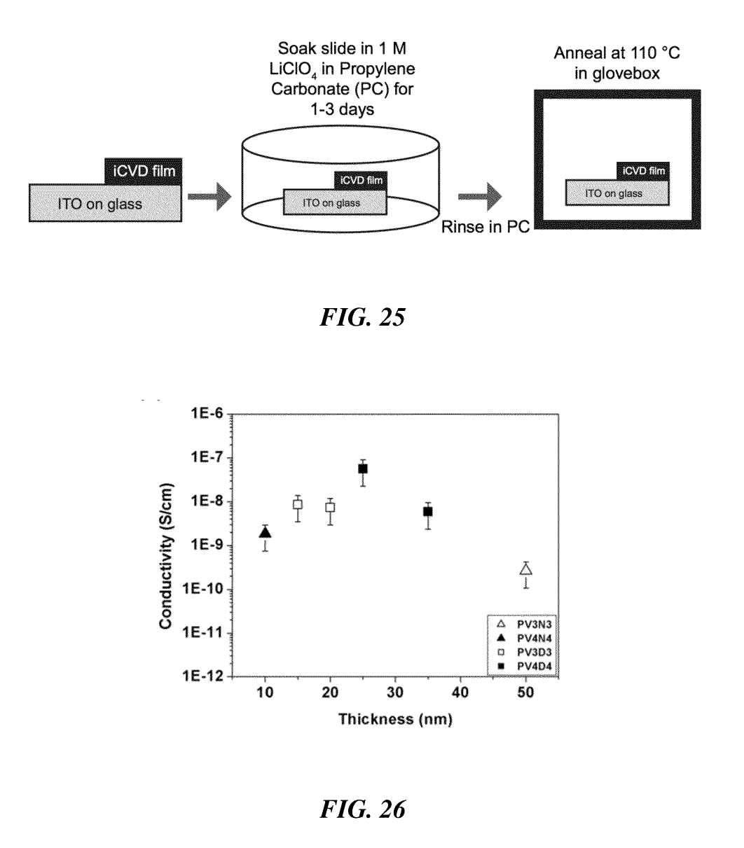

Lithiation. Unless otherwise stated, Li ions (Li⁺) were introduced into iCVD grown polymer films using the following procedure: coated substrates were soaked for 3 days in a 1 M solution of LiClO₄ in propylene carbonate (PC). The soaking process was carried out inside an argon-filled glovebox, with O₂ and H₂O levels less than 0.1 ppm. As shown in FIG. 25, the soaked films were subsequently rinsed with fresh PC and annealed in the glovebox at 110-130° C. for 1 hour to remove residual solvent present in the films.

Characterization. The thicknesses of the iCVD grown polymer films on Si wafers were measured using variable angle spectroscopic ellipsometry (VASE, JA Woollam Model M-2000). Measurements were made at three incident angles (65°, 70° and 75°), and the data was fit to the Cauchy-Urbach isotropic model using WVASE32 software. The spot-size of the VASE beam was 1×4 mm. Atomic force microscopy (AFM) images were obtained on a Veeco Dimension 3100 scanning probe microscope operated in tapping mode. Ionic conductivity of these iCVD grown polymer films was determined using electrochemical impedance spectroscopy (EIS). The EIS spectra were collected at room temperature in an argon-filled glovebox with O₂ and H₂O levels less than 0.5 ppm using a Solartron 1252 Frequency Response Analyzer at a frequency range of 100 kHz to 100 Hz and a 10 mV (RMS) potential. Soft but robust contacts to the nanoscale polymer films and ITO substrate were made using hanging mercury (Hg) drop electrodes with contact areas of 0.0707 to 0.0177 cm² (corresponding to drops of 3 and 1.5 mm in diameter, respectively). Measurements were taken at different positions on each sample, and the impedance data were fit to equivalent circuits (Scribner).

The Li content in the films was analyzed using a quadrupole inductively coupled mass spectroscopy (ICP-MS) (VG Plasma Quad 2+) using a 400 mL/min nebulizer. The sample preparation process (e.g. lithiation) was carried out in pre-cleaned plastic Teflon (Savillex) vials. Bare and lithiated PV3D3 and PV4D4 films of about 20 nm thickness on about 1 cm x 1 cm pieces of silicon wafer were dissolved in 40 mL of 1% nitric acid (HNO₃) for 3 days at room temperature, and the solution was subsequently filtered through a syringe filter (Pall Life Sciences) to remove silicon particles. The parts per billion (ppb) amounts of Li in this solution were calibrated with respect to a 1 ppb Li standard. For reproducibility, the films were also dissolved in varying acid concentrations (1% HNO₃, 5% HNO₃ and 8M concentrated HNO₃). The Li concentration in the solution in ppb was found to be within 10% of the mean value for all three test cases. 1% HNO₃ was chosen as the default test condition for simplicity and ease of sample processing. Blank 1% HNO₃ solution, bare silicon wafer, and unlithiated film samples were used as the reference to subtract Li background arising from the acid, the substrate and the polymer, respectively. Each sample was measured three times, and the average ppb value was used in the calculations.

Raman spectroscopy was carried out using a Horiba-Jobin Yvon system with a 785 nm laser line operating at a power of 10 mW. A 10× objective was used for focusing. The typical spectral collection condition was a 10 s exposure time and an accumulation number of 5.

Density functional theory (DFT) calculations were carried out on the V3D3 and V4D4 siloxane ring systems to investigate the binding energy of the Li⁺ at different positions with respect to the monomer ring. All calculations, including geometry optimizations and single point energies, were calculated using the hybrid functional B3LYP, with Dunning's (cc-pvDZ) basis set, implemented in the Gaussian 09 program package. Long range interactions were included using Grimme's D3 dispersion correction.

### Results and Discussion

### Ionic Conductivity

The as-deposited iCVD polymer films described in this Example were electrical insulators. The excellent dielectric and mechanical properties of iCVD polymer films derived from the V3D3 monomer have enabled fabrication of flexible field effect transistors. The electrical resistivity was previously reported to be in the range of about 10¹¹-10¹⁵ ohm-cm. Such low electrical conductivity values are an important property for electrolyte materials so that short-circuiting inside a battery is prevented. In contrast, the ionic conductivity values for electrolytes generally are high in order to minimize ohmic loss in the battery.

A solution-based lithiation process (shown in FIG. 25) was used to dope Li⁺ into these polymer films and make them ionic conductors. Prior to lithiation, the films were both electronic and ionic insulators. After lithiation, they retained their high electronic resistivity, but also exhibited ionic conduction. FIG. 26 compares the EIS-derived ionic conductivity values of the PV3D3, PV4D4, PV3N3, and PV4N4 films, with the width of the bars indicating the error margin in the measurements. To obtain the ionic conductivity values, the characteristic semicircles in the Nyquist plot obtained from the EIS measurements were fitted to a Randles equivalent circuit to determine the average ionic resistance (Rₑ), and the ionic conductivity values were calculated using Equation 2, where the film thickness was averaged from VASE measurements at 5 positions on the sample and the electrode contact area was defined by the Hg drop size.

The ionic conductivity values of the four polymer films ranged from 10⁻⁷ S/cm to 10⁻¹¹ S/cm at room temperature. For a similar film thickness range of 10-50 nm, lithiated siloxane films PV3D3 and PV4D4 showed higher ionic conductivities than their silazane counterparts PV3N3 and PV4N4. Without wishing to be bound by a particular theory, one reason for the increased ionic conductivity of the siloxane films may be that oxygen atoms on siloxane rings of the siloxane films can provide more favorable binding sites for Li⁺. This would be consistent with the more ionic nature of the Si—O bond compared to the Si-N bond. In addition, the vibrations of flexible Si—O—Si bonds may have the potential to facilitate a hopping ion transport mechanism, resulting in higher ionic conduction at room temperature.

According to the DFT calculations presented below, the anion ClO₄⁻, which is located in the regions of positive charge outside the ring to minimize electrostatic repulsion, can also contribute to the measured value of ionic conductivity.

As the film thickness increases beyond 30-50 nm, there is generally a steady decrease in ionic conductivity. As will be discussed in the ICP-MS results presented below, full lithiation of the thicker films cannot usually be achieved, and the unlithiated material does not conduct ions. It is plausible that as film thickness increases, the roughness and disorder in ring stacking increase, leading to poor diffusion of Li into the bulk of the films.

The highest ionic conductivity obtained in these measurements (10⁻⁷S/cm for about 25 nm PV4D4) is modest when compared to those of liquid or bulk polymer electrolytes. However, the nanoscale thickness of these iCVD films can provide an interesting advantage when it comes to significantly lowering the ionic diffusion times. This is because for a given value of ionic diffusion coefficient (Dᵢₒₙ), the ionic diffusion time (τ) increases as the square of the ionic diffusion length (Lᵢₒₙ), as described by Equation 1.

Therefore, nanoscale electrolytes such as a 25 nm thick PV4D4 film exhibit several orders of magnitude lower ionic diffusion time (τ) compared to micro or macroscale conventional electrolytes and can thus compensate for their modest ionic conductivities by their shorter ionic diffusion times. Since the PV3D3 and PV4D4 systems exhibited consistently higher values for ionic conductivity compared to the PV3N3 and PV4N4 systems, the rest of this Example focuses on the properties of the PV3D3 and PV4D4 materials.

### Morphology

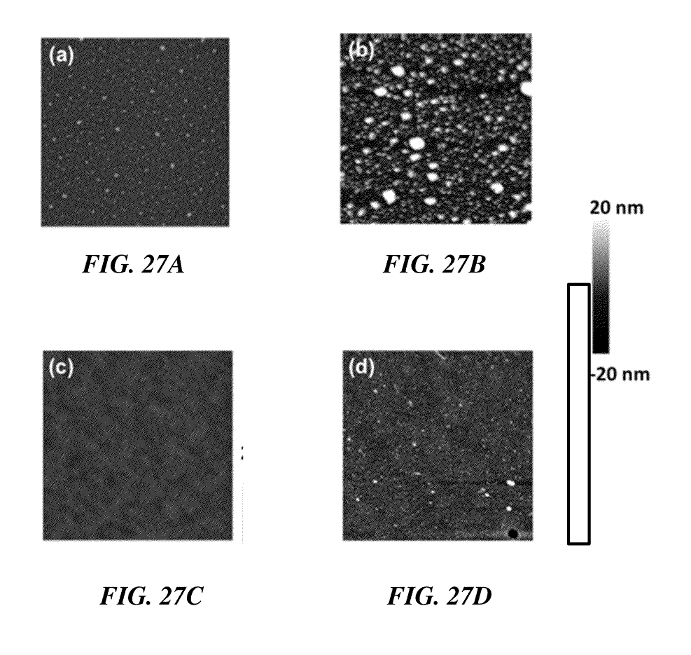

The surface morphology of the 30 nm thick PV3D3 and 25 nm thick PV4D4 films before and after lithiation are compared in FIG. 27. FIGS. 27A-B are AFM images of an iCVD-deposited 30 nm thick PV3D3 film on a silicon wafer before lithiation (FIG. 27A) and after lithiation (FIG. 27B). FIGS. 27C-D are AFM images of an iCVD-deposited 25 nm thick PV4D4 film before lithiation (FIG. 27C) and after lithiation (FIG. 27D). The as-deposited iCVD films of both types displayed low surface roughness, having values that were on the same order as the roughness of a typical silicon wafer (about 0.5 nm). The as-deposited PV4D4 films were particularly smooth, with a root mean square roughness (R_{RMS}) of about 0.67 nm, averaged over multiple line scans on the sample depicted in FIG. 27C. The roughness was approximately double for PV3D3 films (R_{RMS} about 1.29 nm), as depicted in FIG. 27A. Surface roughness increased after lithiation for both polymers, with the PV4D4 again displaying approximately roughly half the surface roughness (R_{RMS}=2.92 nm) (FIG. 27C) as compared to an R_{RMS}=4.76 nm for PV3D3 (FIG. 27D).

The lithiated samples in FIGS. 27B and 27D showed the appearance of clusters. Energy dispersive x-ray spectroscopy (EDS) indicated that these clusters contained chlorine (Cl), suggesting that they were LiClO₄ particles resulting from the lithiation process. Thus, the increase in surface roughness after lithiation measured by AFM can be attributed to salt clusters.

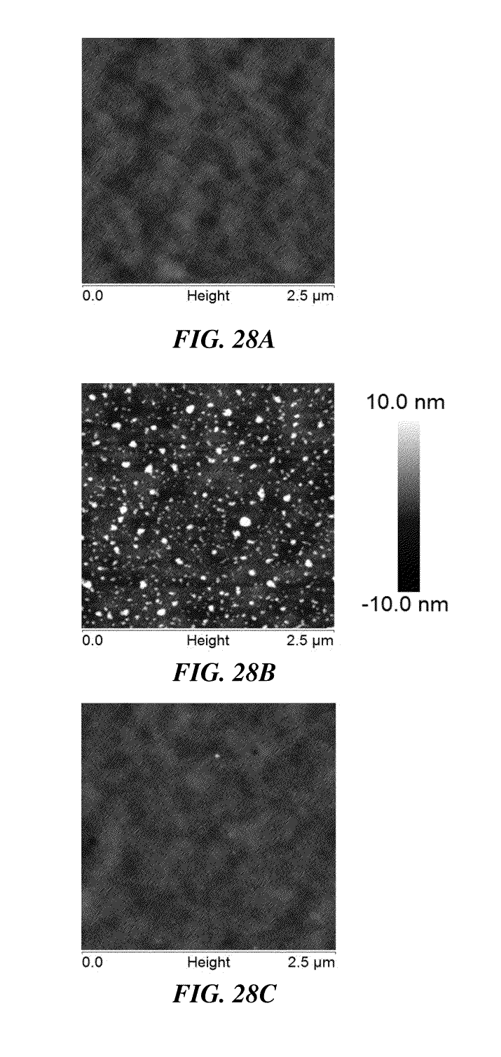

Rinsing the lithiated samples in ethanol (solvent with high solubility for LiClO₄) for 15 minutes eliminated these surface deposits and returned the samples to their pre-lithiation level of roughness (FIG. 28). For example, before lithiation, R_{RMS} of a silicon surface coated with PV4D4 was 0.57 nm (FIG. 28A). After lithiation but before ethanol rinsing, R_{RMS} was 2.29 nm (FIG. 28B). After ethanol rinsing, R_{RMS} was 0.51 nm (FIG. 28C). The ionic conductivity values remained about 10⁻⁸ S/cm for the 25 nm PV4D4 film.

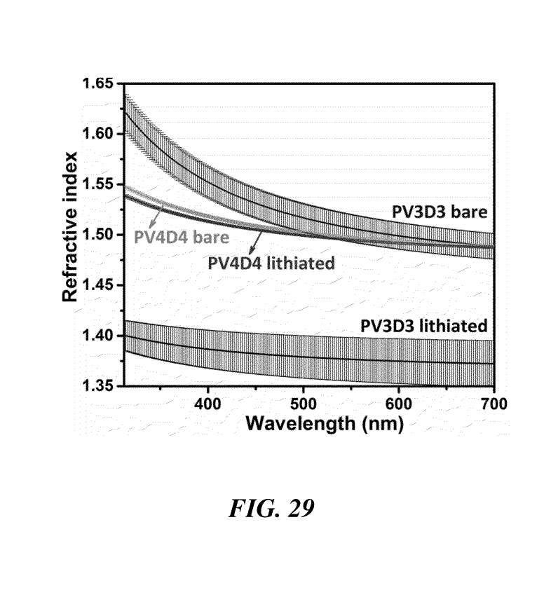

VASE measurements were fitted to obtain the change in refractive index of PV3D3 and PV4D4 films before and after lithiation. FIG. 29 shows a comparison of refractive index of PV3D3 and PV4D4 films on silicon wafers before and after lithiation, as obtained from VASE. The data was the average of measurements at 5 positions on the film sample, and error bars indicated deviation from the average value. From FIG. 29, it can be seen that PV3D3 films showed a significant drop in refractive index after soaking in Li salt solution for 3 days, while only negligible changes were observed in PV4D4 films. Without wishing to be bound by a particular theory, the drop in refractive index may be explained by loss in density of the PV3D3 films due to the increase in volume from the increase in film thickness (swelling) after the solution-based lithiation step. The PV4D4 films demonstrated negligible (less than 3%) change in film thickness after the solution-based lithiation step. The PV3D3 films, on the other hand, showed a significantly higher value, about 78% increase in film thickness.

The mean squared error (MSE) is a fitting parameter that is used in VASE measurements and can be related to surface roughness. Values less than 3-4 suggest highly smooth surfaces (e.g., polished silicon with AFM R_{RMS} about 0.5 nm). The MSE parameters further indicated that PV4D4 films were less rough compared to PV3D3 films. This observation was consistent with the AFM results (FIG. 27) and may also be attributed to the lower stability of the planar V3D3 rings. X-ray reflectivity (XRR) measurements further corroborated the decrease in density of PV3D3 films after lithiation. X-ray diffraction (XRD) measurements also indicated that the polymer films studied were amorphous.

The nature of the siloxane ring unit may play an important role in determining the surface roughness of these polysiloxane films. The planar configuration generally induces strain in the V3D3 rings, while the puckered structure of V4D4 generally results in zero ring strain. In some cases, reducing ring strain energy may be the primary driving force, which reduces stability of the PV3D3 films relative to PV4D4 films. Specifically, the strained V3D3 ring structures are generally more easily cleaved during chemical processing steps. Indeed, evidence in support of this phenomenon during iCVD polymerization includes the observation of Si—Si bonds in Raman spectroscopy of iCVD PV3D3 films. The potential for ring cleavage during lithiation could account for the lowering of film quality (delamination or loss of film during lithiation), variability in pinhole size and density, and poor reproducibility of such significant properties as ionic conductivity, as is observed for PV3D3.

Overall, PV4D4 films showed improved stability during the lithiation process compared to PV3D3 films. The morphology and ionic conductivity values were also more predictable for PV4D4. The minimal swelling of PV4D4 films in solution may be a valuable attribute when using these materials in electrochemical environments and may provide them with a significant advantage when compared to conventional polymer electrolytes (e.g., polyethylene oxide (PEO) and polyphenylene oxide (PPO)), which can swell up to 50% in volume on solution uptake. The large free volume available within the PV4D4 films is a consequence of the larger siloxane rings and the puckered rings that help relieve strain can contribute to the observed lack of swelling. Finally, the larger V4D4 ring with 4 oxygen atoms could also help chelate more Li⁺ compared to the smaller V3D3 ring, resulting in improved ionic conductivity. However, as DFT calculations show, there is likely to be an upper limit to the number Li⁺ that can be added to these rings before destabilizing the co-ordination complex they form with the rings.

### Lithium Content in Films

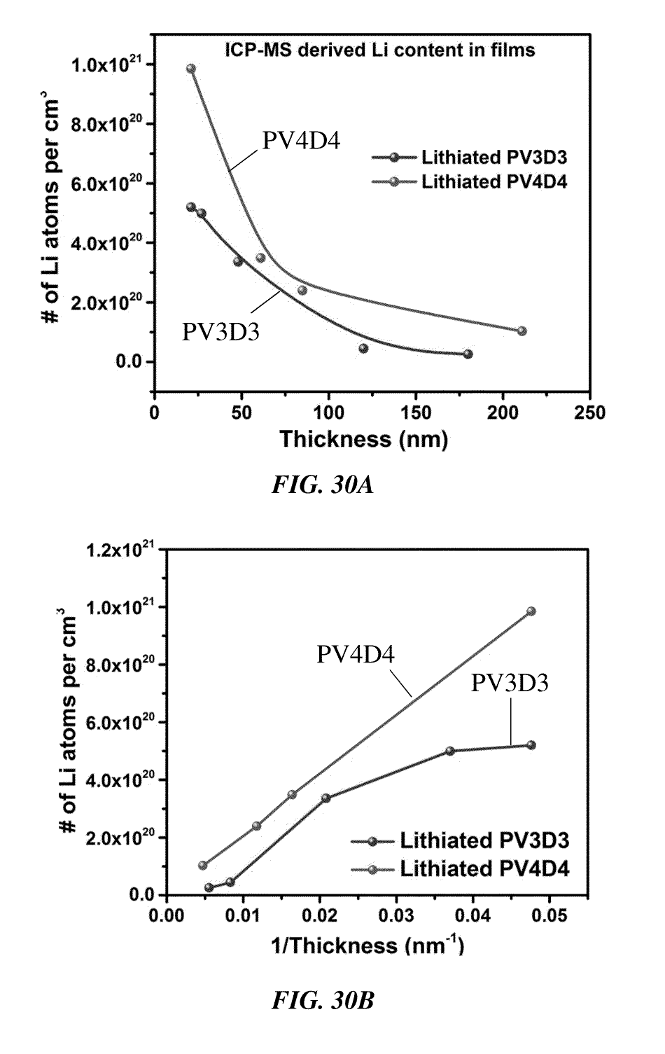

Being an element with low atomic number (Z=3), Li was difficult to detect in the lithiated iCVD films using EDS. Instead, ICP-MS, a technique sensitive enough to detect metals in parts per trillion amounts, was used to carry out elemental analysis of the films. The sample was first ionized by inductively coupled plasma, and then a mass spectrometer was used to separate and quantify ions present in the sample. FIG, 30A shows the ICP-MS results for number of Li atoms per cm³ of the PV3D3 and PV4D4 films as a function of film thickness, and FIG. 30B shows a plot of number of Li atoms per cm³ of the PV3D3 and PV4D4 films as a function of reciprocal film thickness (nm⁻¹). For both PV3D3 and PV4D4, it can be seen that the number of Li atoms decreased with increasing film thickness. This trend agreed with experimental observations wherein ionic conductivity decreased with increasing film thickness (FIG. 26).

In fact, films thicker than 35-50 nm mostly exhibited dielectric behavior. Using the molecular weight of the V3D3 (222 g/mol) and V4D4 (345 g/mol) monomer units and assuming there is about 1 Li⁺ per ring, the Li content in these iCVD films was estimated to peak at about 1 wt. % for a 25 nm thick PV4D4 film.

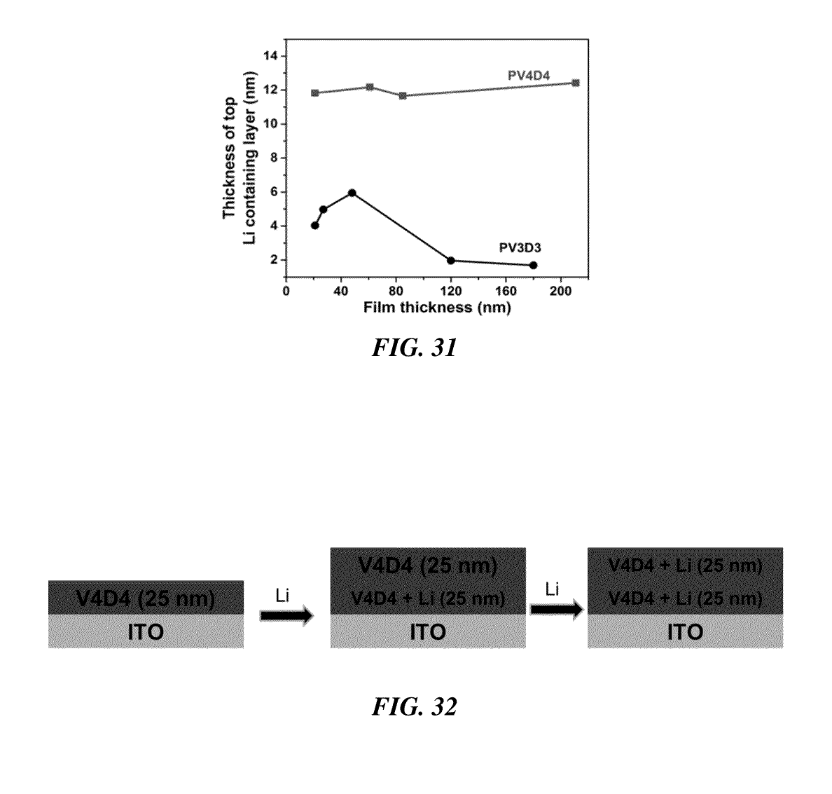

FIG. 31 shows thickness d of the top lithiated layer for PV4D4 and PV3D3 films, as derived from a zero order model for Li-containing top layer of films. The poor ionic conductivity seen in thicker films suggests that the Li concentration drops from the film surface toward the film-substrate interface in thicker films. For a distance x into a film of total thickness t, the concentration of Li as a function of distance C(x) can be defined according to Equation 10:

∫₀^{t}C(x)dx=d×C₀ (10)

where d is the depth of the lithiated layer having Li concentration of C₀ in the zero order evaluation. Here the simplest single step profile is assumed, where the topmost layer of the film (thickness d) has a Li concentration of C₀ but the concentration is zero below this depth.

As indicated in FIG. 31, this zero order model can predict the minimum thickness of these films that will always contain Li. In other words, the model can tell us that for PV4D4 films, the top 15 - 20 nm of the film will generally always be lithiated. Accordingly, films with 15-20 nm thickness show the highest ionic conductivity, particularly for PV4D4.

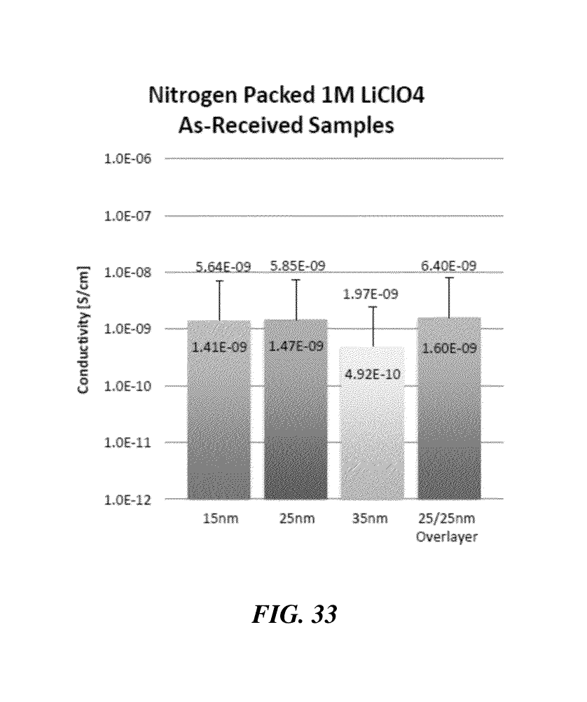

In order to lithiate thicker films, a multi-step lithiation process was developed that produced 50 nm thick PV4D4 films with an ionic conductivity of 10⁻⁸ S/cm. For example, FIG. 32 provides a schematic illustration of a two-step lithiation process that can result in thicker, ionically conductive films. According to the process illustrated in FIG. 32, a 25 nm PV4D4 film was initially deposited on an ITO electrode. The PV4D4 film was then lithiated, resulting in a 25 nm PV4D4 layer and a 25 nm lithiated PV4D4 layer. The PV4D4 film was then further lithiated, resulting in a 50 nm thick lithiated PV4D4 layer. FIG. 33 shows plots of conductivity for 15 nm, 25 nm, 35 nm, and 25/25 nm thick polymer layers. It was found that the 25/25 nm film had a conductivity of 1.6×10⁻⁹ S/cm, compared to 1.41×10⁻⁹ S/cm for the 15 nm layer, 1.47×10⁻⁹ S/cm for the 25 nm layer, and 4.92×10⁻¹⁰ S/cm for the 35 nm layer.

However, for PV3D3, because of variability in film quality as discussed previously, it was difficult to accurately predict this top layer thickness (FIG. 31). The similarity in values for the different thicknesses of PV4D4 films supported the assumption of a simple step concentration profile for Li in these polymer films. The lower and less consistent values seen in PV3D3 were in line with the lower Li⁺ conductivity values for PV3D3 relative to PV4D4. The lower stability of the planar V3D3 ring may also have contributed to this observation.

### Optimization of Lithiation

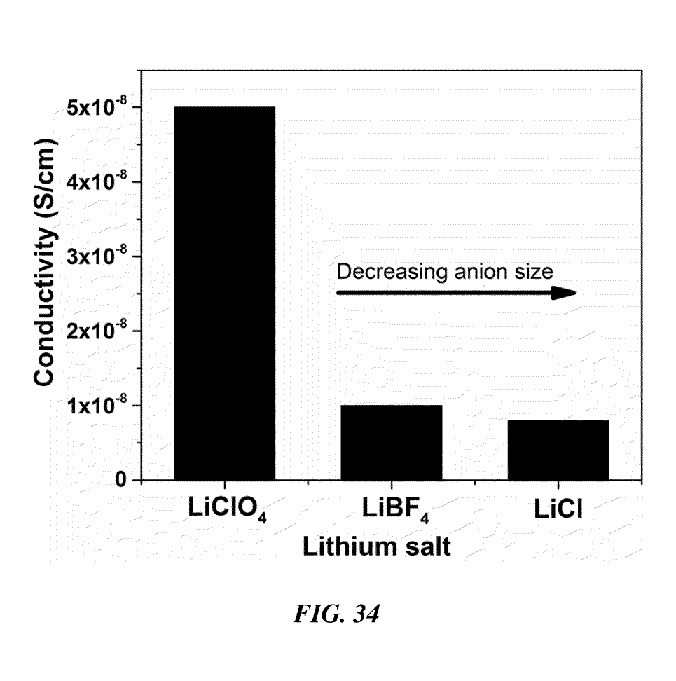

Several processes were adopted to optimize the lithiation process and determine their effect on the ionic conductivity of the nanoscale polymer films. It has been reported that the size of the counterion (anion) in the lithium salt used in the lithiation process can influence the ionic conductivity. FIG. 34, which shows the ionic conductivity value obtained when lithiating 20 nm thick PV4D4 films using lithium salts containing varying sizes of counterion (anion), demonstrates that as anion size increased from LiCl to LiClO₄, dissociation of the salt into Li⁺ and counterion improved, thereby resulting in reduced ion pairing and improved solvation of Li⁺ by the O atoms present in the siloxane film.

Varying the lithiation time appeared to have minimal effect on ionic conductivity. Additionally, changing the lithiation time did not significantly affect the roughness of the films. The amount of Li in the films also did not increase significantly with lithiation time as evident from ICP-MS data.

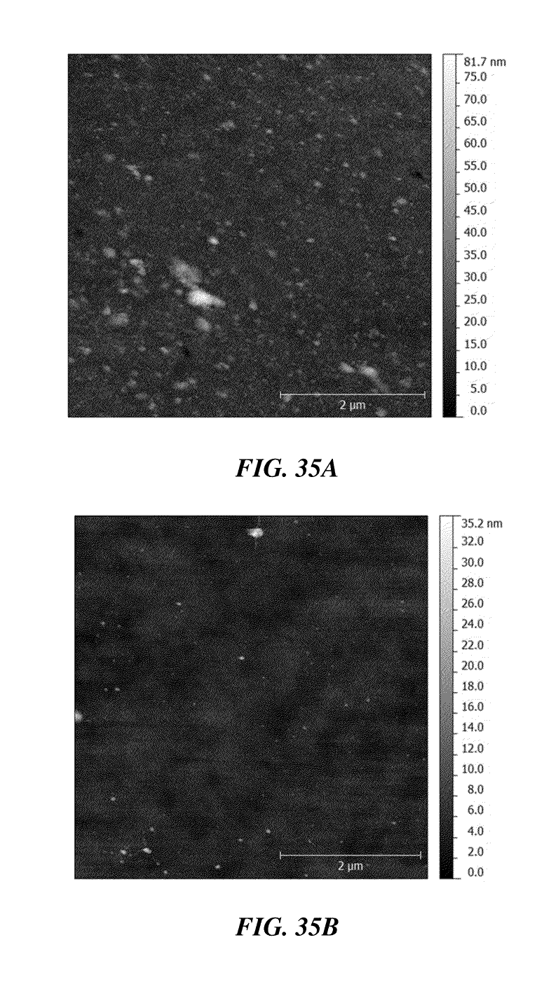

It was found, however, that changing the drying time reduced the presence of Li salt crystals. FIG. 35A shows an AFM image of a polymer film dried for 3 days, which shows Li salt crystals. FIG. 35B shows an AFM image of a polymer film dried for 3 hours, which shows no Li salt crystals. Accordingly, reducing the drying time appears to reduce the formation of Li salt crystals.

The temperature at which the lithiation process was performed also seemed to have a noticeable impact on the amount of Li penetrating into the films. As indicated by ICP-MS data, the amount of Li in the films increased when lithiation was carried out at an elevated temperature of about 50° C. These values were used to calculate the equilibrium constants and subsequently the activation energy for lithiation of the PV3D3 and PV4D4 films. The results summarized in Table 5 suggest that it was significantly easier to lithiate PV4D4 films compared to PV3D3. As discussed previously, the lack of ring strain in the puckered V4D4 rings compared to the planar V3D3 rings could also explain the trend seen in activation energy values.

TABLE 5
Comparison of the activation energy
for lithiation of PV3D3 and PV4D4 films

| iCVD | Film thickness | Activation energy |
|---|---|---|
| film | (nm) | (kJ/mol) |
| PV3D3 | 21 | 12.5 |
| PV4D4 | 21 | 2.8 |

Mechanistic Understanding of Li⁺ Interaction with Films

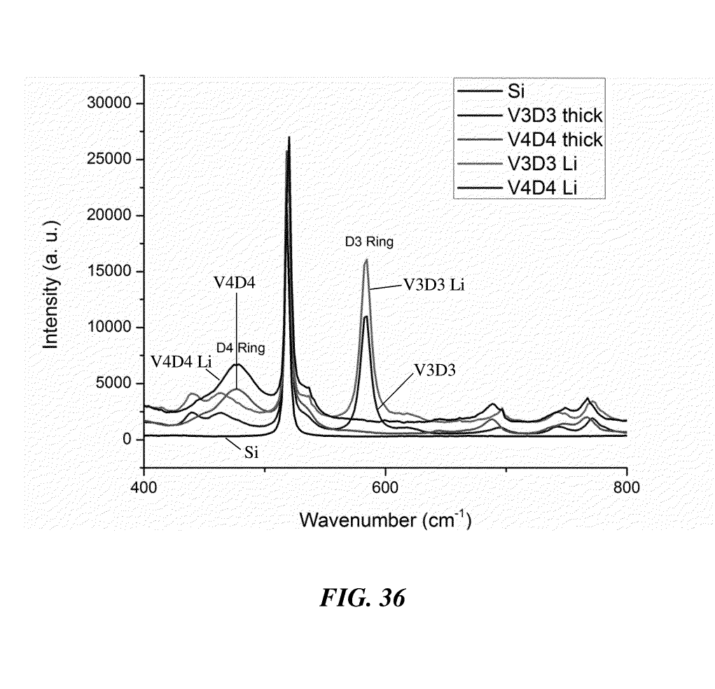

Raman analysis was used to study unlithiated and lithiated monomers. FIG. 36 shows Raman spectra for Si, V3D3, V4D4, lithiated V3D3, and lithiated V4D4. The V3D3 and V4D4 monomers showed characteristic D3 and D4 peaks respectively. Upon adding 20 μL of 1 M LiClO₄ (in PC) to 0.5 mL of V3D3 and V4D4 monomers (in liquid state), the Raman spectrum of V4D4 depicted very slight broadening of the siloxane ring (D4) peak, while V3D3 showed no change.

The Raman spectra of PV3D3 and PV4D4 polymer films were also examined, with particular emphasis on determining whether changes in the Si—O—Si ring deformation peaks occurred in the presence of Li⁺. The amount of Li⁺ present in the iCVD film samples, however, was too small to produce a noticeable signal.

Computational studies were utilized to generate insight into the nature of the ion-siloxane ring interactions. Specifically, density functional theory (DFT) calculations were carried out on V3D3 and V4D4 both with and without coordinating Li⁺. For uncoordinated rings (i.e., bare V3D3 or V4D4) the local electrostatic potential served as a guide to understanding ion-binding properties.

The Li⁺-siloxane ring binding energy was computed by comparing the ground state energies of the uncoordinated and singly-coordinated systems. The results, listed in Table 6, indicated that Li⁺ binding was more energetically favorable for V4D4 than it was for V3D3. This observation also agrees well with the ionic conductivity and morphology-related measurements discussed above.

For a single siloxane ring there are multiple energetically favorable Li⁺ binding sites. The binding energy of a given Li⁺ to a siloxane ring depends on the location of the binding site as well as the number and relative positions of already-coordinated ions. Introducing more than two Li⁺ tended to de-stabilize both the V3D3-Li and the V4D4-Li complexes. The results of these calculations suggested that at high Li⁺ concentration the ion transport in these materials may be governed by a collective balance of differently coordinated species.

TABLE 6
Comparison of binding energy of Li⁺ with O atom on siloxane rings

| | Binding energy | Binding energy |
|---|---|---|
| iCVD monomer | (eV) | (kJ/mol) |
| V3D3 | −2.56 | −247 |
| V4D4 | −2.72 | −262 |

### CONCLUSION

This work explored a group of cyclic siloxane and silazane polymer films synthesized by iCVD, that could potentially serve as nanoscale, conformal ion-conducting electrolytes for compact power systems that integrate high energy and power density. As-deposited films by iCVD synthesis were electronic and ionic insulators. Herein protocols were demonstrated that could render these iCVD polymer films ionically conducting at room temperature with excellent morphological and thickness stability. Overall, PV4D4 films performed better than both PV3D3 and the polysilazane films in terms of ionic conductivity, stability, and reproducibility. The improved properties can be attributed to the higher ionic character of their Si—O bonds and the strain-free nature of the V4D4 rings. ICP-MS experiments revealed a Li content of 1 wt. % in these films, and computational experiments were used to demonstrate how Li interacts with the oxygen atom of the siloxane rings. The studies detailed here provide a basis for understanding the ion transport mechanisms that can be used to engineer novel polymer electrolyte films whose conformality is critical for the emerging field of 3D batteries.

### EXAMPLE 4

This Example describes the characterization of polymer layers of varying compositions and thicknesses synthesized by iCVD.

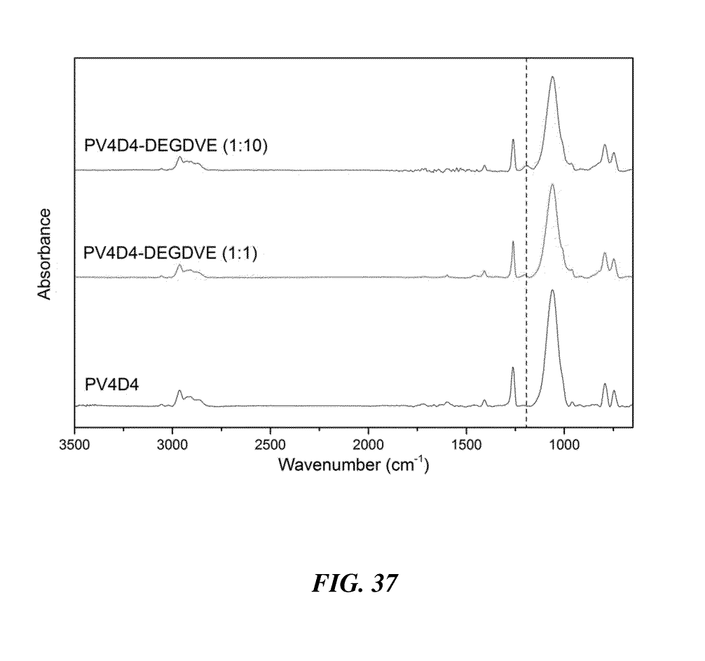

The effect of copolymerizing PV4D4 and DEGDVE was investigated. It was found that the addition of DEGDVE enhanced the ionic conductivity of PV4D4. FIG. 37 shows FTIR spectra for PV4D4-DEGDVE (1:10), PV4D4-DEGDVE (1:1), and PV4D4. The dashed line indicates one of the C—O stretch peaks (at around 1240 cm⁻¹) from DEGDVE. The other peak, which occurs at 1142 cm⁻¹, was overlapped by the large Si—O—Si peak of PV4D4. Preliminary results showed that PV4D4-DEGDVE films having a thickness greater than 50 nm were ionically conductive (e.g., having ionic conductivities of about 10⁻⁸ S/cm).

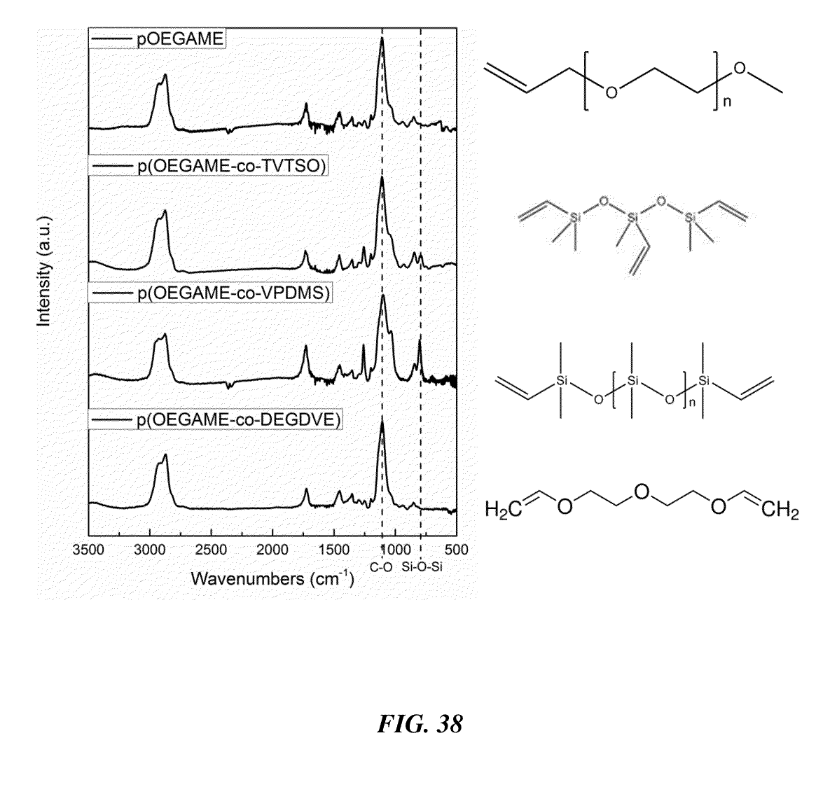

Other polymer electrolytes were also investigated. FIG. 38 shows FTIR spectra for OEGAME-based films. In particular, FIG. 38 shows the FTIR spectra for pOEGAME, p(OEGAME-co-TVTSO), p(OEGAME-co-VPDMS), and p(OEGAME-co-DEGDVE).

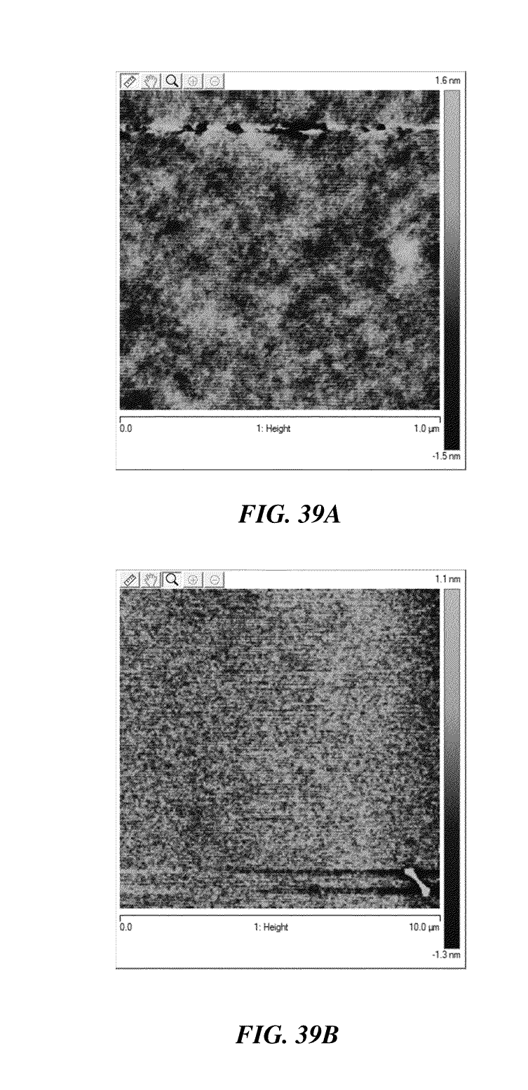

FIG. 39A shows an AFM image of an OEGAME film before lithiation. The film had an RMS roughness R_{RMS} of 0.431 nm. FIG. 39B shows an AFM image of an OEGAME film after soaking in DME and LiClO₄ for 1 day. After lithiation, the OEGAME film had an RMS roughness R_{RMS} of 0.578 nm.

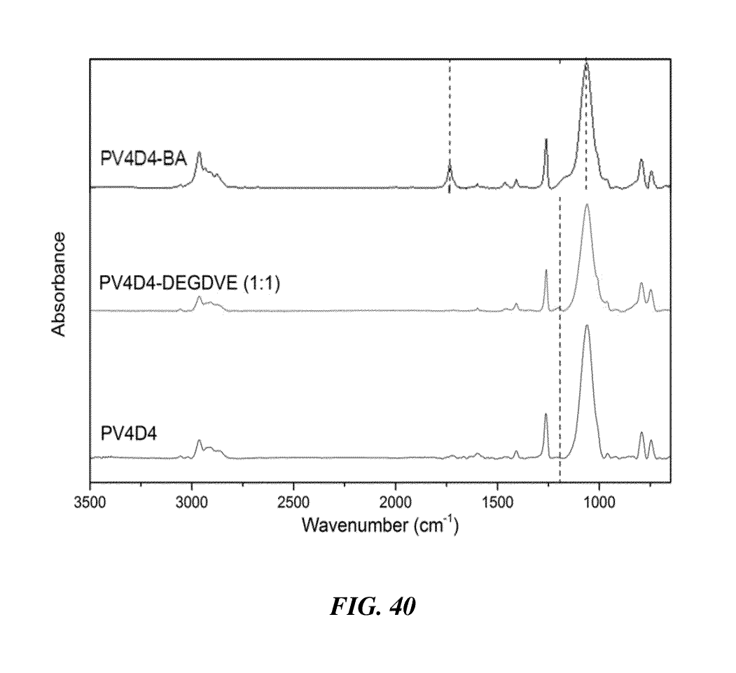

FIG. 40 shows FTIR spectra for PV4D4-BA, PV4D4-DEGDVE (1:1), and PV4D4. Butyl acrylate (BA) was introduced to lower the glass transition temperature.

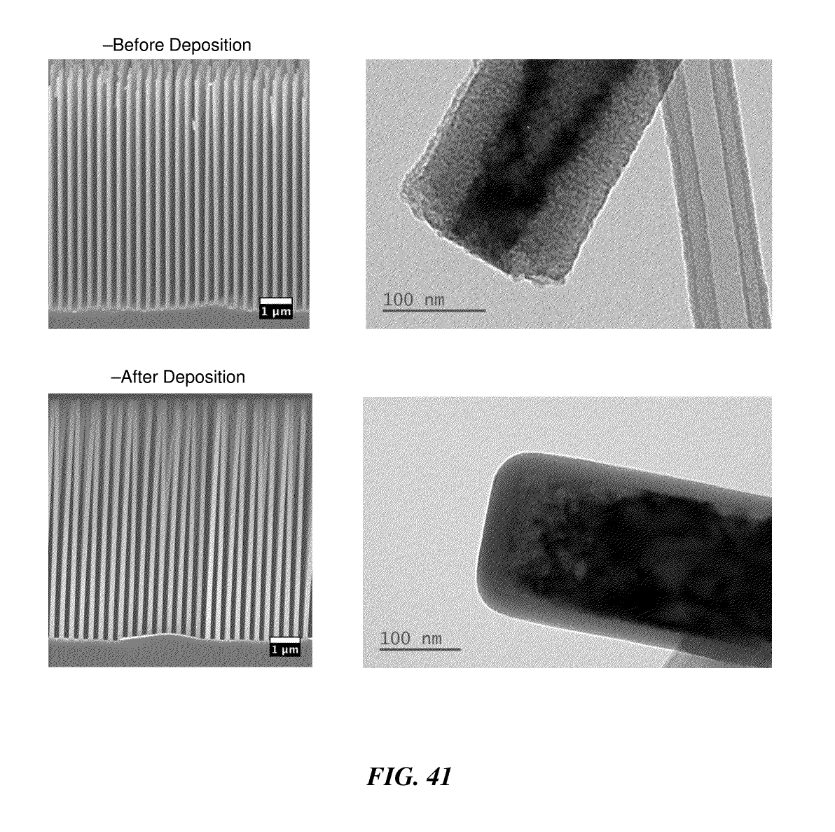

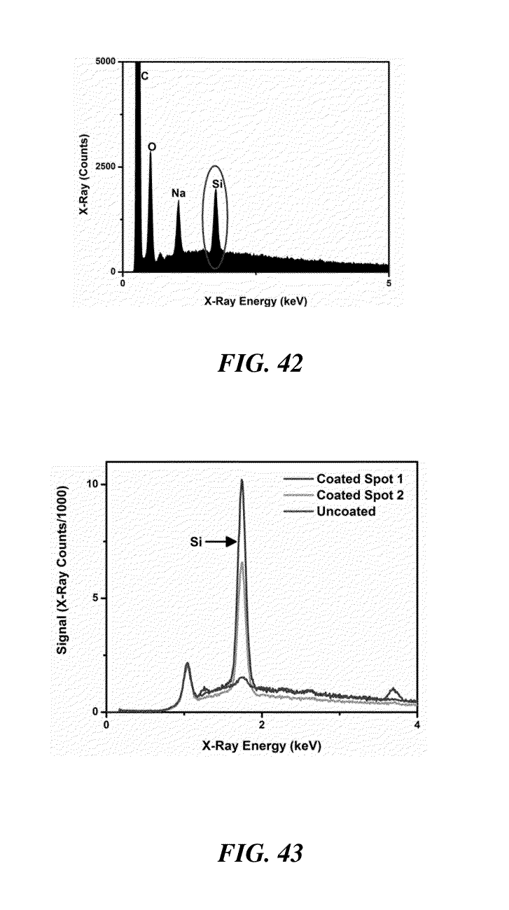

Further tests were conducted to demonstrate that the polymers could be used to conformally coat high-aspect-ratio structures. For example, from FIG. 41, which shows TEM images of silicon nanowires coated with a 50 nm layer of PV4D4, it can be seen that the PV4D4 conformally coats the silicon nanowires. In some tests, carbon microbeads were coated with PV4D4. The presence of the PV4D4 coating on the carbon microbeads was confirmed using electron dispersive spectroscopy (EDS). For example, in the EDS spectrum shown in FIG. 42, the presence of a Si peak demonstrates that the siloxane-based coating is present. Confirmation of tests can also be conducted using electron microprobe analysis. For example, the presence of a Si peak in the electron microprobe spectrum of FIG. 43 also demonstrates the presence of a silicon-comprising coating.

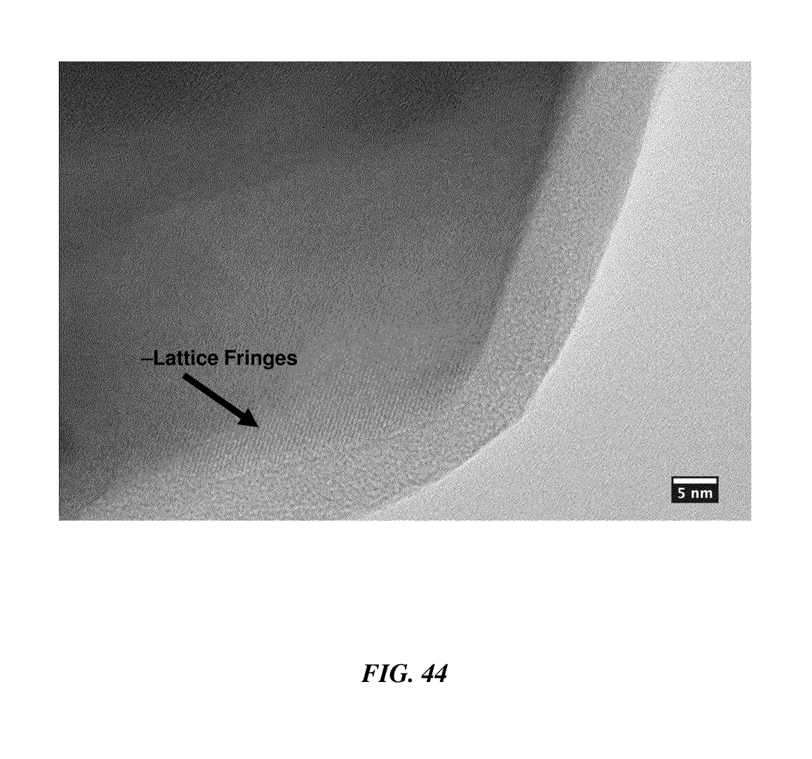

In some cases, a polymer electrolyte may be used to coat a cathode material. For example, FIG. 44 shows a TEM image of a spinel cathode particle conformally coated with PV4D4.

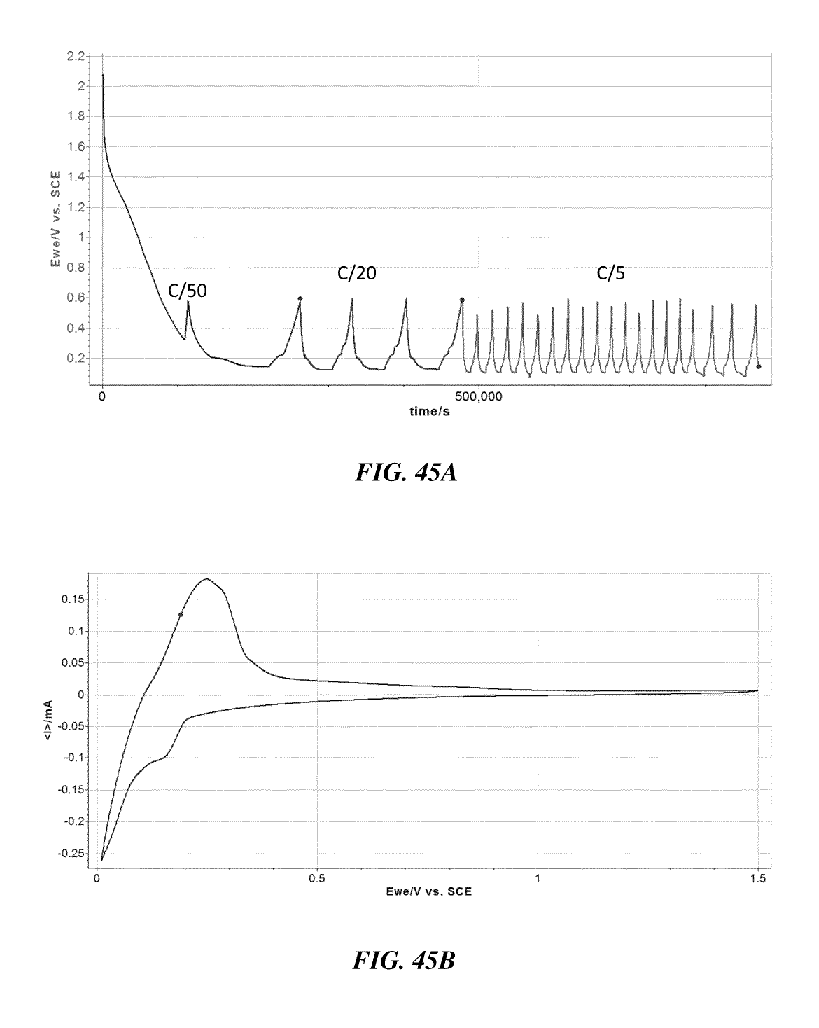

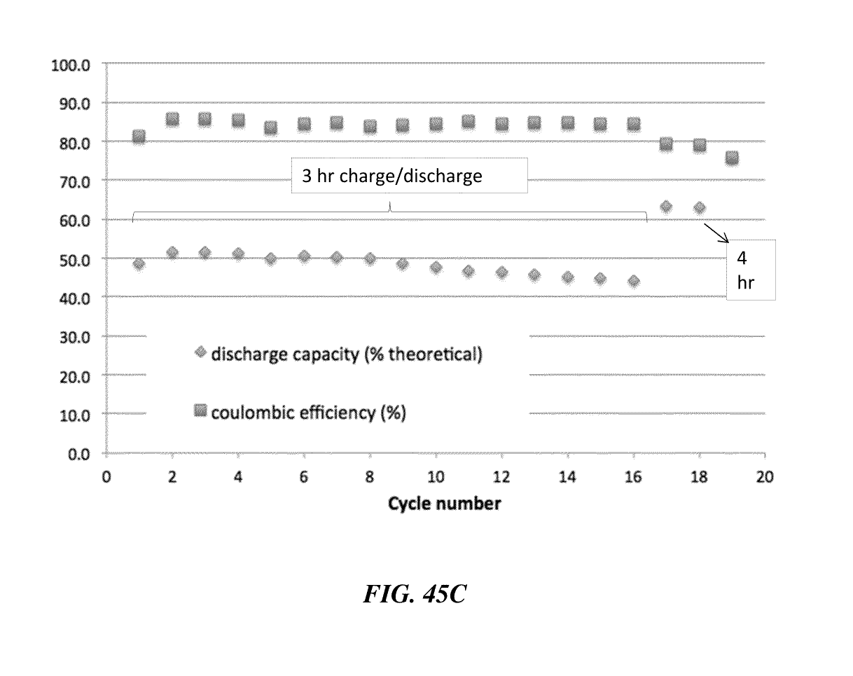

Half-cell battery tests were conducted using a PAN 3D carbon (MCMB) post array coated by a lithiated, 30 nm iCVD PV4D4 film. The theoretical capacity based on the mass of MCMB was 183 μAh, and the areal capacity was 2.04 mAh/cm². FIG. 45A shows a plot of E_{we} (V) vs. SCE as a function of time (s) for cycling rates of C/50, C/20, and C/5. FIG. 45B shows a plot of current (mA) as a function of E_{we} (V) vs. SCE. Discharge was 62% of theoretical capacity, and Coulombic efficiency was 90.4%. FIG. 30C shows a summary of cycling at C/5. In particular, FIG. 45C shows a plot of discharge capacity (% theoretical capacity) and coulombic efficiency (%) as a function of cycle number at C/5.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
at least one electroactive structure; and
a polymer layer proximate the at least one electroactive structure, wherein the polymer layer has a thickness of about 100 nm or less and an ionic conductivity of at least about 10⁻⁹ S/cm at about 25° C.

2-4. (canceled)

5. An article, comprising:
at least one electroactive structure; and
a polymer layer proximate the electroactive layer, wherein the polymer layer has a thickness of about 100 nm or less, wherein the polymer layer comprises a polymer, wherein the polymer has a repeat unit comprising at least one organic ring structure, wherein the at least one organic ring structure comprises at least two heteroatoms and at least one cross-linkable side group.

6. The article according to claim 1, wherein at least a portion of the polymer layer is doped with an electroactive species, wherein the electroactive species is Li⁺, Na⁺, K⁺, Ag⁺, Mg²⁺, Ca²⁺, Ba²⁺, Zn²⁺, or O²⁻.

7-17. (canceled)

18. The article according to claim 1, wherein the polymer layer has a thickness in the range of about 5 nm to about 50 nm.

19-28. (canceled)

29. The article according to claim 1, wherein the polymer layer is substantially free of discontinuities having a maximum cross-sectional dimension in the range of about 0.01 nm to about 5 nm.

30-38. (canceled)

39. The article according to claim 1, wherein the thickness of the polymer layer has a standard deviation within about 20% of an average thickness of the polymer layer.

40-53. (canceled)

54. The article according to claim 1, wherein the electroactive structure has an aspect ratio in the range of about 4:1 to about 1000:1.

55. (canceled)

56. The article according to claim 1, wherein the electroactive structure comprises a lithium intercalation compound.

57. The article according to claim 1, wherein the electroactive structure comprises graphite, petroleum coke, mesocarbon microbeads, silicon, lithium, antimony, tin, tin dioxide (SnO₂), titanium dioxide (TiO₂), lithium titanate (Li₂TiO₃), or an intermetallic compound.

58. The article according to claim 1, wherein the electroactive structure comprises lithium cobalt oxide, lithium iron phosphate, lithium nickel oxide, lithium manganese oxide, lithium manganese nickel oxide, and/or lithium nickel cobalt manganese oxide.

59. The article according to claim 1, wherein the polymer layer has a step coverage in the range of about 0.8 to about 1.2.

60-69. (canceled)

70. The article according to claim 1, wherein the polymer layer has a surface roughness R_{RMS} in the range of 0.1 nm to about 2 nm.

71-73. (canceled)

74. The article according to claim 1, wherein the polymer layer has an electrical conductivity in the range of about 10⁻¹⁴ S/cm to about 10⁻¹² S/cm.

75. The article according to claim 1, wherein the polymer layer comprises a polymer, wherein a repeat unit of the polymer comprises at least two heteroatoms.

76. (canceled)

77. The article according to claim 1, wherein the polymer layer comprises a polymer, wherein a monomeric precursor of the polymer comprises at least one cross-linkable side group.

78-79. (canceled)

80. The article according to claim 1, wherein the polymer layer comprises a polymer, wherein a repeat unit of the polymer comprises an organosiloxane and/or an organosilazane.

81-87. (canceled)

88. The article according to claim 1, wherein the polymer layer comprises a polymer, wherein a repeat unit of the polymer comprises an organic ring structure, wherein the at least one organic ring structure has a ring diameter in the range of about 150 pm to about 600 pm.

89. The article according to claim 1, wherein the polymer layer comprises a homopolymer, wherein the homopolymer comprises poly(1,3,5-trivinyl-1,3,5-trimethylcyclotrisiloxane) (PV3D3), poly(1,3,5,7-tetravinyl-1,3,5,7-tetramethylcyclotetrasiloxane) (PV4D4), poly(1,3,5-trivinyl-1,3,5-trimethylcyclotrisilazane) (PV3N3), poly(1,3,5,7-tetravinyl-1,3,5,7-tetramethylcyclotetrasilazane) (PV4N4), oligo(ethylene glycol) allyl methyl ether (OEGAME), poly(ethylene) glycol divinyl ether (PEGDVE), polyethylene oxide (PEO), or poly(methyl methacrylate) (PMMA).

90. The article according to claim 1, wherein the polymer layer comprises a copolymer, wherein the copolymer is formed from at least one monomer comprising 1,3,5-trivinyl-1,3,5-trimethylcyclotrisiloxane (V3D3), 1,3,5,7-tetravinyl-1,3,5,7-tetramethylcyclotetrasiloxane (V4D4), 1,3,5-trivinyl-1,3,5-trimethylcyclotrisilazane (V3N3), or 1,3,5,7-tetravinyl-1,3,5,7-tetramethylcyclotetrasilazane (V4N4), ethylene glycol divinyl ether, diethylene glycol divinyl ether (DEGDVE), trivinyl-1,1,3,5,5-pentamethyltrisiloxane (TVTSO), vinylpolydimethylsiloxane (VPDMS), ethylene oxide, methyl methacrylate, or butyl acrylate.

91-122. (canceled)

123. A method, comprising:
depositing a conformal polymer coating on an electroactive structure using iCVD, wherein the conformal polymer coating has a thickness of about 100 nm or less; and
exposing the conformal polymer coating to a solution comprising an electroactive species of the electroactive structure, wherein the conformal polymer coating is doped with the electroactive species.

124-153. (canceled)
